(19) United States
(12) Patent Application Publication
(10) Pub. No.: US 2007/0157173 A1
(43) Pub. Date: Jul. 5, 2007

(54) Method and system for multi-version digital authoring

(75) Inventors: Martin H. Klein, Iles des Soeurs (CA); Simon Ashby, Montreal (CA); Nicolas Michaud, Candiac (CA); Eric Begin, Montreal (CA); Jacques Deveau, Montreal (CA); Michel Gervais, Prevost (CA)

Correspondence Address: VENABLE LLP, P.O. BOX 34385, WASHINGTON, DC, 20043-9998, US

(73) Assignee: AUDIOKINETIC, INC., Quebec (CA)

(21) Appl. No.: 11/637,199

(22) Filed: Dec. 12, 2006

Related U.S. Application Data
(60) Provisional application No. 60/749,027, filed on Dec. 12, 2005.
(60) Provisional application No. 60/749,049, filed on Dec. 12, 2005.

(51) Int. Cl. G06F 9/44

(52) U.S. Cl. 717/122; 717/110

(57) ABSTRACT

The method and system for multi-version digital authoring comprises providing digital media from which media objects are created. Version classes are predetermined, each including version identifiers for identifying respective versions of the media objects. A work copy is then created of each sound object corresponding to each version identifier. A selected modifying value characterizing a selected modifier is associated to a selected media object. The version of the object corresponding to a current version identifier is then modified by the modifying value. The method and system provides means to link and unlink modifiers associated to a selected sound object for a selected version identifier.

### FIELD

The present relates to digital authoring including web and game design, computer animation and computer application authoring, etc. More specifically, the present is concerned with a method and system for multi-version digital authoring.

### BACKGROUND

For computer application designers, including video game designers, dealing with different platforms conventionally means creating different projects. More specifically, the traditional process involves creating one project for a specific platform, building the corresponding assets, properties, and settings for that particular platform and then starting all over again with each plafform that needs to be delivered.

Indeed, each platform has it own specific strengths and weaknesses that need to be addressed. For example, not all platforms can handle the same CPU (central processing unit) and memory requirements for given audio or media assets. For aesthetic reasons, different platforms might require different content.

Similar problems arise also for example when digital content producers wish to produce different versions in different languages.

The above-mentioned authoring methodology is conventionally used to produce multi-version computer applications, video games, web sites, etc.

An approach that has been proposed to limit the burden of the application designer consists in preparing templates to receive contents which may vary from version to version. This approach is well-known in web design and in any authoring application where different language versions of the application have to be conceived.

A first drawback of this approach is that the programmer and designer often have to work separately on the template and on the content, which may lead to unpredictable results.

Another drawback of such method is that it does not allow authoring multi-versions of multi-versions. For example, no known method from the prior art allows authoring simultaneously multi-language versions of an application across a plurality of platforms.

### SUMMARY

More specifically, in accordance with a first aspect of the present, there is provided a method in a computer system for multi-version digital authoring comprising:

providing at least one digital media;

predetermining a first version class including first version identifiers; and

associating the at least one digital media to at least one of the first version identifiers.

According to a second aspect, there is provided a computer tool for multi-version digital authoring comprising:

a file importer component that receives at least one digital media; and

an editor component that provides a first version class including first version identifiers and to selectively associate the at least one digital media to at least one of the first version identifiers.

According to a third aspect of the present, there is provided a computer-readable medium containing instructions for controlling a computer system to generate:

a file importer component that receives digital media; and

an editor that provides a first version class including first version identifier and to selectively associate the at least one media to at least one of the first version identifiers.

The computer-readable medium can be a CD-ROM, DVD-ROM, universal serial bus (USB) device, memory stick, hard drive, etc.

The expression “computer application” is intended to be construed broadly as including any sequence of instructions intended for a computer, game console, wireless phone, personal digital assistant (PDA), multimedia player, etc. which produces sounds, animations, display texts, videos, or a combination thereof, interactively or not.

Similarly, the expression “computer system” will be used herein to refer to any device provided with computational capabilities, and which can be programmed with instructions for example, including without restriction a personal computer, a game console, a wired or wireless phone, a PDA (Personal Digital Assistant), a multimedia player, etc.

The present system and method for multi-version digital authoring allows customizing content for a computer application for different versions, including different platforms and/or languages.

It allows for example to optimize content and performance based on the limitations and strengths of certain platforms.

The present system and method for multi-version digital authoring also allows to handle the requirements specific to certain languages.

It further allows for sharing of certain properties across versions and creating content that will be delivered in different formats on different versions.

Other objects, advantages and features of the present will become more apparent upon reading the following non restrictive description of illustrated embodiments thereof, given by way of example only with reference to the accompanying drawings.

### BRIEF DESCRIPTION OF THE DRAWINGS

In the appended drawings:

FIG. 1 is a perspective view of a system for multi-version digital authoring according to a first illustrative embodiment;

FIG. 2 is a flowchart of a method for multi-version digital authoring according to a first illustrative embodiment;

FIG. 3 is block diagram illustrating an example of possible versions for each sound object in a project according to the method from FIG. 2;

FIG. 4 is a flowchart illustrating the audio import process, part of the method from FIG. 2;

FIG. 5 illustrates the links between an audio file, audio sources and a sound object;

FIG. 6 illustrates the structure of the Originals folder as created using the method from FIG. 2;

FIGS. 7 to 9 illustrate the structure and the creating of the cache folder as created using the method from FIG. 2;

FIG. 10 is an example of a user interface allowing to clear the audio file cache, part of the Authoring Tool from the system from FIG. 1;

FIG. 11 is an example of a user interface allowing to update the audio file, part of the Authoring Tool from the system from FIG. 1;

FIG. 12 is an example of a user interface to set conversion settings, part of the Authoring Tool from the system from FIG. 1;

FIG. 13 is an example of a user interface for converting audio files, part of the Authoring Tool from the system from FIG. 1;

FIG. 14 is an illustration of a first level hierarchical structure according to the first illustrative embodiment;

FIG. 15 is a first example of application of the first level hierarchical structure from FIG. 14, illustrating the use of containers to group sound objects;

FIG. 16 is a second example of application of the first level hierarchical structure from FIG. 14, illustrating the use of actor mixers to further group containers and sound objects;

FIG. 17 illustrates a first example of a project hierarchy, including Master-Mixer and Actor-Mixer hierarchies;

FIG. 18 is a block diagram illustrating the routing of the sound through the hierarchy;

FIG. 19 is an example of a user interface for a Project Explorer, part of the system from FIG. 1;

FIG. 20 illustrates the operation of two types of properties within the hierarchy;

FIG. 21 illustrates a third example of application of the hierarchical structure to group and manage sound objects;

FIG. 22 is an example of user interfaces for a Project Explorer and for a Property Editor, part of the system from FIG. 1;

FIG. 23 is a flow diagram illustrating an example of use of a random container;

FIG. 24 is an example of a user interface for a Contents Editor part of the system from FIG. 1;

FIG. 25 is an example of an interactive menu portion from the Property Editor from FIG. 22 to characterize a random/sequence container;

FIG. 26 is a flow diagram illustrating a first example of use of a sequence container;

FIG. 27 is an example of an interactive menu portion from the Property Editor from FIG. 22 to characterize a sequence container;

FIG. 28 is an example of the user interface for the Contents Editor as illustrated in FIG. 24 as it appears in the context of a Sequence container, further illustrating the Playlist pane;

FIGS. 29A-29B are flow diagrams illustrating a second example of use of a random/sequence container and more specifically the use of the step mode;

FIG. 30 is a flow diagram illustrating a third example of use of a random/sequence container, illustrating use of the continuous mode;

FIG. 31 is an example of an interactive menu portion from the Property Editor from FIG. 22, to characterize the playing condition for objects in a continuous sequence or random container;

FIG. 32 is a first example of a switch container for footstep sounds;

FIGS. 33A-33B are flow diagrams illustrating an example of use of a switch container;

FIG. 34 is an example of a user interface for the Contents Editor as it appears in the context of a switch container;

FIG. 35 is an isolated view of the “Assigned Objects” pane form the user interface from FIG. 34;

FIG. 36 illustrates the use of a switch container to author a game;

FIG. 37 is an example of an Game Syncs user interface for managing effects from the Authoring Tool part of the system from FIG. 1;

FIG. 38 illustrates an example of use of relative state properties on sounds;

FIG. 39 illustrates an example of use of absolute state properties on sounds;

FIG. 40 illustrates an example of use of states in a game;

FIG. 41 is an example of a user interface for the State Property Editor from the Authoring Tool part of the system from FIG. 1;

FIG. 42 is an isolated view of a portion of the user interface from FIG. 41, further illustrating the interaction GUI element allowing the user to set the interaction between the objects properties and the state properties;

FIG. 43 is an example of a user interface for a State Group Property Editor from the Authoring Tool part of the system from FIG. 1;

FIG. 44 is an example of a portion from a user interface for a States editor from the Authoring Tool part of the system from FIG. 1;

FIG. 45 illustrates how the volume of the engine of a car in a game can be affected by the speed of the racing car, based on how it is mapped in the project using real time parameter control (RTPC);

FIG. 46 is an example of a user interface for the Game Syncs tab from FIG. 37, further illustrating a shortcut menu which can be used to create a game parameter;

FIG. 47 is an example of a graph view from a RTPC Editor from the Authoring Tool part of the system from FIG. 1;

FIG. 48 is an example of a user interface for defining a New Game Parameter from the Authoring Tool part of the system from FIG. 1;

FIG. 49 is an example of a portion of the RTPC tab for editing RTPCs from the Authoring Tool part of the system from FIG. 1;

FIG. 50 is a first example illustrating the use of Events to drive the sound in a game;

FIG. 51 is a second example illustrating the use of Events to drive the sound in a game;

FIG. 52 is an example of shortcut menu part of the Event Editor from FIG. 54, which can be used to assign actions to an Event;

FIG. 53 is an example of a user interface for an Event tab from the Authoring Tool part of the system from FIG. 1;

FIG. 54 is an example of a user interface for an Event Editor from the Authoring Tool part of the system from FIG. 1;

FIG. 55 is a graph illustrating the docking process;

FIG. 56 is an example of user interface for an Auto-ducking control panel from the Authoring Tool part of the system from FIG. 1;

FIG. 57 is an example of a user interface for a Master-Mixer Console from the Authoring Tool part of the system from FIG. 1;

FIG. 58 is a flowchart illustrating how the Authoring Tool determines which sounds within the actor-mixer structure are played per game object;

FIG. 59 is a flowchart illustrating how the Authoring Tool determines which sounds are outputted through a bus;

FIG. 60 illustrates the setting of playback limit within the Actor-Mixer hierarchy;

FIG. 61 is an example of a user interface for the Property Editor in the context of a Random/Sequence Container, illustrating the “Playback Limit” group box;

FIGS. 62A-62B are close up views of the link indicator user interface element associated with the volume property input box from the Property Editor user interface from FIG. 22, illustrating respectively the linking of the property across all platforms and the unlinking for one of the platforms;

FIG. 63 is an example of a user interface for a shortcut menu for changing the linking status of a modifier;

FIG. 64 is the user interface from FIG. 34 for the Contents Editor, illustrating the unlinking of a source for a selected platform;

FIG. 65A is a close up view of the tree view from the Project Explorer user interface from FIG. 19, illustrating the exclusion of a sound for a selected platform;

FIG. 65B is an example of a user interface for a Platform Manager from the Authoring Tool part of the system from FIG. 1;

FIG. 65C is an example of a user interface for a user interface from the Authoring Tool part of the system from FIG. 1, allowing to add platform to the Platform Manager from FIG. 65B;

FIG. 66 illustrates the links between multi-language versions of audio files and corresponding audio sources for a sound object;

FIG. 67 is a hybrid flow diagram including examples of user interfaces for the Project Explorer and for the Contents Editor illustrating the availability of the sources for a plurality of languages in the Contents Editor;

FIG. 68 is an example of a user interface for a Language Manager from the Authoring Tool part of the system from FIG. 1;

FIG. 69 is an example of a user interface for an Audio File Importer from the Authoring Tool part of the system from FIG. 1;

FIG. 70 is an example of a user interface for a SoundBank Manager from the Authoring Tool part of the system from FIG. 1;

FIG. 71 is an example of part of text inputs for a definition file, listing events in the game in SoundBanks;

FIG. 72 is an example of a user interface for an Import Definition log dialog box from the Authoring Tool part of the system from FIG. 1;

FIG. 73 is an example of a user interface for a SoundBank Generator from the Authoring Tool part of the system from FIG. 1;

FIG. 74 is an example of a user interface for a Project Launcher menu from the Authoring Tool part of the system from FIG. 1;

FIG. 75 is a list of folders and file contained in a Project Folder as created from the Authoring Tool part of the system from FIG. 1;

FIG. 76 is an example of a user interface for a Project Settings dialog box from the Authoring Tool part of the system from FIG. 1;

FIG. 77 is an example of a user interface for an auditioning tool from the Authoring Tool part of the system from FIG. 1;

FIG. 78 is a close up view of the Playback Control area from the auditioning tool from FIG. 77;

FIG. 79 is a close up view of the Game Syncs area from the auditioning tool from FIG. 77; and

FIG. 80 is an example of a user interface for a Profiler from the Authoring Tool part of the system from FIG. 1.

### DETAILED DESCRIPTION

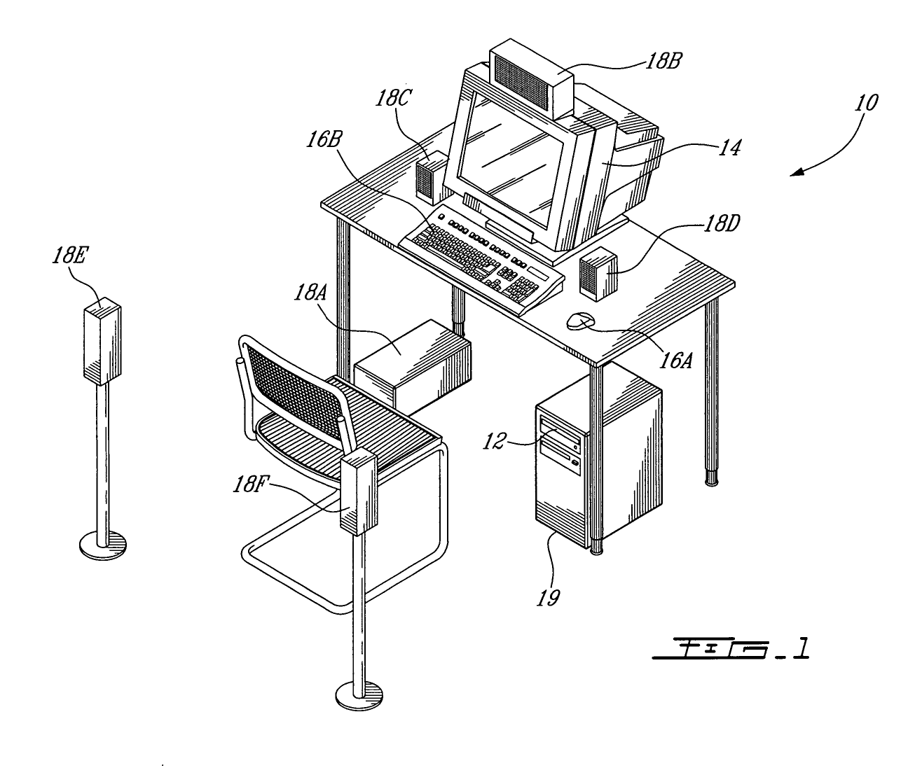

A system 10 for multi-version digital authoring according to an illustrative embodiment will now be described with reference to FIG. 1. The system 10 is in the form of a system for multi-version audio authoring for a video game.

Even though the present system for multi-version digital authoring will be described hereinbelow with reference to a system for authoring audio for video games, it is to be understood that this first embodiment is provided for illustrative purposes only. The present system for multi-version digital authoring can be used in other applications as will be described furtherin.

The system 10 comprises a computer 12 programmed with instructions for generating an authoring tool, which will be referred to herein as the “Authoring Tool”, allowing for:
receiving audio files;
creating a sound object from and for each of the audio files;
providing modifiers in the form of properties and behaviors to modify the sound objects;
predetermining version classes, each including version identifiers for identifying respective versions of the sound objects;
creating a corresponding copy of each of the sound object for each selected version identifier:
for each of selected modifiers and selected sound objects:
   associating modifying values characterizing the selected modifiers to the selected sound objects; and
   modifying the selected sound objects accordingly with the associated modifying values characterizing the selected modifiers.

The Authoring Tool will be described hereinbelow in more detail.

The system 10 further comprises a display 14, conventional input devices, in the form for example of a mouse 16A and keyboard 16B, and six (6) sound speakers 18A-18F, including a sub-woofer 18A, configured to output sounds in a Dolby 5.1 setup for example. The system 10 is of course not limited to this setup. The number and type of input and output device may differ and/or the sound output setup may also be different.

The system 10 also includes a conventional memory (not shown), which can be of any type. It is configured for network connectivity 19.

As will be described hereinbelow, the Authoring Tool further includes user interactive interfaces to manage audio files, sound objects, modifiers, version classes and their associations.

These and other characteristics and features of the system 10, and more specifically of the Authoring Tool, will become more apparent upon reading the following description of a method 300 for multi-version digital authoring of audio for a video game according to a first illustrative embodiment.

The method 300 comprises the following steps:

302—providing audio files;

304—creating a sound object for each of the audio file;

306—predetermining version classes, each including version identifiers for identifying respective versions of the sound objects;

308—creating a work copy of each audio file for each of the version identifiers, and associating these copies to the corresponding object;

310—providing modifiers in the form of properties and behaviors to modify the sound objects;

for each of selected version identifiers:
for each of selected modifiers and selected sound objects:
   312—associating modifying values characterizing the selected modifiers to the selected sound objects;
   314—modifying the work copy associated with the selected sound objects and corresponding to the selected version identifier accordingly with the associated modifying values characterizing the selected modifiers; and
   316—storing information related to the sound objects in a project file to be used by the video game.

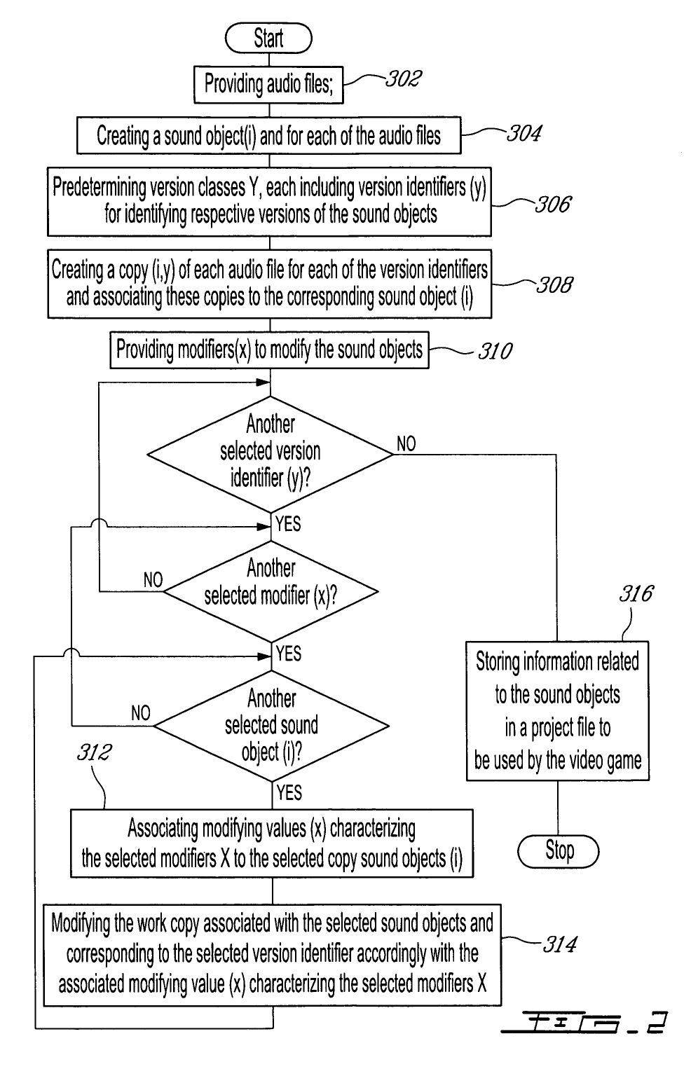

FIG. 2 summarizes the method 300.

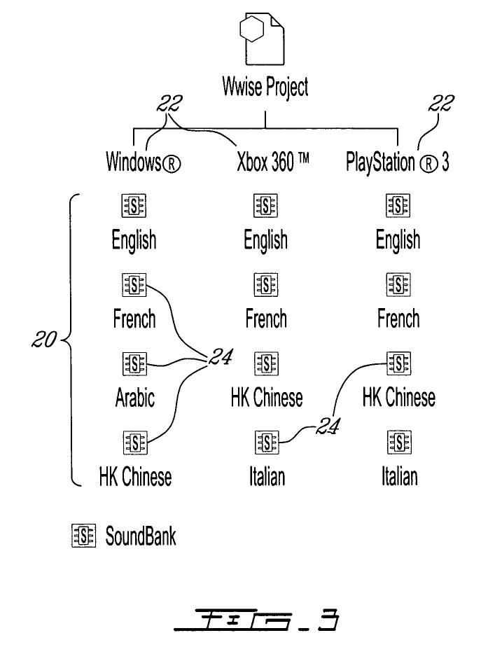

FIG. 2 as been simplified for clarity purposes. For example, the method 300 is not limited to a single version class. Indeed, as illustrated in FIG. 3 and as will now be described in more detail, the method 300 and system 10 may result in multi-language versions 20 for different platforms 22, resulting in a combination of twelve (12) unique versions 24 in the illustrated example. Moreover, for a selected platform, the method 300 and system 10 allows creating different versions.

As will be described hereinbelow in more detail, the Authoring Tool is configured to allow a user to assign different behaviors and properties to different versions of a sound object. For example, the pitch of the voice of a ghost in the English version of a game for Microsoft Windows™ might be assigned a predetermined value while the pitch of the voice of the same ghost in the French version of the game for Sony PlayStation™ might be a random value selected within a predetermined range.

Referring briefly to step 306 of the method 300, the expression “version class” is used herein to define the different categories of versions that are used to identify and characterize the different versions of the sound objects within a project. The number and nature of version classes can differ from one project to another. According to the first illustrative embodiment, the following version classes are provided: game platform and language.

Within a predetermined version class, version identifiers are used to identify the different possibilities of versions allowed by the Authoring Tool. As described with reference to the above example, the combination of a plurality of version classes with respective version identifiers yields a wide variety of possible versions for a unique sound objects.

In addition, the Authoring Tool also allows dividing up the audio assets by:
Use: original or working copy; and
Type: sound effect (SFX) or voice.

As will be explained hereinbelow in more detail, step 302 includes importing the audio files into the Authoring Tool, which yields two copies of the audio file: the original copy and a work copy. The original copy remains untouched, but can be referenced to. The work copy is used for experimentation and therefore to create the different versions as explained hereinabove.

In addition, different versions can be created for different workgroups, which are logical entities that can be created in the Authoring Tool to restrict the access to selected assets to selected users. By organizing the original assets separately and creating work copies for each individual in a workgroup, team work can be done on the same files and so that they can be better managed. More specifically, using workgroups allows organizing a project and its components so that many people can work simultaneously on different parts of the project at the same time and it can all be saved together, while limiting merging problems.

To better manage the special requirements of audio files that contain voice over and character dialogue, audio files are further sub-divided into two types: SFX and Voice. The Authoring Tool allows treating the two types of files differently since voice over work and character dialogue may need to be translated. As will be described furtherin, the distinction between these two types of files can made as soon as the files are imported into the Authoring Tool, so that they can be flagged accordingly and then stored in separate folders.

The icons illustrated in the following table are used both to facilitate the reference in the present description and also to help a user navigate in the graphical user interfaces (GUIs) provided with the Authoring Tool.

TABLE 1

| Icon | Represents |
|---|---|
| [symbol] | Sound effect (Sound SFX) |
| [symbol] | Voice (Sound Voice) |

Each of the steps of the method 300 and characteristics of the Authoring Tool will now be described in further detail.

In step 302, audio files are provided. According to the first illustrated embodiment, step 302 includes importing audio files into the system 10.

The importing process 302 generally includes converting the audio files and creating audio sources for each audio file. The importing process can also be viewed as including the creation in the Authoring Tool of sound objects that contain the audio sources (step 304).

The audio files can be for example from any type of PCM (Pulse-Code Modulation) audio file format such as the well-known WAV format.

The media files can alternatively be streamed directly to the system 10 via, for example, but not limited to, a well-known voice-over-ip, protocol. More generally, step 302 can be seen as providing digital media, which can be in the form of a file or of a well-known stream.

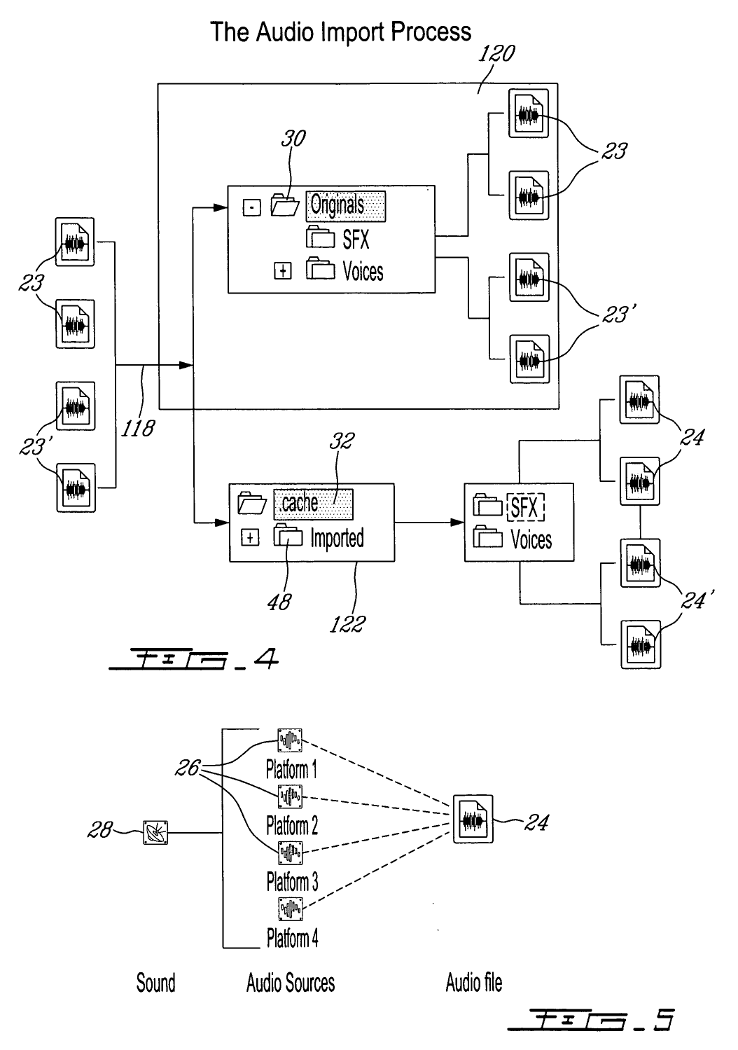

With reference to FIG. 4, the importing process includes the following subs-steps:
the original audio files 23-23′ are validated by the Authoring Tool and imported into the project;
the original files 23-23′ remain unmodified and are moved into an Originals folder 30;
copies 24-24′ of the imported files are created and are stored for example in a Project\.cache\Imported folder 32;
audio sources 26 are created for and from the audio files 24-24′ and sound objects 28 that contain the audio sources are created and made available for editing in the Authoring Tool (see FIG. 5).

The validation sub-step includes verifying for errors in the original audio files 23-23′ including verifying whether the audio files are 23-23′ in a format recognized and accepted by the Authoring Tool and whether the sample rate, bit rate and channel are beyond a predetermined range. It is to be noted that the validation sub-step can be omitted or can differ depending for example on the type of files, computer application, or on the level of reliability desired.

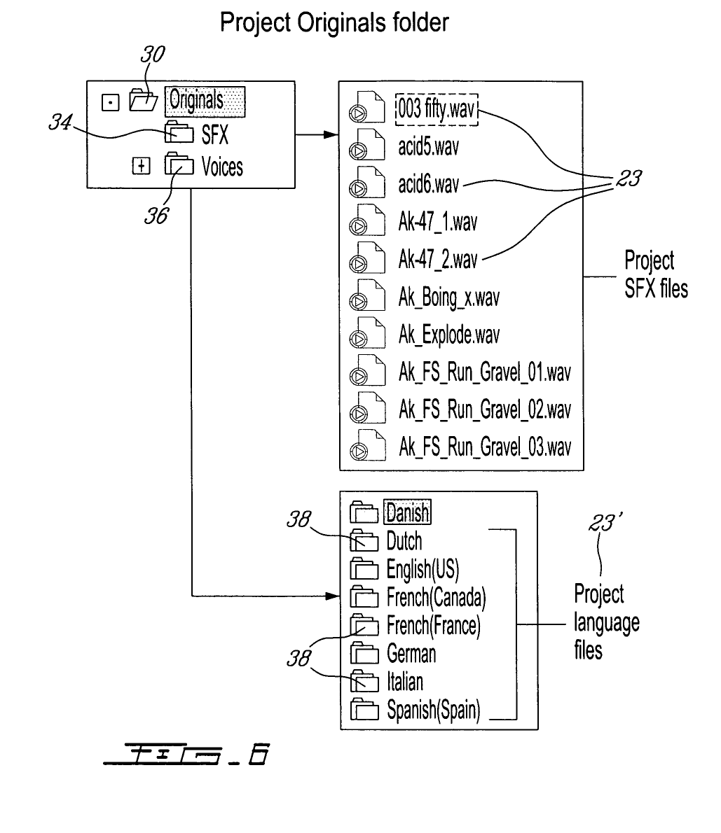

As illustrated in FIG. 6, the Originals folder 30 contains the following folders:
SFX folder 34, which contains the original SFX files 23; and
Voices folder 36, which contains sub-folders 38 including respective language voice files 23′.

In step 306, version classes, each including identifiers to identify versions of the sound objects are determined. According to the first illustrative example, two version classes are provided: game platforms and languages. The version identifiers for the game platforms include, for example: Sony PlayStation®, XBOX 360™ and Microsoft Windows®. The version identifiers for the languages include English, French, Spanish, etc.

The Project .cache folder, which is illustrated in FIG. 7, includes an additional folder hierarchy 40 to provide for the game platform version class including respective game platform folder 42 to receive a SFX folder 44 platform SFX files 50 and a Voices folder 46 similar to those included in the Originals folder 30 with platform Voices files 52 per project language. These files 50 and 52 are based on the respective cache Imported folder files 24 and 24′ respectively and have been converted for the specific platform.

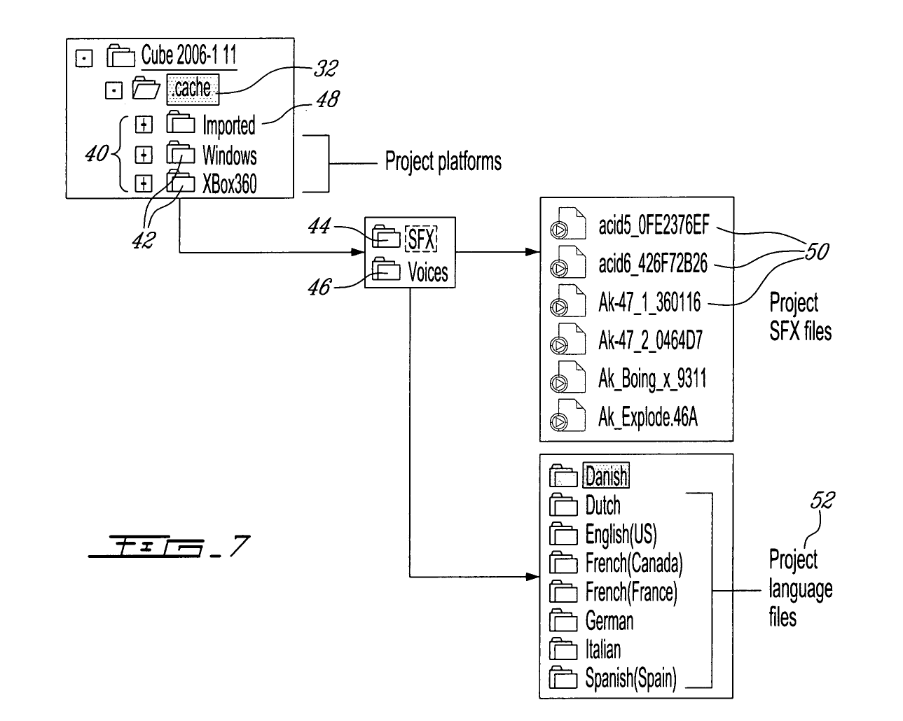

The cache Imported folder 48 stores the imported SFX and voice files 24 and 24′. The audio files in the platform folders 42 are further converted for the specific respective game platform as will be described hereinbelow in more detail. This is illustrated in FIG. 8.

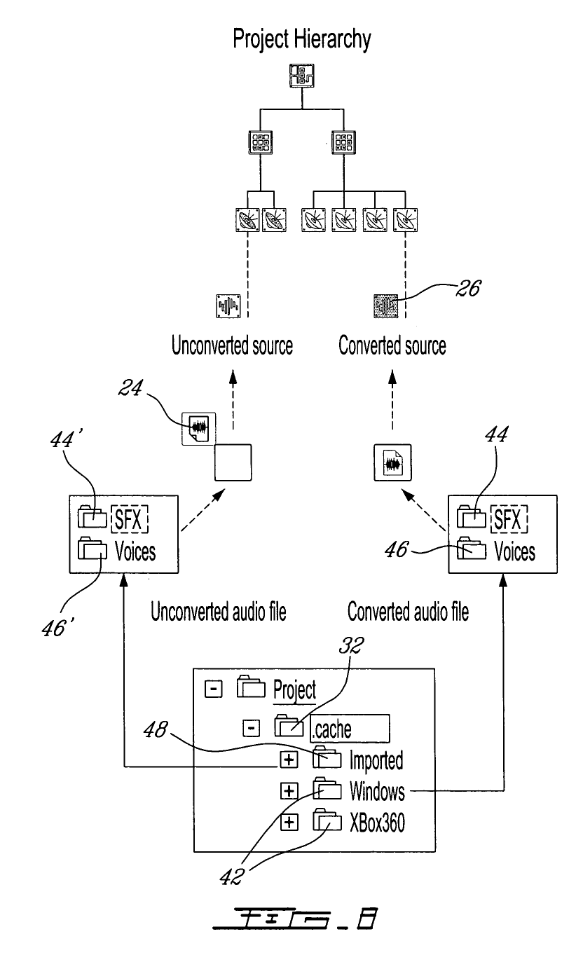

As illustrated in FIG. 5, objects 28 reference audio sources 26 as they are created in the Authoring Tool from imported audio files 24. These sources 26 contain the conversion settings for each project platform. In addition, as can be better seen from FIG. 9, each platform also contains language versions. The creation of sound sources as a copy of the sound objects for each of the version identifiers corresponds to step 308 of the method 300.

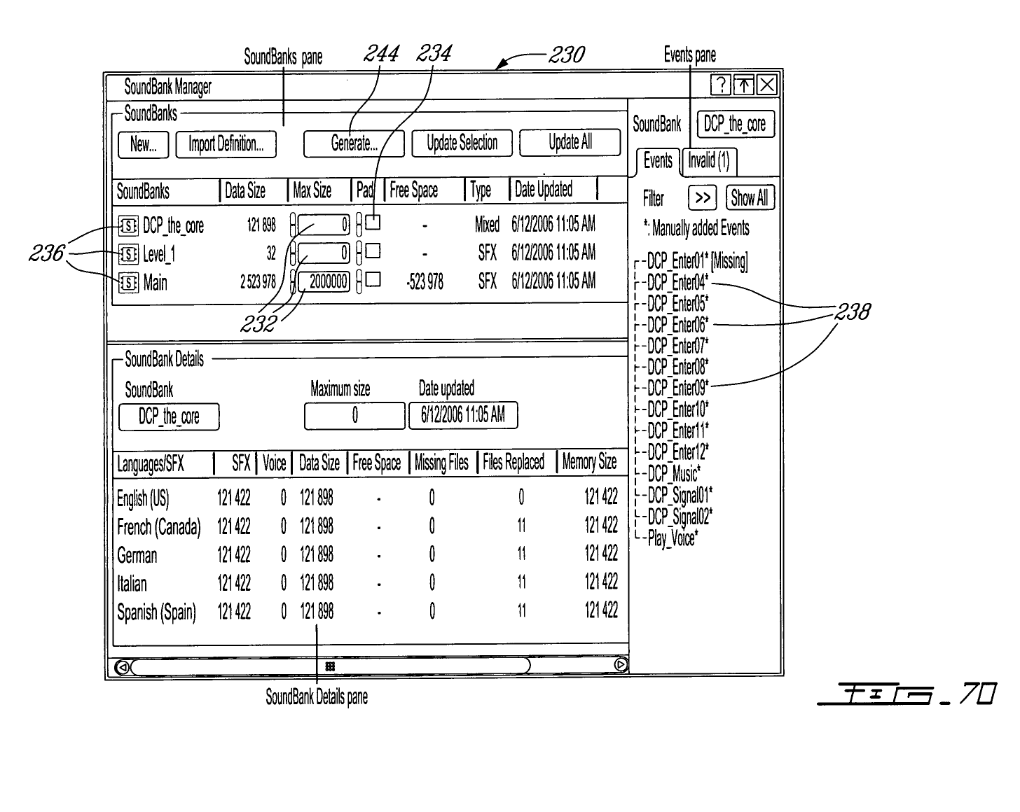

By default, the Authoring Tool assigns the same conversion settings for all platforms 22. However, as will be described hereinbelow, the Authoring Tool is configured with a graphical user interface (GUI) tool to import the audio files. More specifically, the Authoring Tool includes an Audio File Importer 214 (see FIG. 69) including a Conversion Settings Dialog box 58 to allow assigning different conversion settings to each game platform 22. The Audio File Importer 214 will be described hereinbelow in more detail.

It is reminded that the import conversion information and the conversion settings are included in the audio source during the importing process. The same audio file 23 or 23′ can be used for many sources 26 or versions and different conversion settings can be assigned to each source 26.

The folders structure according to the first illustrative embodiment is not intended to be limitative. Other folder structures can be of course provided to store the original files and the copies of the imported files.

The Authoring Tool allows importing audio files in many situations, including:
to bring audio files into a project at the beginning thereof, or as the files become available;
to replace audio files previously imported, for example, to replace placeholders or temporary files used at the beginning of the project; or
to bring language audio files into the project for localization. In the Authoring Tool, the Audio File Importer 214 is provided to import SFX or Voice audio files into a project.

As will be described hereinbelow in more detail, the Authoring Tool includes a Project Explorer 74 to allow automatically importing an audio file dragged in one of its user interfaces.

Since the cache folder 32 contains project audio files 50 and 52, and since changes can be made to the Originals folder 30 when, for example files are added, deleted, or replaced, the Authoring Tool includes an Audio File Manager (not shown) to manage the different versions of the audio files during a project, including keeping the project audio files 50 and 52 in sync with those in Originals folder.

More specifically, the Audio File Manager allows clearing the audio cache and updating audio files.

The Audio File Manager includes a Clear Audio File Cache dialog box 54 (see FIG. 10) allowing the user to select the audio files to clear in the cache 32. This dialog box 54 can be used to manage the audio files and more specifically to clear the cache folder so as to remove files that are no longer used, are outdated, or have been found problematic when used.

As illustrated in FIG. 10, the Audio File Manager allows selectively clearing the cache folder based for example on the following:
Audio files: to specify which type of files to clear. All files in the cache can be cleared or only the orphan files, or converted files;
Platforms: to specify for which platform to clear the files;
Languages: to specify the language files to clear.

Orphan files are created when a sound object is deleted; the audio files or orphans are then no longer needed but are still associated with the objects and will remain in the cache folder until they are manually cleared.

In other cases, a platform conversion may have resulted in poor quality and one could want to start over by deleting the converted files for that platform.

The audio cache of older language versions can also be cleared when the final version of language files is delivered.

Finally, it has been found advantageous to clear the entire audio cache before updating the files in a project from the Originals folder.

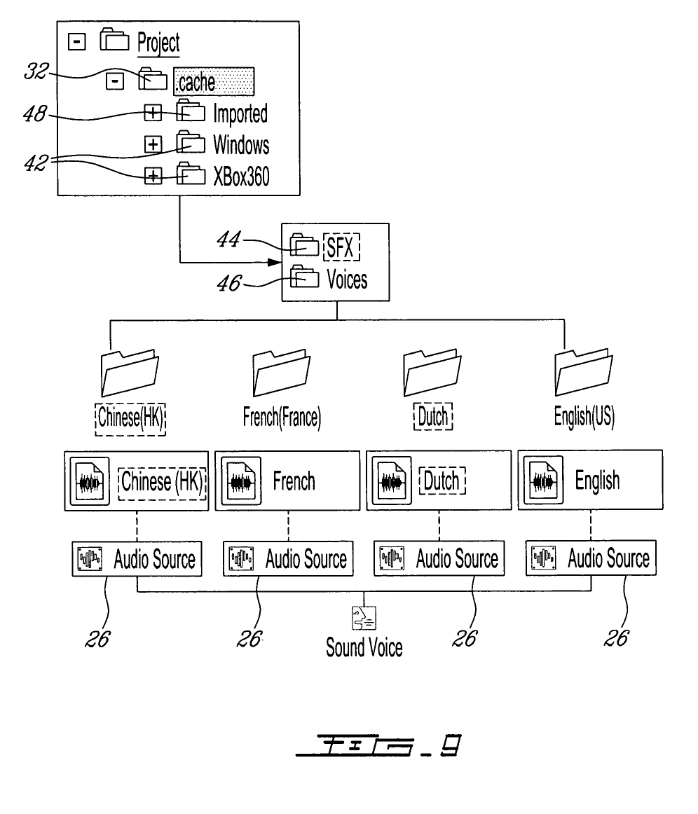

The Audio File Manager further includes an Audio File Update dialog box 56 (see FIG. 11) for updating the cache folder when the files 23 and 23′ in the Originals folder 30 are changed, or new files are added, so that the project references the new audio files for the sound objects. During the update process, out of date files in the cache folder 32 are detected and then updated by the Audio File Manager. The Audio File Update dialog box 56 allows the user to choose to either update all files, or selectively update the audio files for a specific object based on the following:
Languages: to specify which languages file to update. The current language can be chosen or all of the language files can be updated.
Versions: to specify which version's associated audio file to update. The audio file for the version currently in use or all existing versions can be updated.

As mentioned hereinabove, the created copies 24-24′ of the imported files are not tailored for any specific game platform. Thereby, further to the importing process, the imported files can be converted for a specific platform. This additional conversion process includes two steps:
defining the audio conversion settings; and
converting audio files.

Of course, if the created copies 24-24′ are already tailored for a specific platform, conversion settings do not have to be defined for these files which do not have to be converted.

Defining the Audio Conversion Settings

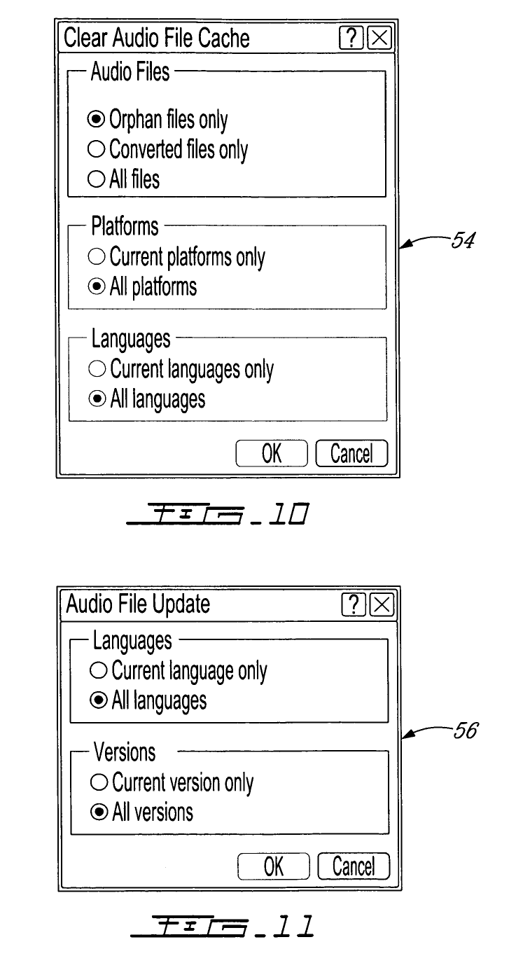

The Authoring Tool includes a Conversion Settings dialog box 58 for defining the conversion settings for selected files or audio files linked to selected objects. The Authoring Tool is configured so that the Conversion Settings dialog box 58, which is illustrated in FIG. 12, can be accessed using conventional editing means for example by selecting an object in the Project Explorer 74, which will be described furtherin.

The Conversion Settings dialog box 58 is also available during the audio files importing process. Indeed, before the audio assets are converted, the settings can be defined based on the project requirements and the requirements of each platform.

As can be seen in FIG. 12, the Conversion Settings dialog box 58 displays the original settings 60 and includes a series of user interface input elements 62 in the form of input boxes and sliders to input values for predetermined parameters 64.

In addition to the various game platforms allowed, a series of input boxes 66 are provided to simultaneously associate settings to all platform versions. It is to be noted that a single interface allows inputting all the conversion settings for all game platform versions.

A “Convert” button is provided to initiate the conversion process. The conversions settings can alternatively be set and saved without being applied.

The Authoring Tool is configured so that the audio conversion process retains the same pitch and duration as the original files 23 and 23′. However, the following properties can be defined for the conversion: Channels, R-L Mix, Sample Rate, Audio Format, Bit Depth, Bit Rate and Filename Marker. Since these properties of audio files are believed to be well-known in the art, and for concision purposes, they will not be described further.

In addition, the Conversion Settings dialog box includes check boxes to disable DC offset removal during the conversion process 68 and to disable dithering during the bit rate conversion 70.

According to another embodiment, another combination of properties can be used to define the conversion settings.

Of course, the Conversion Settings dialog box 58 is adapted to the version class to set.

Converting Audio Files

Audio files can be converted after either the original audio file settings or the conversion settings specified by the user using the Conversion Settings dialog box 58 have been determined. The Authoring Tool includes an Audio File Converter (not shown), having a Converting dialog box 72, for that purpose.

As can be seen in FIG. 13, the Converting dialog box 72 allows defining the following conversion scope:
Plafforms: the current or all of the platforms in the project;
Languages: the current or all of the languages created for the project;
Versions: the selected version of the sound in the Authoring Tool or all versions (sources) of a sound.

The Authoring Tool is further configured to allow converting only the files for a selected object or all unconverted audio files.

The Converting dialog box 72 is available in the Authoring Tool in the same context as the Conversion Settings dialog box 58.

The Conversion Settings dialog box 58 and Converting dialog box 72 are contextual dialog boxes, i.e. they operate on the files or objects from which they have been called. Moreover, the Converting dialog box 72 can be accessed from a menu option in the Authoring Tool which causes the Conversion of all audio files in a project.

Even though the Conversion Settings dialog box 58 according to the first illustrative embodiment includes input boxes to set the conversion settings for a single version class, which in the present case is the game platform, it is believed to be within the reach of a person skilled in the art to provide an alternate dialog box for simultaneously providing settings for two version classes.

Returning briefly to FIG. 2, the method 300 then proceeds in step 310 with modifiers being provided to modify the sound objects. These modifiers include properties and behaviors which can be assigned to the sound objects.

More specifically, the sound objects are grouped and organized in a first hierarchical structure, yielding a tree-like structure including parent-child relationships whereby when properties and behaviours are assigned to a parent, these properties and behaviours are shared by the child thereunder. This hierarchical structure will now be described in more detail.

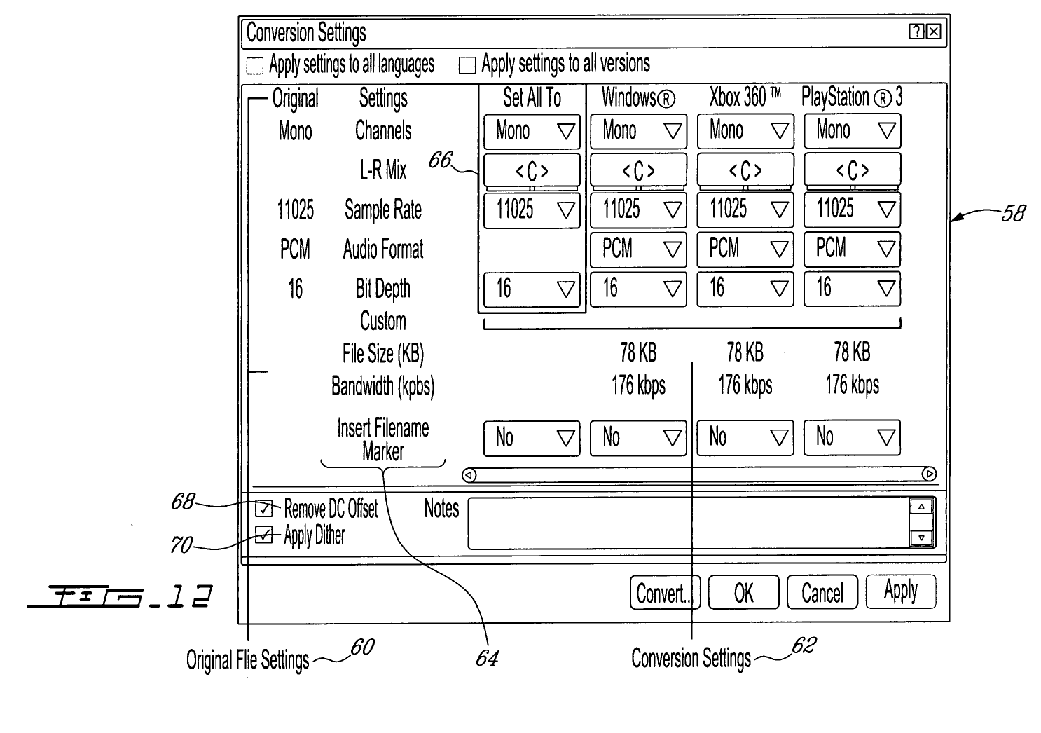

As illustrated in FIG. 14, the hierarchical structure includes containers (C) to group sound objects (S) or other containers (C), and actor-mixers (AM) to group containers (C) or sound objects (S) directly, defining parent-child relationships between the various objects.

As will be described hereinbelow in more detail, sound objects (S), containers (C), and actor-mixers (AM) all define object types within the project which can be characterized by properties, such as volume, pitch, and positioning, and behaviors, such as random or sequence playback.

Also, by using different object types to group sounds within a project structure, specific playback behaviors of a group of sounds can be defined within a game.

The following table summarizes the objects that can be added to a project hierarchy:

TABLE 2

| Object | Icon | Description |
|---|---|---|
| Sounds | | Objects that represent the individual |
| | | audio asset and contain the audio |
| | | source. There are two kinds of sound |
| | | objects: |
| | [symbol] | Sound SFX - sound effect object |
| | [symbol] | Sound Voice - sound voice object. |
| Containers | | A group of objects that contain |
| | | sound objects or other containers |
| | | that are played according to certain |
| | | behaviors. Properties can be applied |
| | | to containers which will affect the |
| | | child objects therein. There are three |
| | | kinds of containers: |
| | [symbol] | Random Containers - group of one |
| | | or more sounds and/or containers |
| | | that can be played back in a random |
| | | order or according to a specific |
| | | playlist. |
| | [symbol] | Sequence Container - group of one |
| | | or more sounds and/or containers |
| | | that can be played back according to |
| | | a specific playlist. |
| | [symbol] | Switch Container - A group of one |
| | | or more containers or sounds that |
| | | correspond to changes in the game. |
| Actor-Mixers | [symbol] | High level objects into which other |
| | | objects such as sounds, containers |
| | | and/or actor-mixers can be grouped. |
| | | Properties that are applied to an |
| | | actor-mixer affect the properties of |
| | | the objects grouped under it. |
| Folders | [symbol] | High level elements provided to |
| | | receive other objects, such as |
| | | folders, actor-mixers, containers and |
| | | Sounds. Folders cannot be child |
| | | objects for actor-mixers, containers, |
| | | or sounds. |
| Work Units | [symbol] | High level elements that create XML |
| | | files and are used to divide up a |
| | | project so that different people can |
| | | work on the project concurrently. It |
| | | can contain the hierarchy for project |
| | | assets as well as other elements. |
| Master-Mixers | [symbol] | Master Control Bus/Control Bus |

The icons illustrated in the above table are used both to facilitate the reference in the present description and also to help a user navigate in an Audio Tab 76 of the Project Explorer 74 provided with the Authoring Tool, and which allows a user to create and manage the hierarchical structure as will be explained hereinbelow in more detail.

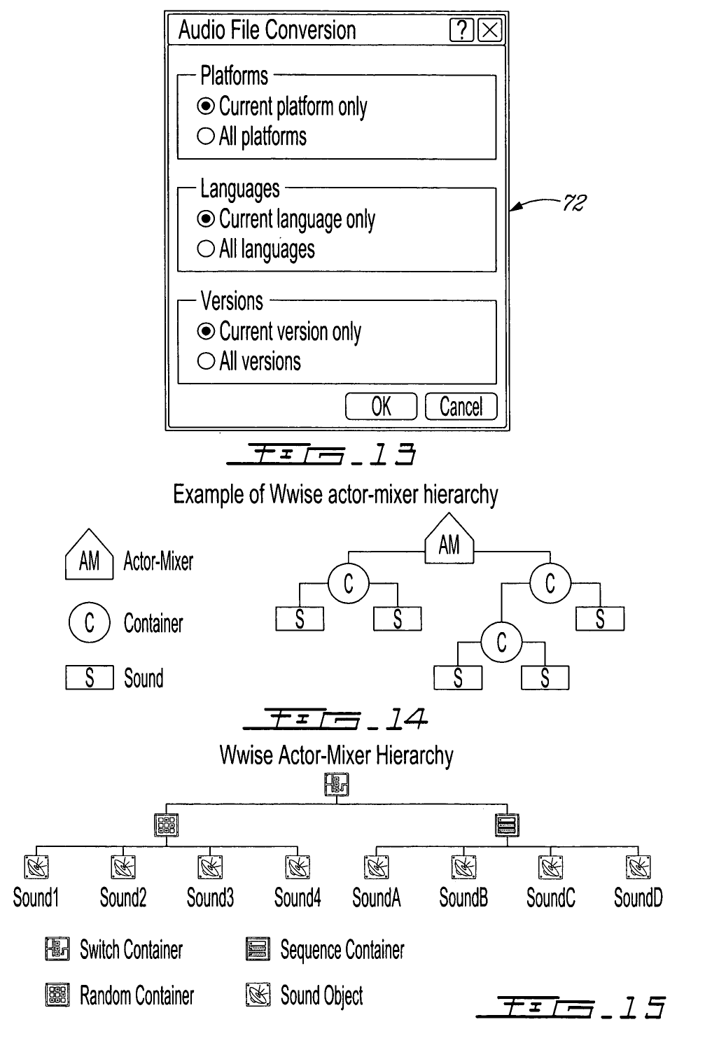

With reference to FIG. 15, containers define the second level in the Actor-Mixer Hierarchy. Containers can be both parent and child objects. Containers can be used to group both sound objects and containers. As will be described hereinbelow in more detail, by “nesting” containers within other containers, different effects can be created and realistic behaviors can be simulated.

Actor-mixers sit one level above the container. The Authoring Tool is configured so that an actor-mixer can be the parent of a container, but not vice versa.

Actor-mixers can be the parent of any number of sounds, containers, and other actor-mixers. They can be used to group a large number of objects together to apply properties to the group as a whole.

FIG. 16 illustrates the use of actor-mixers to group sound objects, containers, and other actor-mixers.

The characteristics of the random, sequence and switch containers will also be described hereinbelow in more detail.

The above-mentioned hierarchy, including the sound objects, containers, and actor-mixers will be referred to herein as the Actor-Mixer hierarchy.

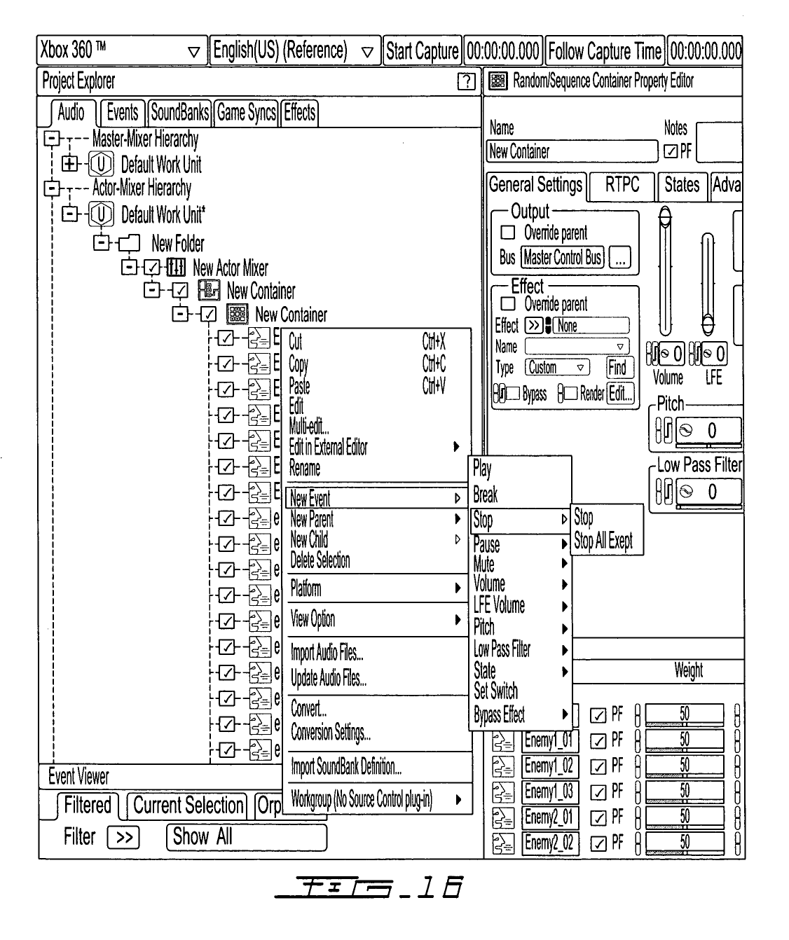

An additional hierarchical structure sits on top of the Actor-Mixer hierarchy in a parent-like relationship: the Master-Mixer hierarchy. The Master-Mixer Hierarchy is a separate hierarchical structure of control busses that allows re-grouping the different sound structures within the Actor-Mixer Hierarchy and preparing them for output. The Master-Mixer Hierarchy consists of a top-level “Master Control Bus” and any number of child control busses below it. FIG. 17 illustrates an example of a project hierarchy including Master-Mixer and Actor-Mixer hierarchies. As can also be seen in FIG. 17, the Master-Mixer and control busses are identified by a specific icon.

The child control busses allow grouping the sound structures according to the main sound categories within the game. Examples of user-defined sound categories include:
voice;
ambience;
sound effects; and
music.

These control busses create the final level of control for the sound structures within the project. They sit on top of the project hierarchy allowing to create a final mix for the game. As will be described hereinbelow in more detail, the Authoring Tool further allows applying effects to the busses to create the unique sounds that the game requires.

Since the control busses group complete sound structures, they can further be used to troubleshoot problems within the game. For example, they allow muting the voices, ambient sounds, and sound effects busses, to troubleshoot the music in the game.

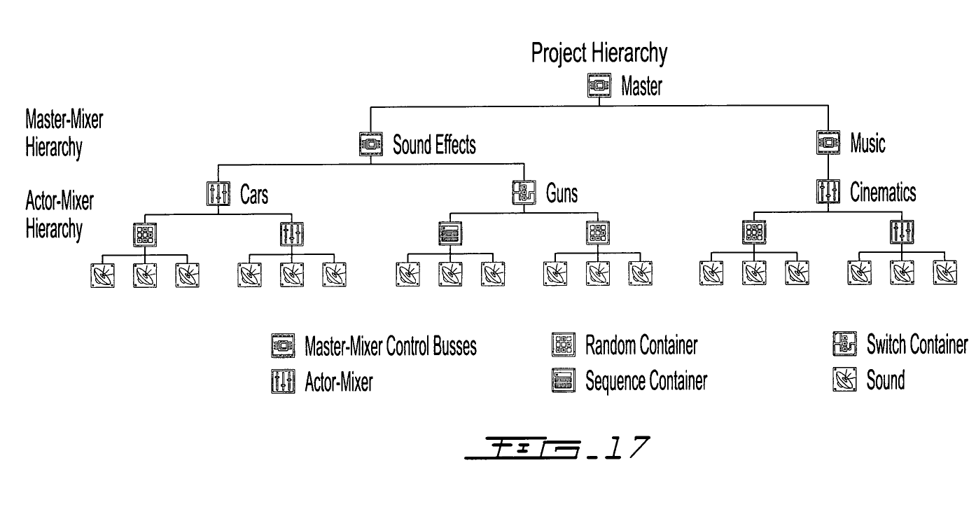

An object within the hierarchy is routed to a specific bus. However, as illustrated in FIG. 18, the hierarchical structure allows defining the routing for an entire sound structure by setting the routing for the top-level parent object. The output routing is considered an absolute property. Therefore, these settings are automatically passed down the child objects below it. Other characteristics and functions of the Master-Mixer hierarchy will be described hereinbelow in more detail.

As can be seen in FIG. 19, the Authoring Tool includes a Project Explorer GUI 74, including an Audio tab 76 allowing creating and editing an audio project, including the project hierarchy structure 78.

The Project Explorer GUI 74 includes further secondary user interfaces accessible through tabs 80-82, 134 allowing to access different aspect of the audio project including: Events and Soundbanks. Each of these aspects will be described hereinbelow in more detail.

The Audio tab 76 is provided to display the newly created sound objects 28 resulting from the import process and to build the actual project hierarchy 78. It is configured to allow either:
setting up the project structure and then importing audio files therein;
importing audio files and then organizing them afterwards into a project structure.

As briefly described in Table 1, a hierarchy can be built under work units.

The Audio tab 76 displays the project hierarchy in a tree view 78 including both the Actor-Mixer 79 and the Master-Mixer 81 hierarchies. Navigation through the tree is allowed by clicking conventional alternating plus (+) and minus (−) signs which causes the correspondent branch of the tree to respectively expand or collapse.

According to other embodiments (not shown), the Actor-Mixer 79 and Master-Mixer hierarchies can be displayed and managed through different user interfaces.

In addition to the icons used to identify different object types within the project, other visual elements, such as colors are used in the Audio tab 76 and more generally in the Project Explorer 74 to show the status of certain objects.

As illustrated in numerous examples hereinabove, indentation is used to visually distinguished parent from child levels. Other visual codes can be used including, colors, geometrical shapes and border, text fonts, text, etc.

A shortcut menu 83, such as the one illustrated in FIG. 19, is available for each object in the hierarchy. This menu 83 can be made available through any conventional GUI means including for example by right-clicking on the selected object name from the list tree 78. The menu 83 offers the user access to hierarchy management-related options. Some of the options from the menu include sub-menu options so as to allow creating the hierarchical structure as described hereinabove. For example, a “New Child” option, which allows creating a new child in the hierarchy to the parent selected by the user, further includes the options of defining the new child as folder, an actor-mixer, a switch-container, a random-sequence container, a sound effects or a sound voice for example. A similar process can be used to create a parent in the hierarchy. As can also be seen from FIG. 19, the Audio tab 76 is further configured with conventional editing functionalities, including cut and paste, deleting, renaming and moving of objects. These functionalities can be achieved through any well-known conventional GUI means.

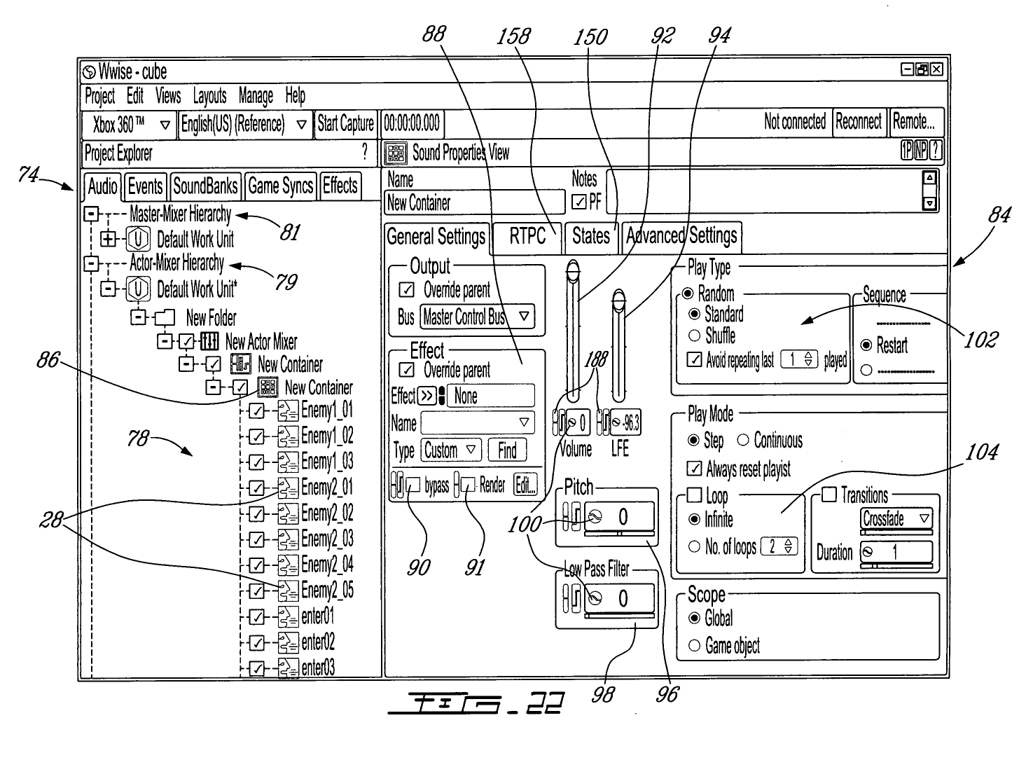

A Contents Editor 106, which will be described hereinbelow in more detail with reference to FIG. 24, is also provided with similar conventional editing functionalities which will not be described herein for concision purposes and since they are believed to be within the reach of a person of ordinary skills in the art.

The hierarchical structure is such that when sounds are grouped at different levels in the hierarchy 78, the object properties and behaviors of the parent objects affect the child objects differently based on the property type.

Properties

The properties of an object can be divided into two categories:
relative properties, which are cumulative and are defined at each level of the hierarchy, such as pitch and volume.

The sum of all these values determines the final property; and
absolute properties, which are defined at one level in the hierarchy, usually the highest. An example of an absolute property includes playback priority. As will be described hereinbelow in more detail, the Authoring Tool is so configured as to allow overriding the absolute property at each level in the hierarchy.

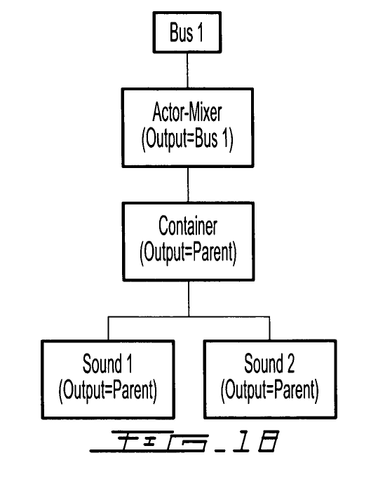

FIG. 20 illustrates how the two types of property values work within the project hierarchy. In this example, the positioning properties are absolute properties defined at the Actor-Mixer level. This property is therefore assigned to all children object under the actor-mixer. On the other hand, different volumes are set for different objects within the hierarchy, resulting in a cumulative volume which is the sum of all the volumes of the objects within the hierarchy since the volume is defined as a relative property.

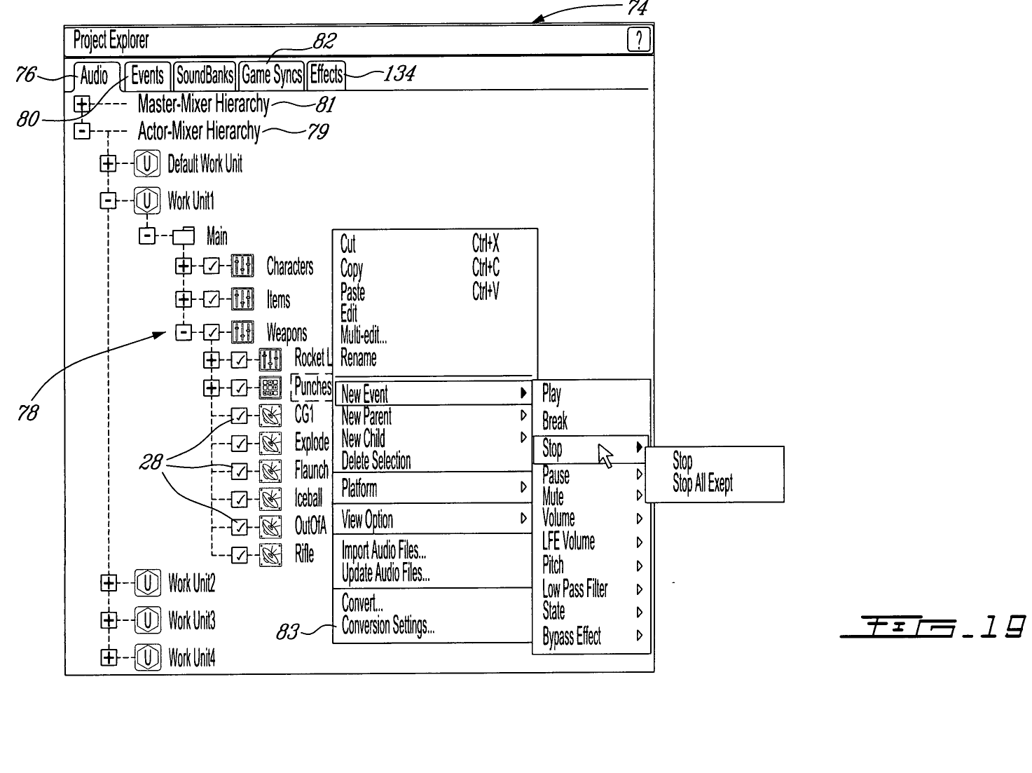

A preliminary example of the application of the hierarchical structure to group and manage sound objects according to the first illustrative embodiment is illustrated in FIG. 21, referring to pistol sounds in a well-known first person shooter game.

The game includes seven different weapons. Grouping all the sounds related to a weapon into a container allows the sounds for each weapon to have similar properties. Then grouping all the weapon containers into one actor-mixer provides for controlling properties such as volume and pitch properties of all weapons as one unit.

Object behaviors determine which sound within the hierarchy will be played at any given point in the game. Unlike properties, which can be defined at all levels within the hierarchy; behaviors can be defined for sound objects and containers. The Authoring Tool is also configured so that the types of behaviors available differ from one object to another as will be described furtherin.

Since the Authoring Tool is configured so that absolute properties are automatically passed down to each of a parent's child objects, they are intended to be set at the top-level parent object within the hierarchy. The Authoring Tool is further provided with a Property Editor GUI 84 (see FIG. 22) allowing a user to specify different properties for a particular object should the user decide to override the parent's properties and set new ones.

The Property Editor 84 is provided to edit the property assigned to a selected object 86 (“New Container” in the example of FIG. 22) among the objects listed in the hierarchy 76. The Property Editor 84 includes a series of GUI elements 88 to apply effects to the object 86 to further enhance the sound in-game. Examples of effects that can be applied to a hierarchical object include: reverb, parametric EQ, delay, etc. The Property Editor GUI 84 further includes a check box 90 allowing bypassing a selected effect so that a user can audition the original unprocessed version. The Property Editor GUI 84 further includes a check box 91 allowing rendering a selected effect so that the effect is rendered before a SoundBank is generated.

According to the illustrative embodiment, the Property Editor includes control panel group of elements 92-98 to modify the value of the following four relative properties:
volume;
LFE (Low Frequency Effect);
pitch; and
LPF (Low Pass Filter).

The control panel of the Property Editor 84 includes sliding cursors, input boxes, and check boxes for allowing setting the property values.

The present Authoring Tool is however not limited to these four properties, which are given for illustrative purposes only.

The Authoring Tool is further programmed with a Randomizer to randomly modify some property values of an object each time it is played. More specifically, the Randomizer function is assigned to some of the properties and can be enabled or disabled by the user via a pop up menu accessible, for example, by right-clicking on the property selected in the Property Editor 84. Sliders, input boxes and/or any other GUI input means are then provided to allow the user inputting a range of values for the randomizing effect.

Selected properties include a randomizer indicator 100 to indicate to the user whether the corresponding function has been enabled and to trigger the function.

Behaviours

In addition to properties, each object in the hierarchy can be characterized by behaviours.

The behaviors determine for example how many times a sound object will play each time it is called or the order it will play, and whether the sound is stored in memory or streamed directly from an external medium such as a DVD, a CD, or a hard drive. Unlike properties that can be defined at all levels within the hierarchy, behaviors are defined for sound objects and containers. The Authoring Tool is configured such that different types of behaviors are made available from one object to another.

The Property Editor 184 includes control panel elements 102-104 allows defining respectively the following behaviors for a sound object:
Looping; and
Streaming.

The Authoring Tool is configured so that, by default, sound objects play once from beginning to end. However, a loop can be created so that a sound will be played more than once. In this case, the number of times the sound will be looped should also be defined. The loop control panel element 102 (“Loop”) allows setting whether the loop will repeat a specified number of times or indefinitely.

The stream control panel element (“Stream”) 104 allows setting which sounds will be played from memory and which ones will be streamed from the hard drive, CD, or DVD. When media is streamed from the disk or hard drive, an option is also available to avoid any playback delays by creating a small audio buffer that covers the latency time required to fetch the rest of the file. The size of the audio buffer can be specified so that it meets the requirements of the different media sources, such as hard drive, CD, and DVD.

Containers

Since different situations within a game may require different kinds of audio play back, the hierarchical structure allows to group objects into any of the following three different types of containers:
Random containers;
Sequence containers;
Switch containers.

As will now be described in further detail, each container type includes different settings which can be used to define the playback behavior of sounds within the game. For example, random containers play back the contents of the container randomly, sequence containers play back the contents of the container according to a playlist, and switch containers play back the contents of the container based on the current switch, state or RTPC within the game. A combination of these types of containers can also be used. Each of these types of containers will now be described in more detail.

Random Container

Random containers are provided in the hierarchy to play back a series of sounds randomly, either as a standard random selection, where each object within the container has an equal chance of being selected for playback, or as a shuffle selection, where objects are removed from the selection pool after they have been played. Weight can also be assigned to each object in the container so as to increase or decrease the probability that an object is selected for playback.

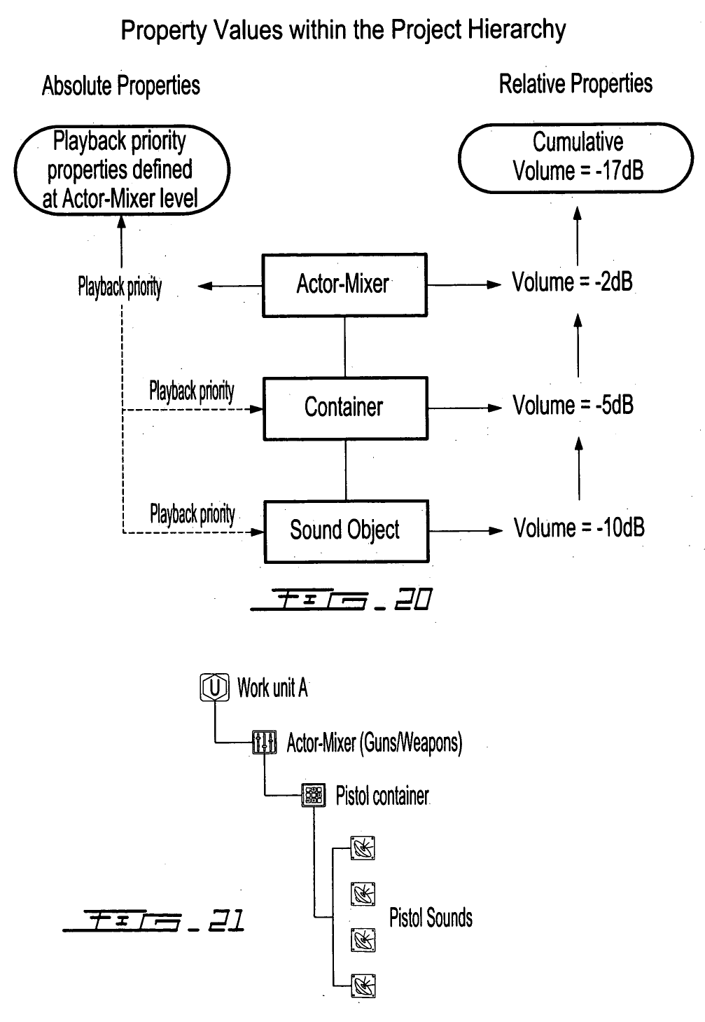

An example of use of a random container will now be described with reference to FIG. 23, where sounds are added in a cave environment in a video game. A random container is used to simulate the sound of water dripping in the background to give some ambience to the cave environment. In this case, the random container groups different water dripping sounds. The play mode of the container is set to Continuous with infinite looping to cause the sounds to be played continuously while the character is in the cave. Playing the limited number of sounds randomly adds a sense of realism.

As will be described hereinbelow in more detail, random and sequence containers can be further characterized by one of the following two play modes: Continuous and Step.

The Property Editor 84 is configured to allow creating a random container wherein objects within the container are displayed in the Contents Editor GUI 106.

The Contents Editor 106 will now be described in more detail with reference to FIG. 24.

The Contents Editor 106 includes a list of the objects 108 nested in the container and associated property controls including properties associated to each object which can be modified using, in some instance, either a conventional sliding cursor or an input box, or in other instances a conventional check box.

The Contents Editor 106 displays the object or objects 108 that are contained within the parent object that is loaded into the Property Editor 84. Since the Property Editor 84 can contain different kinds of sound structures, the Contents Editor 106 is configured to handle them contextually. The Contents Editor 106 therefore includes different layouts which are selectively displayed based on the type of object loaded.

For example, as illustrated in FIG. 24, when sound structures are loaded into the Contents Editor 106, it provides at a glance access to some of the most common properties associated with each object 108, such as volume and pitch. By having the settings in the Contents Editor 106, a parent's child objects can be edited without having to load them into the Property Editor 84. The Contents Editor 106 also provides the tools to define playlists and switch behaviors, as well as manage audio sources as will be described hereinbelow in more detail.

The general operation of the Contents Editor 106 will now be described.

When an object from the hierarchy is added to the Property Editor 84, its child objects 108 are displayed in the Contents Editor 106. As can be seen in FIG. 24, the Contents Editor 106, when invoked for an Actor-Mixer object, includes the list of all the objects 108 nested therein and for each of these nested objects 108, property controls including properties which can be modified using, in some instances, either a conventional sliding cursor or an input box, or in other instances a conventional check box.

The Authoring Tools is configured so as to allow a user to add an object to the Contents Editor 106 indirectly when it is added to the Property Editor 84, wherein its contents are simultaneously displayed in the Contents Editor 106, or directly into the Contents Editor 106, for example by dragging it into the Contents Editor 106 from the Audio tab 76 of the Project Explorer 76.

The Contents Editor 106 is further configured to allow a user to selectively delete an object, wherein a deleted object from the Contents Editor 106 is deleted from the current project. However, the Authoring Tool is programmed so that deleting an object from the Contents Editor 106 does not automatically delete the associated audio file from the project .cache folder. To delete the orphan file, the audio cache has to be cleared as discussed hereinabove.

The Property Editor 84 further contextually includes an interactive menu portion 110 (see FIG. 25) allowing to define the container as a random container and offering the following options to the user:
Standard: to keep the pool of objects intact. After an object is played, it is not removed from the possible list of objects that can be played and can therefore be repeated;
Shuffle: to remove objects from the pool after they have been played. This option avoids repetition of sounds until all objects have been played.

As illustrated in FIG. 25, the interactive menu portion 110 further includes an option to instruct the Authoring Tool to avoid playing the last x sounds played from the container. The behavior of this option is affected by whether in a Standard or a Shuffle mode:
in Standard mode, the object played is selected completely randomly, but the last x objects played are excluded from the list;
in Shuffle mode, when the list is reset, the last x objects played will be excluded from the list.

As mentioned hereinabove, the objects in the container can further be prioritized for playback, for example by assigning a weight thereto.

Sequence Container

Sequence containers are provided to play back a series of sounds in a particular order. More specifically, a sequence container plays back the sound objects within the container according to a specified playlist.

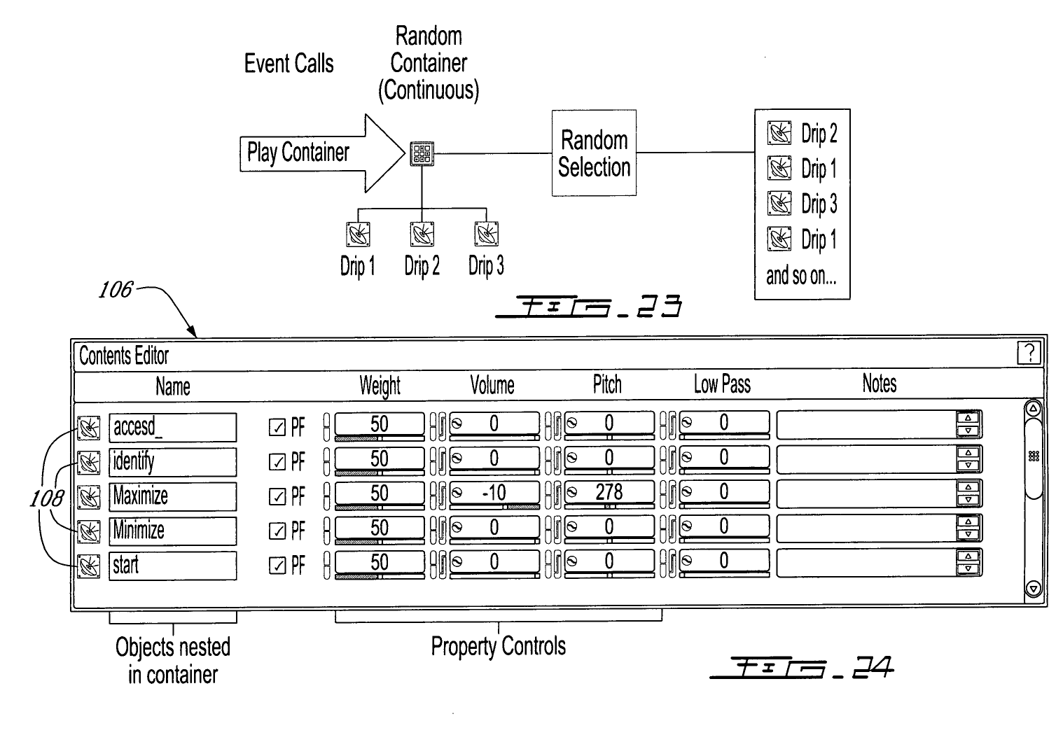

An example of use of a sequence container will now be described with reference to FIG. 26, where sounds are added to a first person shooter game. At one point in the game, the player must push a button to open a huge steel door with many unlocking mechanisms. In this case, all the unlocking sounds are grouped into a sequence container. A playlist is then created to arrange the sounds in a logical order. The play mode of the container is then set to Continuous so that the unlocking sounds play one after the other as the door is being unlocked.

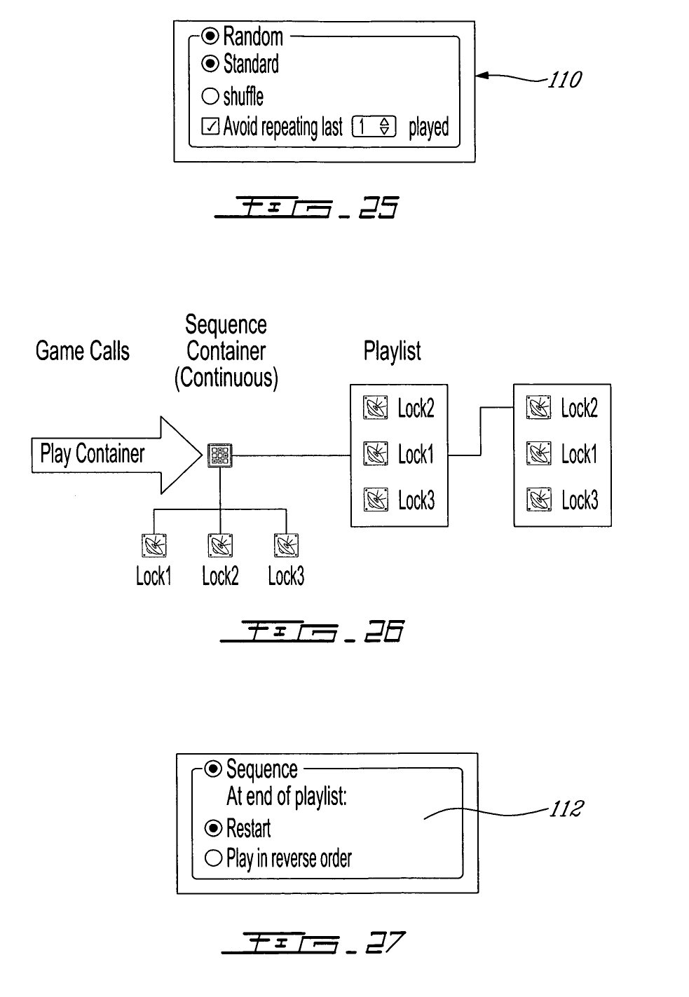

After objects are grouped in a container, the container can be defined as a sequence container in the Property editor 84. The interactive menu portion 112 of the Contents Editor 106 includes the following options to define the behavior at the end of the playlist (see FIG. 27):
Restart: to play the list in its original order, from start to finish, after the last object in the playlist is played;
Play in reverse order: to play the list in reverse order, from last to first, after the last object in the playlist is played.

The Contents Editor 106 is configured so that when a sequence container is created, a Playlist pane 114 including a playlist is added thereto (see FIG. 28). The playlist allows setting the playing order of the objects within the container. As will now be described in more detail, the Playlist pane 114 further allows adding, removing, and re-ordering objects in the playlist.

As in the case of any other types of containers or Actor-mixers, the Project Explorer 74 is configured so as to allow conventional drag and drop functionalities to add objects therein. These drag and drop functionalities are used to add objects in the playlist via the Playlist pane 114 of the Contents editor 106.

It is however believed to be within the reach of a person skilled in the art to provide other means to construct the hierarchy and more generally to add elements to lists or create links between elements of the audio projects.

The Playlist pane 114 and more generally the Project Explorer 74 are programmed to allow well-known intuitive functionalities such as allowing deletion of objects by depressing the “Delete” key on the keyboard, etc.

It is reminded that the playlist may include containers, since containers may includes containers.

The Playlist pane 114 is further configured to allow re-ordering the objects in the playlist. This is achieved, for example, by allowing conventional drag and drop of an object to a new position in the playlist.

Finally, the Playlist pane is configured to highlight the object being played as the playlist is played. Other means to notify the user which object is being played can also be provided, including for example a tag appearing next to the object.

Defining How Objects Within a Container are Played

Since both random and sequence containers consist of more than one object, the Property Editor 84 is further configured to allow specifying one of the following two play modes:
Step: to play only one object in the container each time the container is played;
Continuous: to play the complete list of objects in the container each time the container is played. This mode further allows looping the sounds and creating transitions between the various objects within the container.

The step mode is provided to play only one object within the container each time it is called. For example, it is appropriate to use the step mode each time a handgun is fired and only one sound is to be played or each time a character speaks to deliver one line of dialogue.

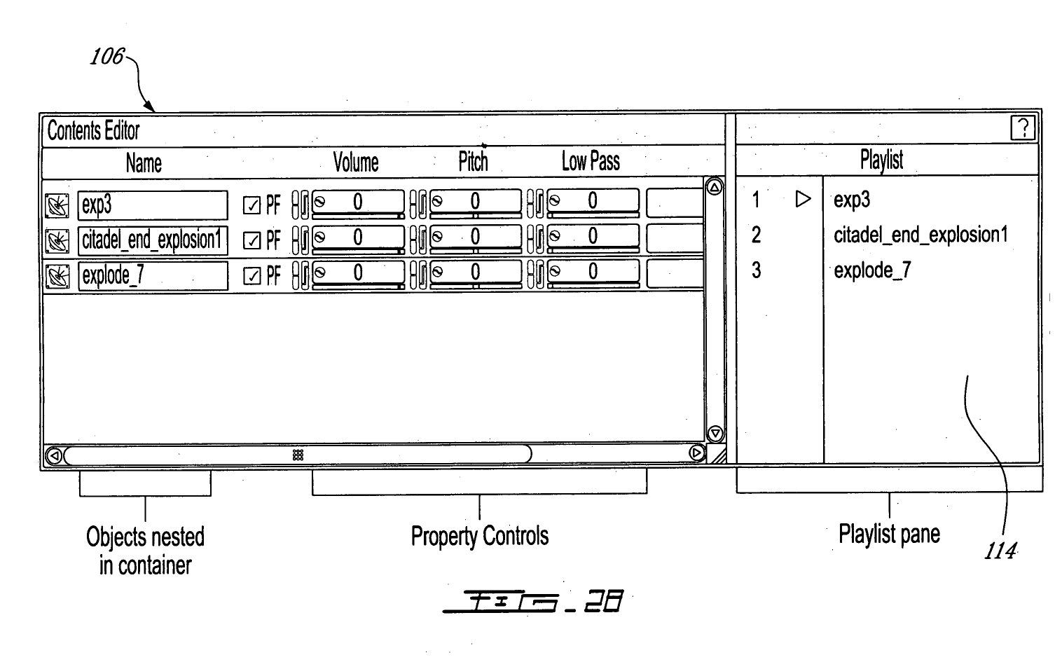

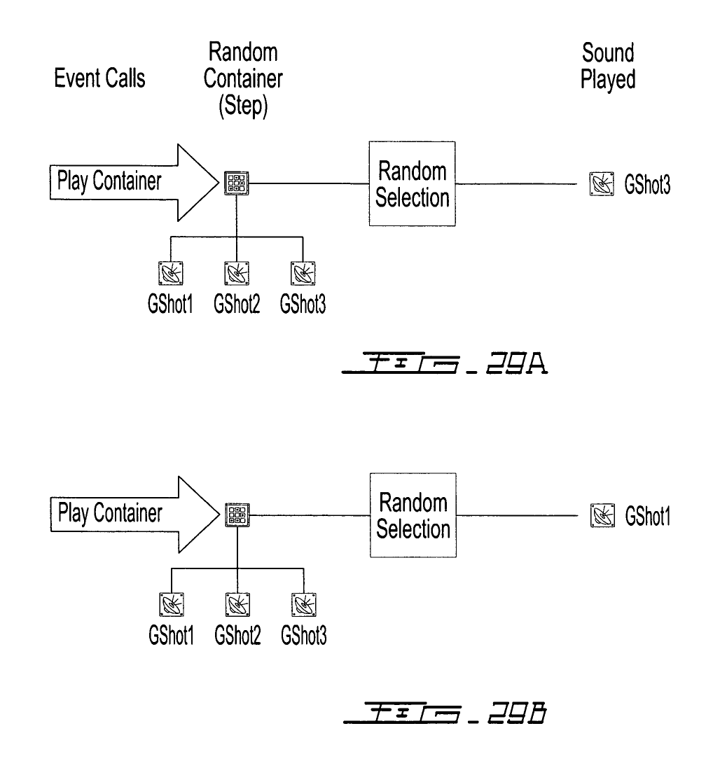

FIGS. 29A-29B illustrate another example of use of the step mode in a random container to play back a series of gun shot sounds.

The continuous mode is provided to play back all the objects within the container each time it is called. For example, the continuous mode can be used to simulate the sound of certain guns fired in sequence within a game.

FIG. 27 illustrates an example of use of a sequence container played in continuous mode.

The Property Editor 84 is configured to allow the user to add looping and transitions between the objects when the Continuous playing mode is selected.

It is to be noted that when a random container is in the Continuous mode, since weighting can be applied to each object within the container, some objects may be repeated several times before the complete list has played once.

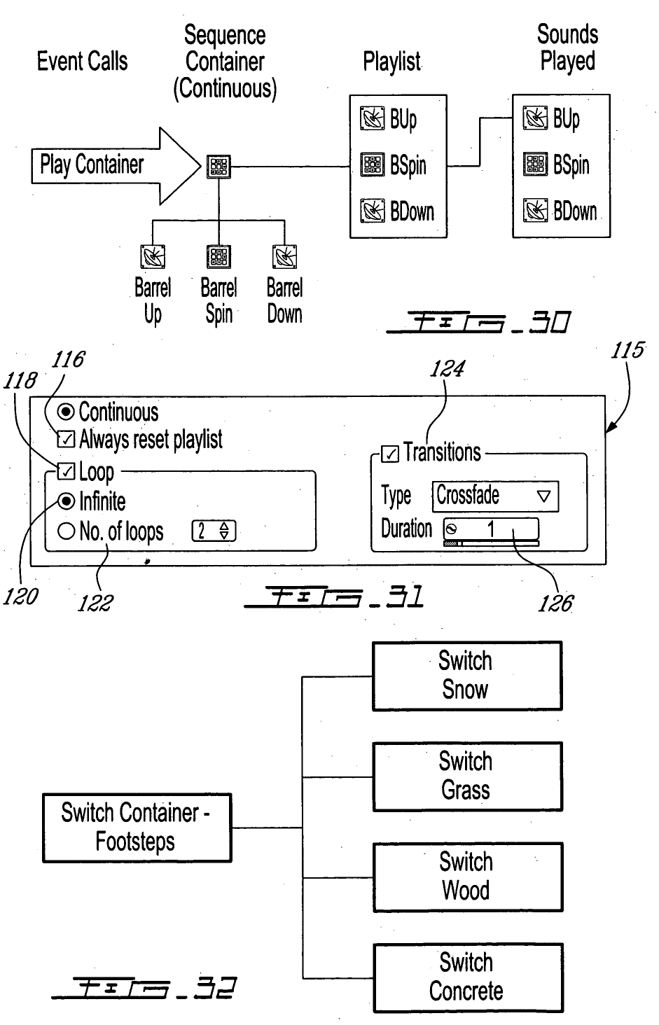

FIG. 31 illustrates an example of a “Continuous” interactive menu portion 115 from the Property Editor 84 allowing a user to define the playing condition for objects in a continuous sequence or random container.

An “Always reset playlist” option and corresponding checkbox 116 are provided to return the playlist to the beginning each time a sequence container is played. A “Loop” option and corresponding checkbox 118 obviously allow looping the entire content of the playlist. While this option is selected, an “Infinite” option 120 is provided to specify that the container will be repeated indefinitely, while the “No. of Loops” option 122 is provided to specify a particular number of times that the container will be played. The “Transitions” option 124 allows selecting and applying a transition between the objects in the playlist. Examples of transitions which can be provided in a menu list include:
a crossfade between two objects:
a silence between two objects; and
a seamless transition with no latency between objects.

As illustrated in FIG. 31, a Duration text box 126 in the Transition portion of the GUI is provided for the user to enter the length of time for the delay or cross-fade.

The Property Editor 84 is further provided with user interface elements allowing the user to select the scope of the container. According to the first illustrative embodiment, the scope of a container can be either:
Global: wherein all instances of the container used in the game are treated as one object so that repetition of sounds or voices across game objects is avoided; or
Game object: wherein each instance of the container is treated as a separate entity, with no sharing of sounds occurring across game objects.

Indeed, since the same container can be used for several different game objects, the Property Editor 84 includes tools to specify whether all instances of the container used in the game should be treated as one object or each instance should be treated independently.

It is to be noted that the Authoring Tool is so configured that the Scope option is not available for sequence containers in Continuous play mode since the entire playlist is played each time an event triggers the container.

The following example illustrates the use of the Scope option. It involves a first person role-playing game including ten guards that all share the same thirty pieces of dialogue. In this case, the thirty Sound Voice objects can be grouped into a random container that is set to Shuffle and Step. The Authoring Tool allows using this same container for all ten guards and setting the scope of the container to Global to avoid any chance that the different guards may repeat the same piece of dialogue. This concept can be applied to any container that is shared across objects in a game.

Switch Containers

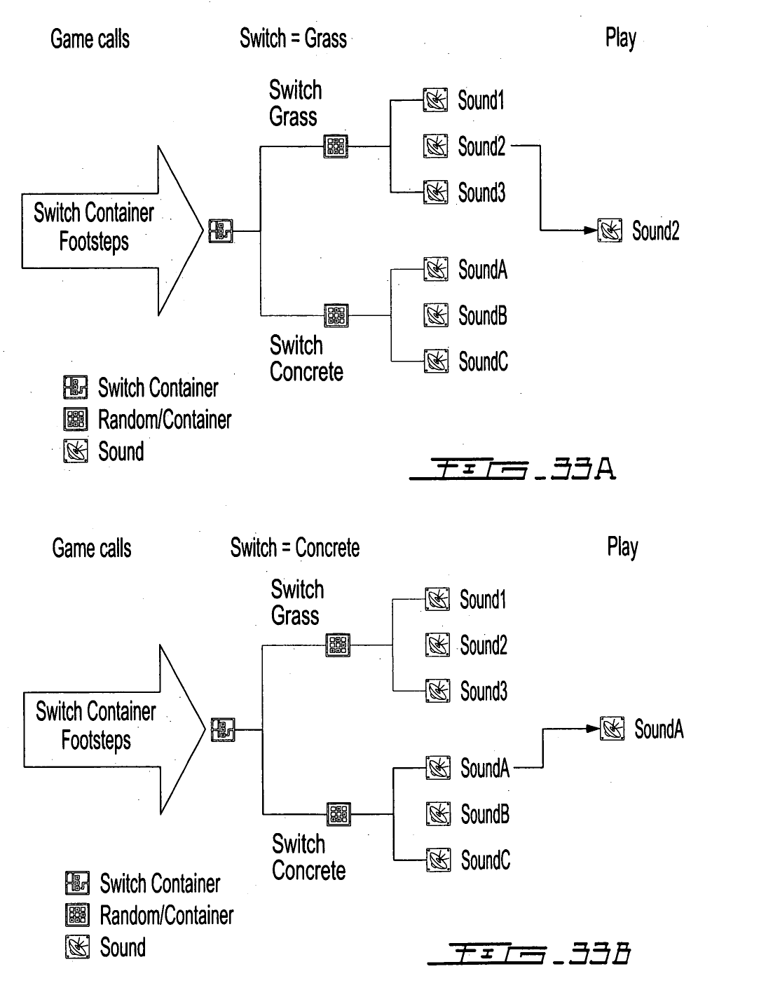

Switch containers are provided to group sounds according to different alternatives existing within a game. More specifically, they contain a series of switches or states or Real-time Parameter Controls (RTPC) that correspond to changes or alternative actions that occur in the game. For example, a switch container for footstep sounds might contain switches for grass, concrete, wood and any other surface that a character can walk on in game (see FIG. 32).

Switches, states and RTPCs will be referred to generally as game syncs. Game syncs are included in the Authoring Tool to streamline and handle the audio shifts that are part of the game. Here is a summary description of what each of these three game syncs are provide to handle:
States: a change that affects the audio properties on a global scale;
Switches: a change in the game action or environment that requires a completely new sound;
RTPCs: game parameters mapped to audio properties so that when the game parameters change, the mapped audio properties will also reflect the change.

The icons illustrated in the following table are used both to facilitate the reference in the present description and also to help a user navigate in the Audio Tab 76 of the Project Explorer 74.

TABLE 3

| Icon | Represents |
|---|---|
| [symbol] | State |
| [symbol] | Switch |
| [symbol] | RTPC |

Each of these three game syncs will now be described in further detail.

Each switch/state includes the audio objects related to that particular alternative. For example, all the footstep sounds on concrete would be grouped into the “Concrete” switch; all the footstep sounds on wood would be grouped into the “Wood” switch, and so on. When the game calls the switch container, the sound engine verifies which switch/state is currently active to determine which container or sound to play.

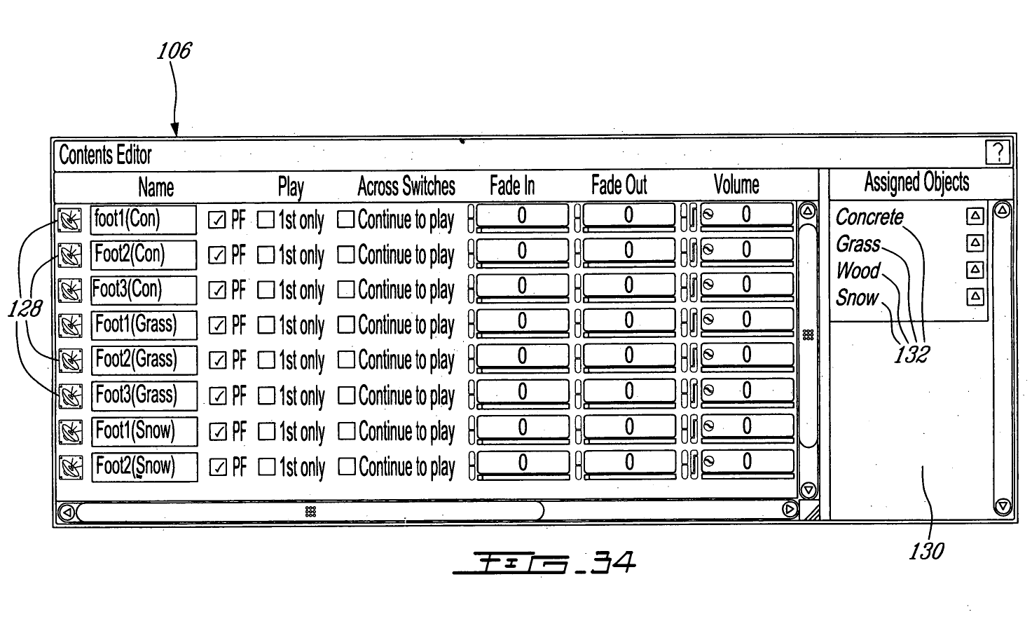

FIGS. 33A-33B illustrate what happens when an event calls a switch container called “Footsteps”. This container has grouped the sounds according to the different surfaces a character can walk on in game. In this example, there are two switches: Grass and Concrete. When the event calls the switch container, the character is walking on grass (Switch=Grass), so the footstep sounds on grass are played. A random container is used to group the footstep sounds within the switch so that a different sound is played each time the character steps on the same surface.

The Property Editor 84 includes a Switch type GUI element (not shown), in the form for example, of a group box, to allow a user to select whether the switch container will be based on states or switches. The Property Editor 84 further includes a GUI element (not shown) for assigning a switch or state group to the container. Of course, this switch or state group has been previously created as will be described furtherin.

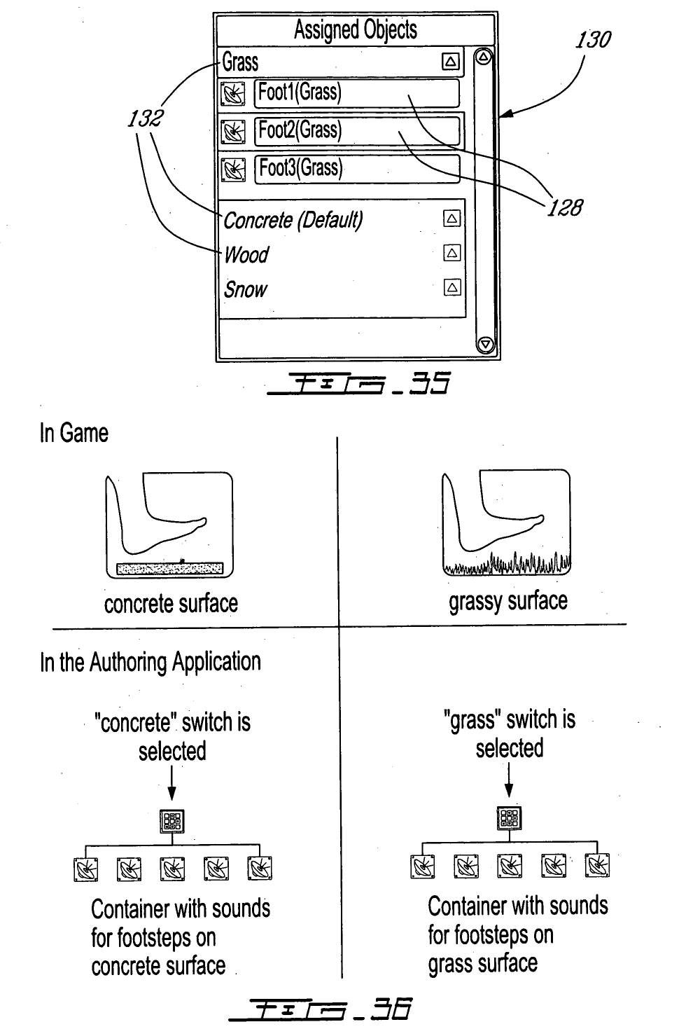

The Property Editor 84 is configured so that when a switch container is loaded thereinto, its child objects 128 are displayed in the Contents Editor 106 (see FIG. 34). The Contents Editor 106 further includes a list of behaviors for each of the objects nested in the container. These behaviors are modifiable using GUI elements as described hereinabove. The Contents Editor 106 further includes an “Assigned Objects” window pane 130 including switches 132 within a selected group. The objects 128 can be assigned to these switches 132 so as to define the behavior for the objects when the game calls the specific switch.

As illustrated in FIG. 35, the Assigned Objects pane 130 of the Contents Editor 106 is configured to add and remove objects 128 therein and assign these objects 128 to a selected switch. More specifically, conventional drag and drop functionalities are provided to assign, de-assign and move an object 128 to a pre-determined switch 132. Other GUI means can of course be used.

With reference to FIG. 34, the Contents Editor 106 is configured to allow a user to determine the playback behavior for each object within the container since switches and states can change frequently within a game. More specifically, the following playback behaviors can be set through the Contents Editor 106 using respective GUI elements:
Play: determines whether an object 128 will play each time the switch container is triggered or just when a change in switch/state occurs;
Across Switches: determines whether an object 128 that is in more than one switch will continue to play when a new switch/state is triggered;
Fade In: determines whether there will be a fade in to the new sound when a new switch/state is triggered; and
Fade Out: determines whether there will be a fade out from the existing sound when a new switch/state is triggered.

The switch container is configured with the “step” and “continuous” play mode which has been described herein with reference to sequence containers for example.

Since switches and states syncs share common characteristics, the GUI of the Contents Editor 106 is very similar in both cases. For such reason, the GUI of the Contents Editor 106 when it is invoked for States will not be described hereinbelow in more detail.

Switch

The concept of switches will now be described in further detail.

As mentioned hereinabove, switches represent the alternatives that exist for a particular element in game, and are used to help manage the corresponding sounds for these alternatives. In other words, sounds are organized and assigned to switches so that the appropriate sounds will play when the changes take place in the game.

Returning to the surface switch example which began with reference to FIGS. 32, 33A and 33B, one can create a switch called “concrete” and assign a container with footstep sounds that match the concrete surface to this switch. Switches for grass, gravel and so on can also be created and corresponding sounds assigned to these switches.

In operation, the sounds and containers that are assigned to a switch are grouped into a switch container. When an event signals a change in sounds, the switch container verifies the switch and the correct sound is played.

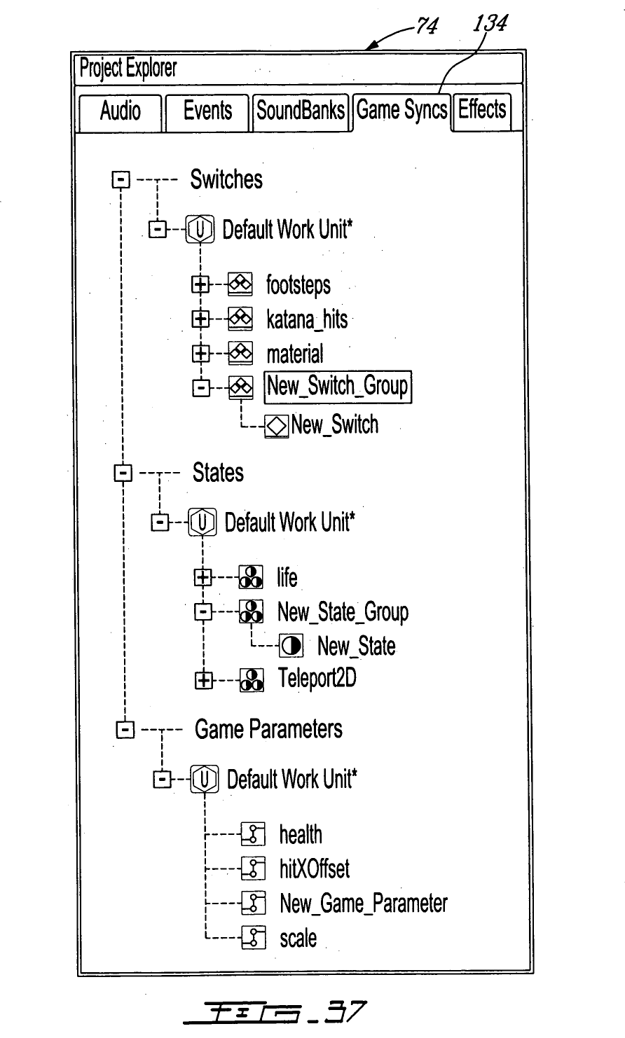

With reference to FIGS. 33A-33B and 36, when the main character of a game is walking on a concrete surface for example, the “concrete” switch and its corresponding sounds are selected to play, and then if the character moves from concrete to grass the “grass” switch is called by the sound engine.

Before being used in a switch container, switches are first grouped in switch groups. Switch groups contain related segments in a game based on the game design. For example, a switch group called “Ground Surfaces” can be created for the “grass” and “concrete” switches illustrated in FIGS. 33A-33B and 36 for example.

The icons illustrated in the following table are used both to facilitate the reference in the present description and also to help a user navigate in the Audio Tab 76 of the Project Explorer and in other user interfaces of the Authoring Tool.

74.

TABLE 4

| Icon | Represents |
|---|---|
| 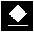 | Switch |
| 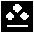 | Switch group |

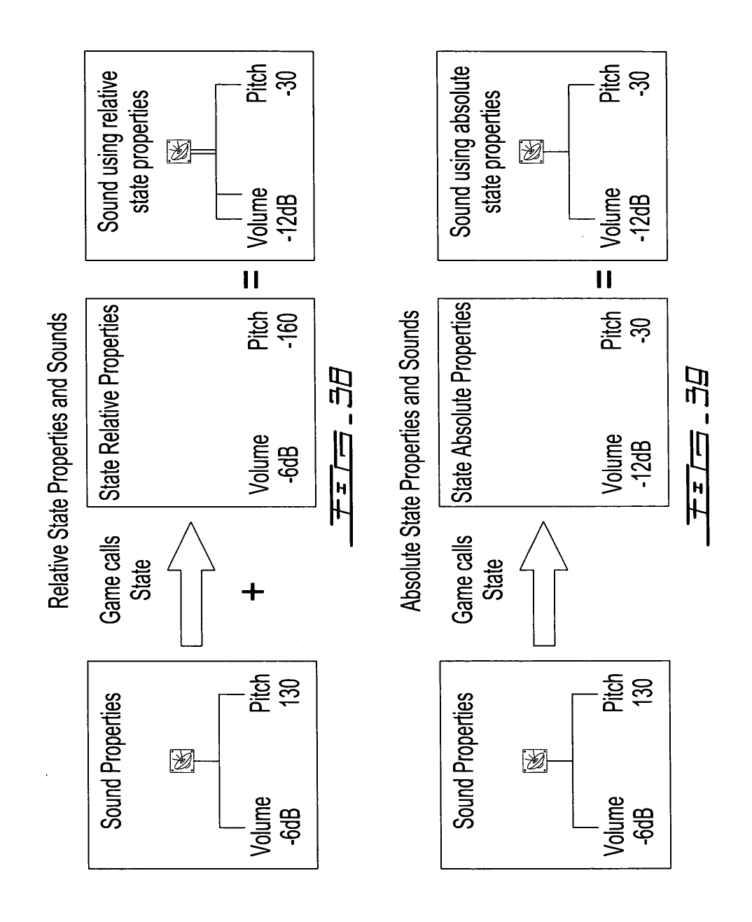

As illustrated in FIG. 37, the Project Explorer 74 further includes a Game Syncs tab 134 similar to the Audio tab 76 which allows creating and managing the switch groups, including renaming and deleting a group. As can be seen in the upper portion of FIG. 37, the Game Syncs tab 134 includes a Switches manager including, for each work unit created for the project, the list of switch groups displayed in an expandable tree view and for each switch group, the list of nested switches displayed in an expandable tree view.

The Project Explorer 74 is configured to allow creating, renaming and deleting switches within the selected groups. Conventional pop up menus and functionalities are provided for this purpose. To help discriminate works on the same project between teams, the Game Syncs tab 82 allows assigning switches to different work units so that each member of the team can work on different switches simultaneously

Objects can then be assigned to one or more selected switches via a switch container created for example in the Audio Tab 76 of the Project Explorer 74 so that they are played when the associated switches are selected in game. This can be achieved using the Property Editor 84 in the context of a switch container.

States

States are provided in the Authoring Tool to apply global property changes for objects in response to game conditions. Using a state allows altering the properties on a global scale so that all objects that subscribe to the state are affected in the same way. As will become more apparent upon reading the following description, using states allows creating different property kits for a sound without adding to memory or disk space usage. By altering the property of sounds already playing, states allow reusing assets and save valuable memory.

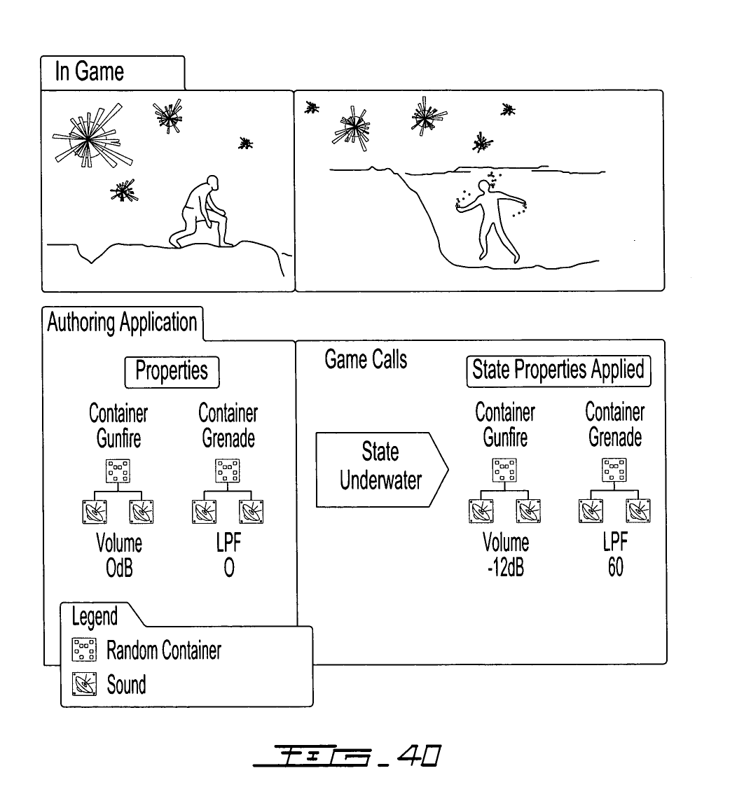

A state property can be defined as absolute or relative. As illustrated in FIGS. 38 and 39, and similarly to what has been described hereinabove, applying a state whose properties are defined as relative causes the effect on the object's properties to be cumulative.

Applying a state whose properties are defined as absolute causes the object's properties to be ignored and the state properties is used.

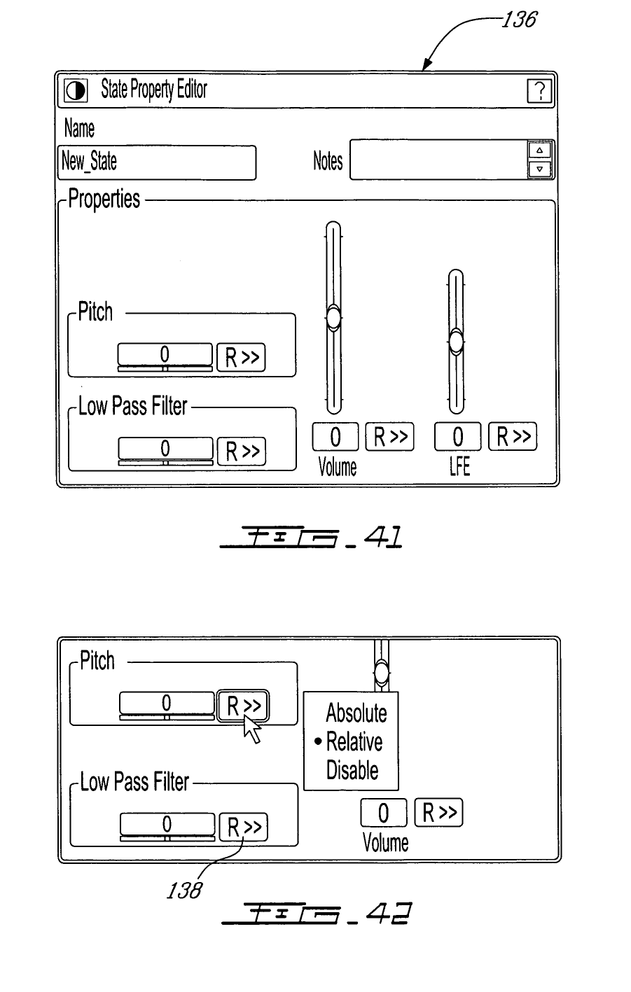

An example illustrating the use of states is shown in FIG. 40. This example concerns the simulation of the sound treatment that occurs when a character goes underwater in a video game. In this case, a state can be used to modify the volume and low pass filter for sounds that are already playing. These property changes create the sound shift needed to recreate how gunfire or exploding grenades would sound when the character is under water.

Similarly to switches, before being usable in a project, states are first grouped in state groups. For example, after a state group called Main Character has been created, states can be added that will be applied to the properties for the objects associated with the Main Character. From the game, it is for example known that the main character will probably experience the following states: stunned, calm, high stress. So it would be useful to group these together.

The icons illustrated in the following table are used both to facilitate the reference in the present description and also to help a user navigate in the Audio Tab 76 of the Project Explorer 74 and in other user interfaces of the Authoring Tool.

TABLE 5

| Icon | Represents |
|---|---|
| [symbol] | State |
| [symbol] | State group |

Since the GUI elements and tools provided with the Authoring Tool and more specifically with the Property Editor 84 for managing the states are very similar to those provided to manage the switches and which have been described hereinabove, only the differences between the two sets of GUI elements and tools will be described furtherin.

Since a state is called by the game to apply global property changes for objects in response to game conditions, the Project Explorer 74 is configured to allow editing property settings for states as well as information about how the states will shift from one to another in the game. To help discriminate works on the same project between teams, the Game Syncs tab 82 allows assigning states to different work units so that each member of the team can work on different states simultaneously.

The process of creating a new state therefore includes the following non-restrictive steps:
creating a state;
editing the properties of a state; and
defining transitions between states.

The Authoring Tool includes a State Property Editor including a State Property Editor GUI 136 to define the properties that will be applied when the state is triggered by the game. For each state, the following properties can be modified: pitch, low pass filter (LPF), volume, and low frequency effects and corresponding GUI elements are provided in the State Property Editor GUI 136. The State Property Editor 136 is illustrated in FIG. 41. The State Property Editor includes user interface elements similar to those provided in the Property Editor 84 for the corresponding properties.

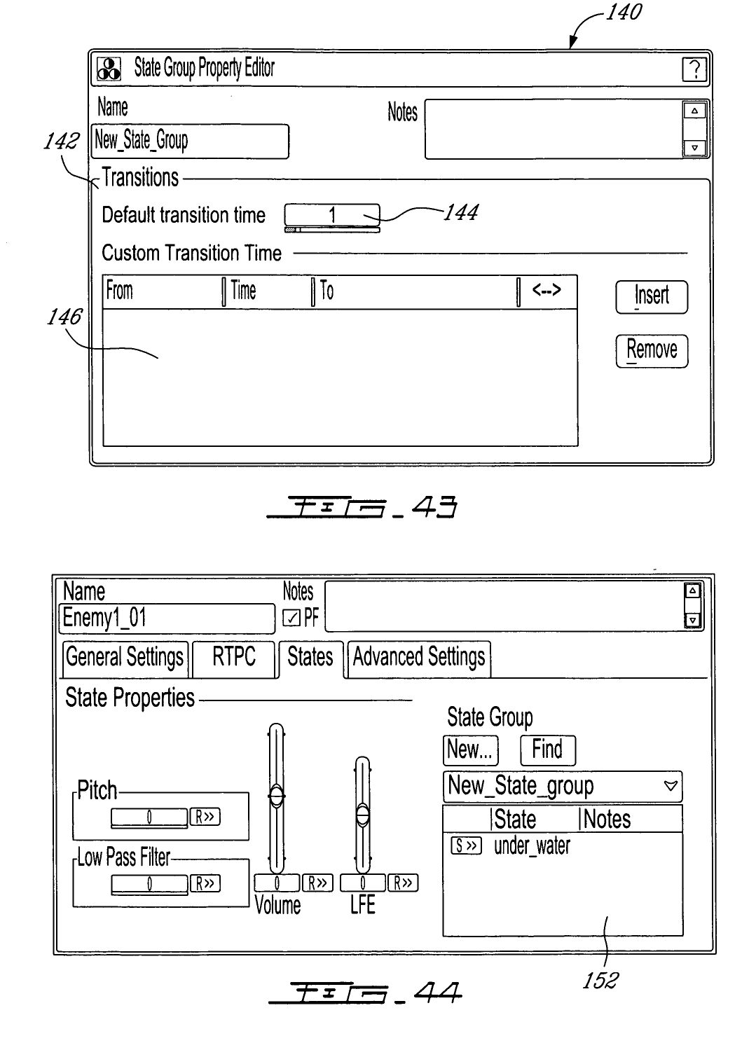

In addition, the State Property Editor 136 allows setting how the state properties will interact with the properties already set for the object. Indeed, as can be better seen in FIG. 42, each GUI element provided to input the value of a respective state property is accompanied by an adjacent interaction GUI element 138 allowing the user to set the interaction between the objects properties and the state properties. One of the following three options is available:
Absolute: to define an absolute property value that will override the existing object property value;
Relative: to define a relative property value that will be added to the existing properties for the object;
Disable: to use the existing property set for the object. This option enables the property controls.

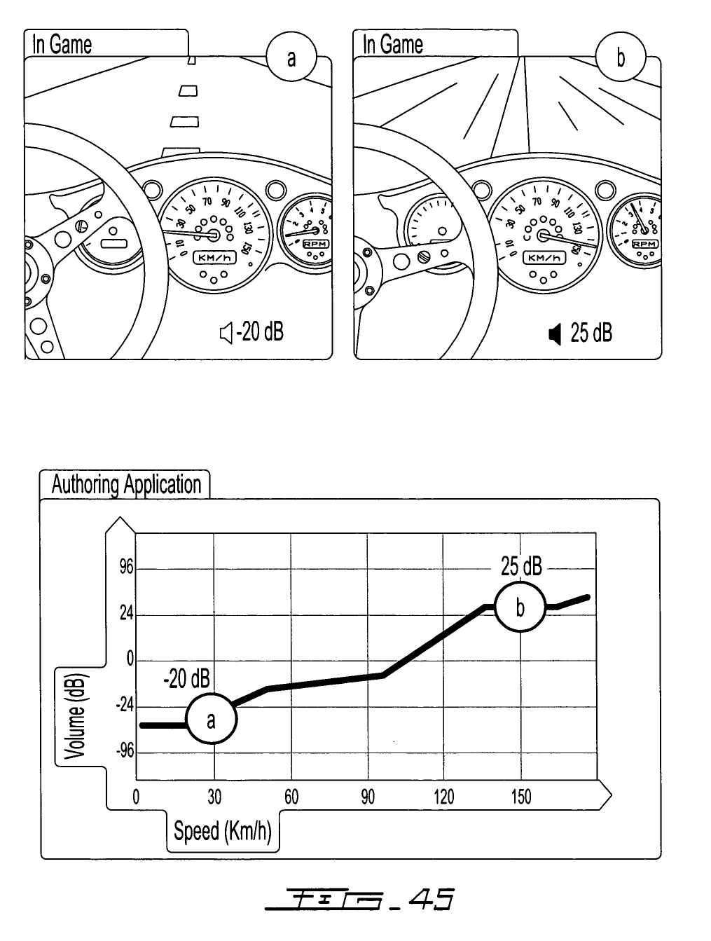

The Authoring Tool is further provided with a State Group Property Editor 140 to allow setting transitions between states. Indeed, a consequence of providing states in the game is that there will be changes from one state to another. Providing transitions between states allows to prevent these changes from being abrupt. To provide smooth transitions between states, the State Group Property Editor 140, which is illustrated in FIG. 43, provides a GUI allowing defining the transition time between the states. More specifically, a Transition Time tab 142 is provided to set such time.

In the Transition Time tab 142, a Default Transition Time 144 is provided to set the same transition time between states for all states in a state group.

A Custom Transition Time window 146 is provided to define different transition times between states in a state group.

After states have been created, they can be assigned to objects from the hierarchy. The first step is to choose a state group. The Authoring Tool is configured so that by default all states within that state group are automatically assigned to the object and so that the properties for each individual state can then be altered. States can also be assigned to control busses in the Master-Mixer hierarchy.

A portion of the States tab 150 (see FIG. 22) of the Property Editor 84 is illustrated in FIG. 44. This tab is provided with a list of state groups 152 from which a user may select a state group 152 to assign to the object currently loaded in the Property editor 84.

After a state group has been assigned to an object, the properties of its individual states can be customized as described hereinabove.

RTPCs

Real-time Parameter Controls (RTPCs) are provided to edit specific sound properties in real time based on real-time parameter value changes that occur within the game. RTPCs allow mapping the game parameters to property values, and automating property changes in view of enhancing the realism of the game audio.

For example, using the RTPCs for a racing game allows editing the pitch and the level of a car's engine sounds based on the speed and RPM values of an in-game car. As the car accelerates, the mapped property values for pitch and volume react based on how they have been mapped. The parameter values can be displayed, for example, in a graph view, where one axis represents the property values in the project and the other axis represents the in-game parameter values.

The Authoring Tool is configured so that the project RTPC values can be assigned either absolute values, wherein the values determined for the RTPC property will be used and ignore the object's properties, or relative values, wherein the values determined for the RTPC property will be added to the object's properties. This setting is predefined for each property.

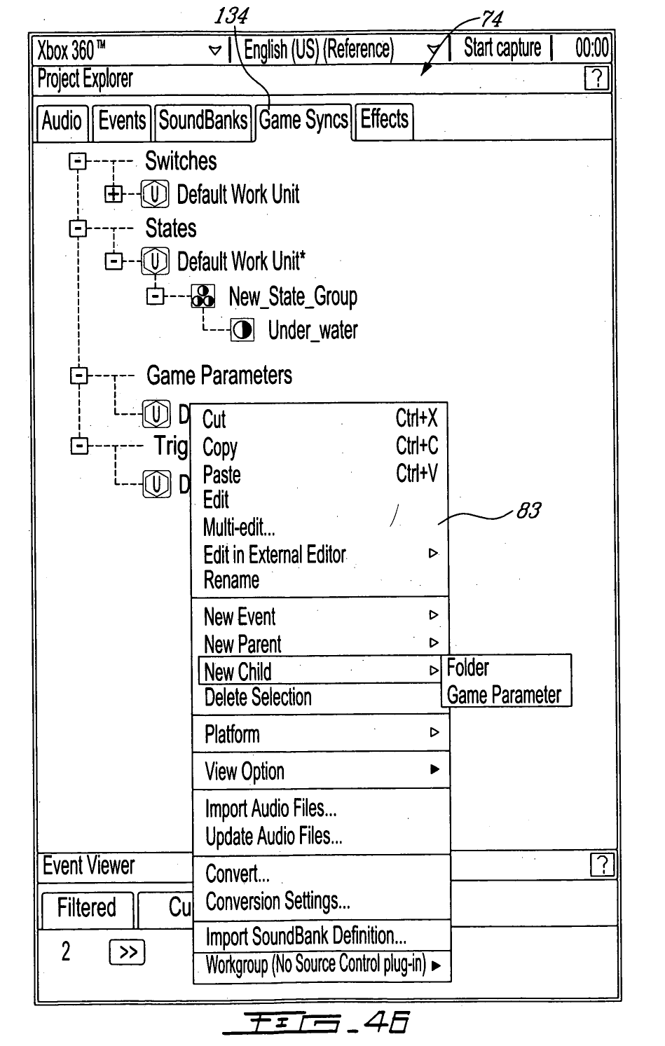

FIG. 45 illustrates how the volume can be affected by the speed of the racing car in a game, based on how it is mapped in the project.

A Property Editor is provided to map audio properties to already created game parameters. As can be seen from FIG. 22, the already discussed Game syncs tab of the Property Editor 84 includes a RTPC manager section (not shown) provided with a graph view for assigning these game parameters and their respective values to property values.

The RTPC manager allows to:
create a game parameter;
edit a game parameter;
delete a game parameter.

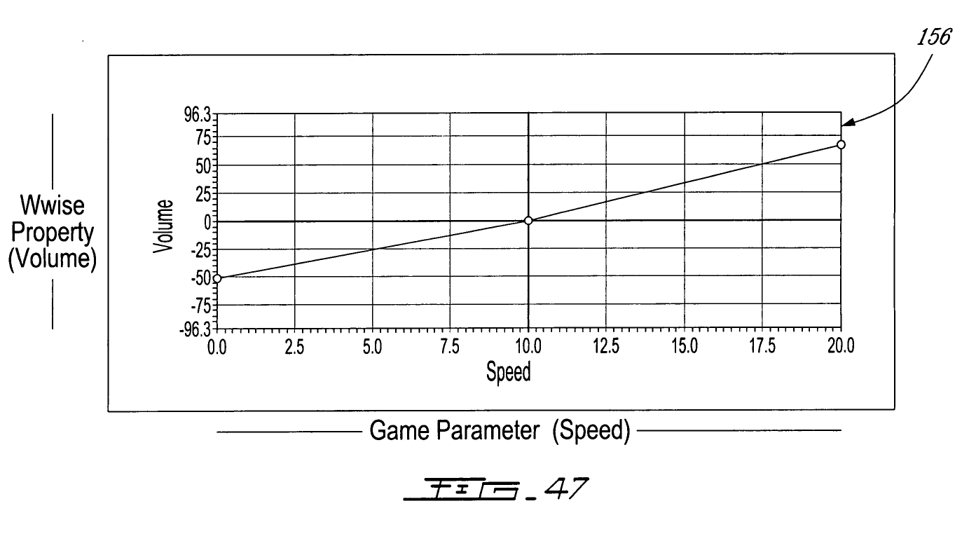

Creating a game parameter involves adding a new parameter (including naming the parameter) and defining the minimum and maximum values for that parameter. A new parameter can be created through the Game Syncs tab 134 of the Project Explorer 74 where the conventional shortcut menu 83 associated to the Game Parameters tree section includes an option for that purpose (see FIG. 46). Input boxes are provided for example in a Game Parameter Property Editor (not shown) to set the range values for the parameter.

A graph view 156 is provided in the RTPC tab 158 of the Property Editor 84 to edit real-time parameter value changes which will affect specified game sound properties in real time. One axis of the graph view represents the property values in the project and the other axis represents the in-game parameter values. An example of a graph view is illustrated in FIG. 47.

The RTPCs for each object or control bus are defined on the RTPC tab 158 of the Property Editor 84.

An example of use of RTPCs to base the volume of the character's footstep sounds on the speed of the character in game will now be provided with reference to a first shooter game. For example, when the character walks very slowly, it is desirable according to this example that the footstep sounds be very soft and that when the character is running, that the sounds be louder. In this case, RTPCs can be used to assign the game parameter (speed) to the project property (volume). Then the graph view 156 can be used to map the volume levels of the footstep sounds to the speed of the character as it changes in game. If the speed information is not available, the position of the console's joystick can be mapped to the volume level instead for example.

RTPCs can also be used to achieve other effects in a game, such as mapping low pass filter values to water depth, low frequency effect values to the force of an explosion, and so on.

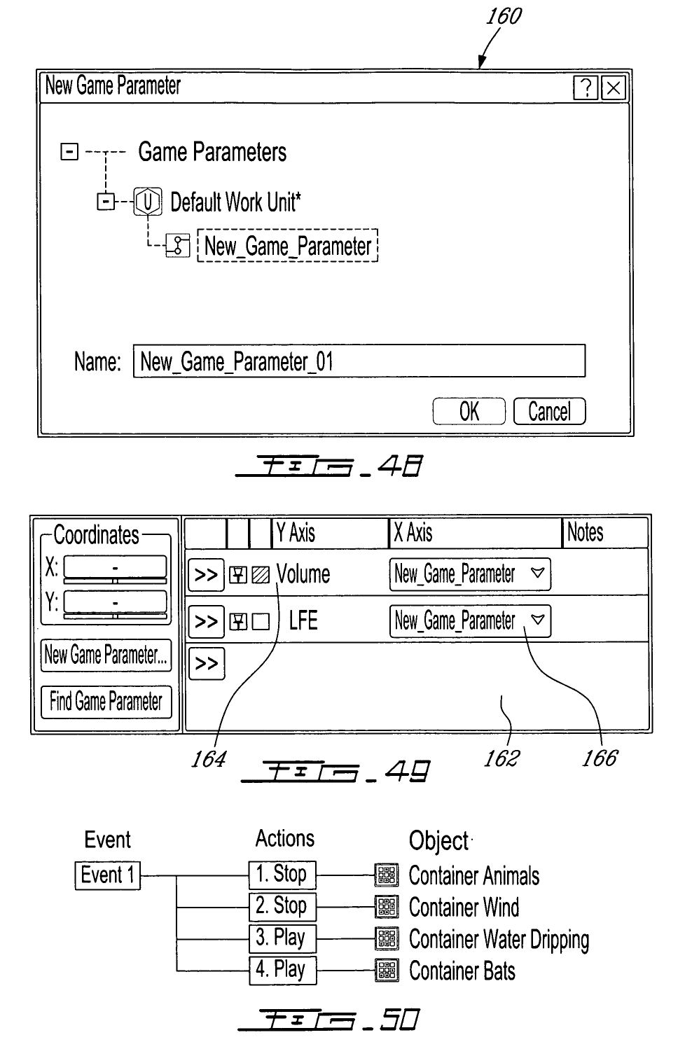

The RTPC tab 158 of the Property Editor 84 is configured to allow assigning object properties to game parameters. More specifically, for example, selecting “NEW” in the RTPC tab 158 causes a New Game Parameter dialog box 160 to open. An example of such a dialog box 160 is illustrated in FIG. 48. Also, to help discriminate works on the same project between teams, the Game Syncs tab 82 allows assigning RTPCs to different work units so that each member of the team can work on different RTPCs simultaneously

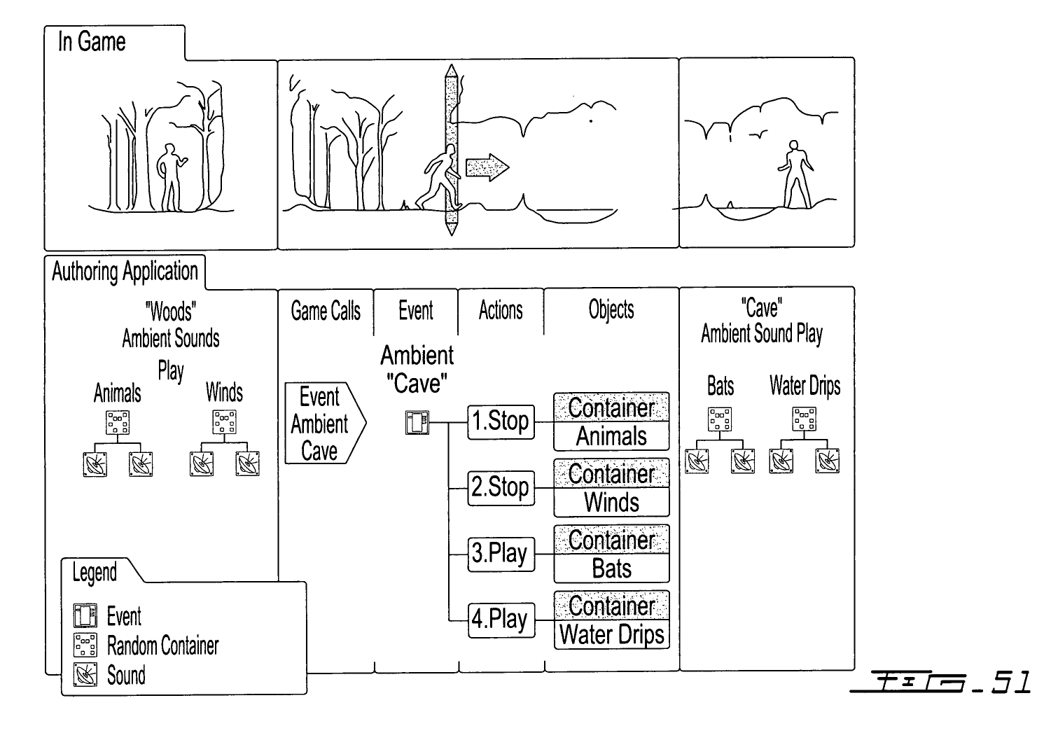

The selected property is added to the RTPC list 162 in the RTPC tab 158 from the Property Editor 84 (see FIG. 49) and is assigned to the Y axis in the graph view 156 (FIG. 47).

The RTPC tab further includes an X axis list 164 associated to the Y axis list 166 as illustrated in FIG. 49, from which the user can select the game parameter to assign to the property.

After the X and Y axes are defined by the game parameter and the property, the Graph view 156 can be used to define the relationship between the two values. More specifically, property values can be mapped to game parameter values using control points. For example, to set the volume of the sound at 50dB when the car is traveling at 100 km/h, a control point can be added at the intersection of 100 km/h and 50 dB.

Conventional editing tools are provided for zooming and panning the graph view 156, adding, moving, and deleting controls points thereon.

The RTPC list 162 in the RTPC tab 158 is editable so that RTPCs can be deleted.

The types of containers described herein are adapted to assign behaviors to sound objects. It is however believed to be within the reach of a person skilled in the art desiring to make use of a hierarchical structure similar to the one described herein to modify multiple versions of media files to provide containers providing behaviors adapted to the application.

Events

The Authoring Tool is configured to include Events to drive the sound in-game. Each event can have one or more actions or other events that are applied to the different sound structures within the project hierarchy to determine whether the objects will play, pause, stop, etc (see FIG. 50).

Events can be integrated into the game even before all the sound objects are available. For example, a simple event with just one action such as play can be integrated into a game. The event can then be modified and objects can be assigned and modified without any additional integration procedures required.

After the events are created, they can be integrated into the game engine so that they are called at the appropriate times in the game.

The icon illustrated in the following table is used both to facilitate the reference in the present description and also to help a user navigate in the Event Tab 76 of the Project Explorer 74.

TABLE 6

| Icon | Represents |
|---|---|
| [symbol] | Event |

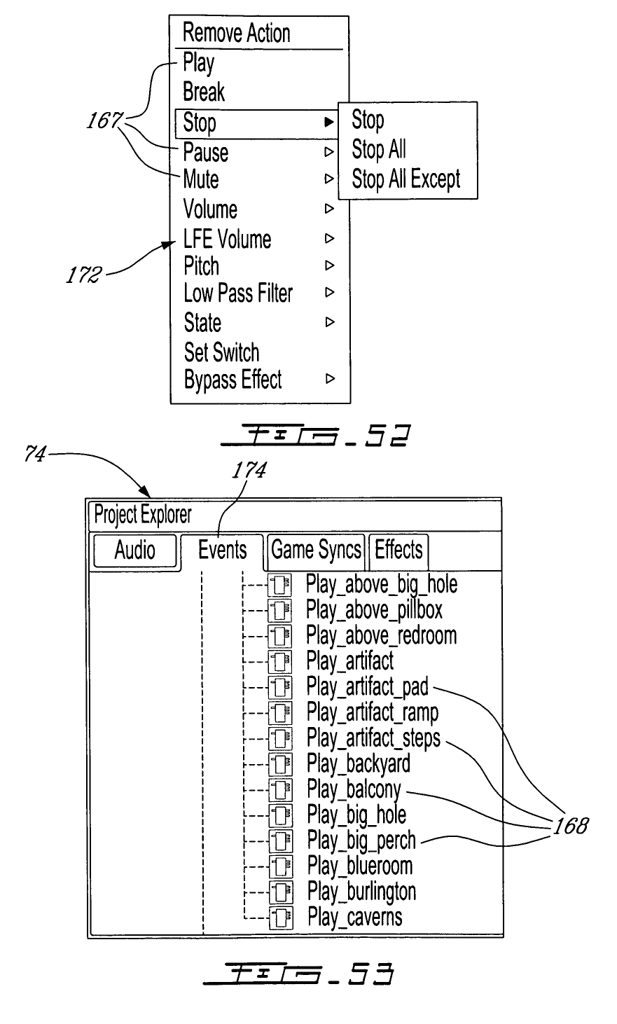

An example of use of events will now be provided with reference to FIG. 51 which concerns a first person role-playing game. According to this game, the character will enter a cave from the woods in one level of the game. Events are used to change the ambient sounds at the moment the character enters the cave. At the beginning of the project, an event is created using temporary or placeholder sounds. The event contains a series of actions that will stop the ambient “Woods” sounds and play the ambient “Cave” sounds. After the event is created, it is integrated into the game so that it will be triggered at the appropriate moment. Since no additional programming is required after the initial integration, different sounds can be experimented, actions can be added and removed, and action properties can be changed until it sounds as desired.

A variety of actions are provided to drive the sound in-game. The actions are grouped by category and each category contains a series of actions that can be selected.

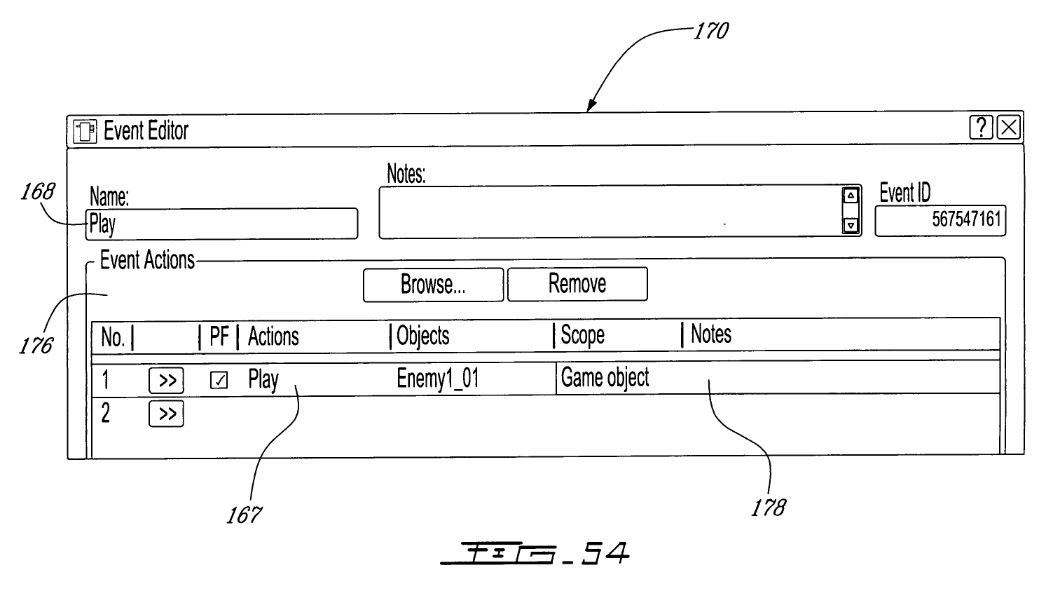

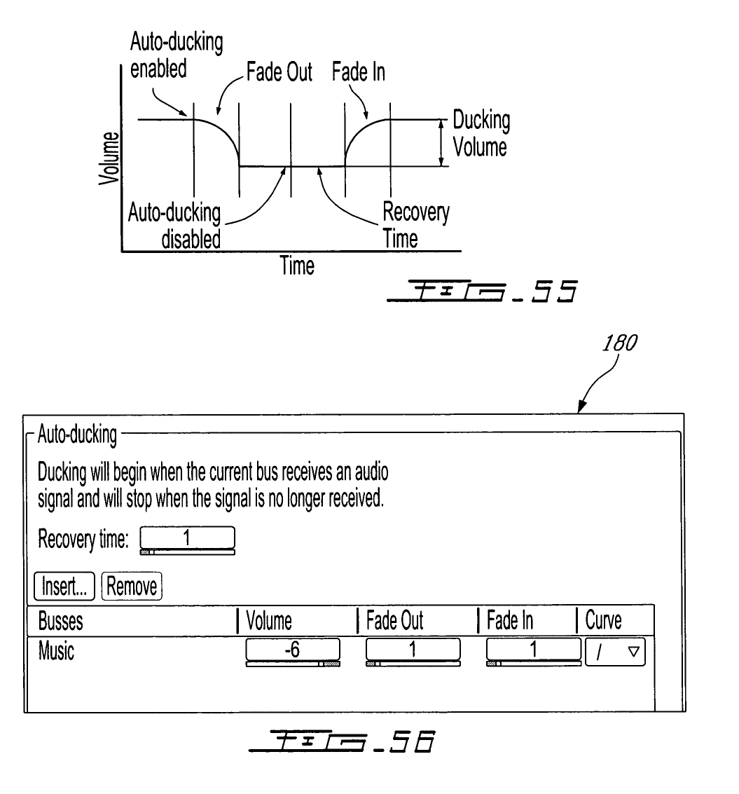

Each action also has a set of properties that can be used to fade in and fade out incoming and outgoing sounds. The following table describes examples of event actions 167 that can be assigned to an Event 168 in the Events Editor 170 (see FIG. 54), using for example the shortcut menu 172 shown in FIG. 52:

TABLE 7

| Event Action | Description |
|---|---|
| Play | Plays back the associated object. |
| Break | Breaks the loop of a sound or the continuity of a |
| | container set to continuous without stopping the |
| | sound that is currently playing. |
| Stop | Stops playback of the associated object. |
| Stop All | Stops playback of all objects. |
| Stop All Except | Stops playback of all objects except those |
| | specified. |
| Mute | Silences the associated object. |
| Unmute | Returns the associated object to its original |
| | “pre-silenced” volume level. |
| Unmute All | Returns all objects to their original “pre- |
| | silenced” volume levels. |
| Unmute All Except | Returns all objects, except those specified, to |
| | their original “pre-silenced” volume levels. |
| Pause | Pauses playback of the associated object. |
| Pause All | Pauses playback of all objects. |
| Pause All Except | Pauses playback of all objects except those |
| | specified. |
| Resume | Resumes playback of the associated object that |
| | had previously been paused. |
| Resume All | Resumes playback of all paused objects. |
| Resume All Except | Resumes playback of all paused objects, |
| | except those specified. |
| Set Volume | Changes the volume level of the associated |
| | object. |
| Reset Volume | Returns the volume of the associated object to |
| | its original level. |
| Reset Volume All | Returns the volume of all objects to their |
| | original levels. |
| Reset Volume | Returns the volume of all objects, except those |
| All Except | specified, to their original levels. |
| Set LFE Volume | Changes the LFE volume level of the |
| | associated object. |
| Reset LFE Volume | Returns the LFE volume of the associated |
| | object to its original level. |
| Reset LFE Volume | Returns the LFE volume of all objects to their |
| All | original levels. |
| Reset LFE Volume | Returns the LFE volume of all objects, except |
| All Except | those specified, to their original levels. |
| Set Pitch | Changes the pitch for the associated object. |
| Reset Pitch | Returns the pitch of the associated object to its |
| | original value. |
| Reset Pitch All | Returns the pitch of all objects to their original |
| | values. |
| Reset Pitch All Except | Returns the pitch of all objects, except those |
| | specified, to their original values. |
| Set LPF | Changes the amount of low pass filter applied |
| | to the associated object. |
| Reset LPF | Returns the amount of low pass filter applied to |
| | the associated object to its original value. |
| Reset LPF All | Returns the amount of low pass filter applied to |
| | all objects to their original values. |
| Reset LPF All Except | Returns the amount of low pass filter applied to |
| | all objects, except the ones that are specified, |
| | to their original values. |
| Set State | Activates a specific state. |
| Enable State | Re-enables a state for the associated object. |
| Disable State | Disables the state for the associated object. |
| Set Switch | Activates a specific switch. |
| Enable Bypass | Bypasses the effect applied to the associated |
| | object. |
| Disable Bypass | Removes the effect bypass which re-applies the |
| | effect to the associated object. |
| Reset Bypass Effect | Returns the bypass effect option of the |
| | associated object to its original setting. |
| Reset Bypass Effect | Returns the bypass effect option of all objects to |
| All | their original settings. |
| Reset Bypass Effect | Returns the bypass effect option of all objects, |
| All Except | except the ones that you specified, to their |
| | original settings. |

The event creation process involves the following steps:
creating a new event 168;
adding actions to the created event 168;
assigning objects to event actions 167;
defining the scope of an event action 167; and
setting properties for the event action 167.

To provide additional control and flexibility, the Authoring Tool is configured so that events 168 can perform one action or a series of actions 167.

The Project Explorer 74 is provided with an Events tab 174 including GUI elements for the creation and management of events. An example of Event tab 174 is illustrated in FIG. 53.

The Event tab 174 displays all the events 168 created in the project. Each event 168 is displayed for example alphabetically under its parent folder or work unit. The Event tab 174 is provided to manage events 168, including without restrictions: adding events, organizing events into folders and work units, and cut and pasting events.

To help discriminate works on the same project between teams, the Event tab 174 allows assigning events to different work units so that each member of the team can work on different events simultaneously.

Turning now briefly to FIG. 54, an Event Editor GUI 170 is provided with the Event tab 174 as a further means to create events 168. As can be better seen from FIG. 54, the Event Editor 170 further includes an Event Actions portion 176 in the form of a field listing events created, and for each event created including a display menu button (>>) to access an the event action list, including a submenu for some of the actions listed. The Event Editor 170 is advantageously configured so that when an event is loaded therein, the objects associated with the event 168 are simultaneously displayed in the Contents Editor 106 so that properties for these objects can be edited.

As can be seen in FIG. 19, the Audio tab 76 of the Project Explorer 74 is also configured to create events. The Audio tab 76 is more specifically configured so that a GUI menu similar to the one illustrated in FIG. 46 is accessible from each object in the object hierarchy allowing to create an event in the Event Editor 170 and associate the selected object to the event 168.

The Event Editor 170 is further provided to define the scope for each action 167. The scope specifies the extent to which the action 167 is applied to objects within the game. More specifically, the Event Editor 170 includes a Scope list 178 to select whether to apply the event action 167 to the game object that triggered the event or to apply the event action to all game objects.

Moreover, each event action 167 is characterized by a set of related properties that can be used to further refine the sound in-game, which fall into, for example, one of the following possible categories:
delays;
transitions; and
volume, pitch, or state settings.

The Event Editor 170 is further configured to allow a user to rename an event 168, remove actions 167 from an event 168, substitute objects assigned to event actions 167 with other objects and find an event's object in the Audio tab 76 of the Project Explorer 74 that is included in an event 168. For these purposes, the Event Editor 170 includes conventional GUI means, including for example, pop up menus, drag and drop functionalities, etc.

Master-mixing

As mentioned hereinabove, the hierarchical structure provided to organize the sound objects further includes a Master-Mixer hierarchical structure 81 provided on top of the Actor-Mixer hierarchy 79 to help organize the output for the project. More specifically, the Master-Mixer hierarchy 81 is provided to group output busses together, wherein relative properties, states, RTPCs, and effects as defined hereinabove are routed for a given project.

The Master-Mixer hierarchy 81 consists of two levels with different functionalities:
Master Control Bus: the top level element in the hierarchy that determines the final output of the audio. As will be described hereinbelow in more detail, while other busses can be moved, renamed, and deleted, the Master Control Bus is not intended to be renamed or removed. Also, according to the first illustrative embodiment, effects can be applied onto the Master Control Bus;
Control Busses: one or more busses that can be grouped under the master control bus. As will be described hereinbelow in more detail, these busses can be renamed, moved, and deleted, and effects can be applied thereon.

The Authoring Tool is configured so that, by default, the sounds from the Actor-Mixer hierarchy 79 are routed through the Master Control Bus. However, as will now be described, as the output structure is built, objects can systematically be routed through the busses that are created. Moreover, a GUI element is provided in the Authoring Tool, and more specifically in the Audio tab 76 of the Project Explorer 74, for example in the form of a Default Setting dialog box (not shown) to modify this default setting.

With reference to FIG. 19, the Master-Mixer hierarchy 81 can be created and edited using the same GUI tools and functionalities provided in the Audio tab 76 of the Project Explorer 74 to edit the Actor-Mixer hierarchy 79.

Similarly to objects in the Actor-Mixer hierarchy 79, each control bus can be assigned properties that can be used to make global changes to the audio in the game. The properties of a control bus can be used to do for example one of the following:
add effects;
specify values for volume, LFE, pitch, and low pass filter; and
duck audio signals.

Since the control busses are the last level of control, any changes made will affect the entire group of objects below them.

As in the case for objects, RTPCs can be used, states can be assigned and advanced properties can be set for control busses.

The control busses are linked to objects from the Actor-Mixer hierarchy 79 in a parent-child relationship therewith so that when effects are applied to a control bus, all incoming audio data is pre-mixed before the effect is applied.

A “Bypass effect” control GUI element (not shown) is provided for example in the Property Editor window 84 which becomes available when a control bus is selected, to bypass an effect.

The Property Editor 84 shares the same GUI effect console section for selecting and editing an effect to assign to the current control bus which can be used to assign effect to an object within the Actor-Mixer hierarchy 79 (see FIG. 22). This effect is applied to all sounds being mixed through the bus. Examples of such effects include reverb, parametric equalizing, expander, compressor, peak limiter, and delay. Effect plug-ins can also be created and integrated using the GUI effect console element. The GUI effect console section or element is identical to the one which can be seen in FIG. 22.

Similarly to what has been described with reference to objects within the Actor-Mixer hierarchy 79, relative properties can be defined for each control bus within the Master-Mixer hierarchy 81 using the same GUI that has been described with reference to the Actor-Mixer hierarchy 79. Also, the same properties which can be modified for objects within the Actor-Mixer hierarchy 79 can be modified for control busses, namely, for example: volume, LFE (low frequency effects), pitch, and low pass filter.

The Master-Mixer hierarchy 81 and more specifically, the control busses can be used to duck a group of audio signals as will now be described. Ducking provides for the automatic lowering of the volume level of all sounds passing through one first bus in order for another simultaneous bus to have more prominence.

For example, when at different points in a game, some sounds are to be more prominent than others or the music is to be lowered when characters are speaking in game, audio signals' importance in relation to others can be determined using ducking.

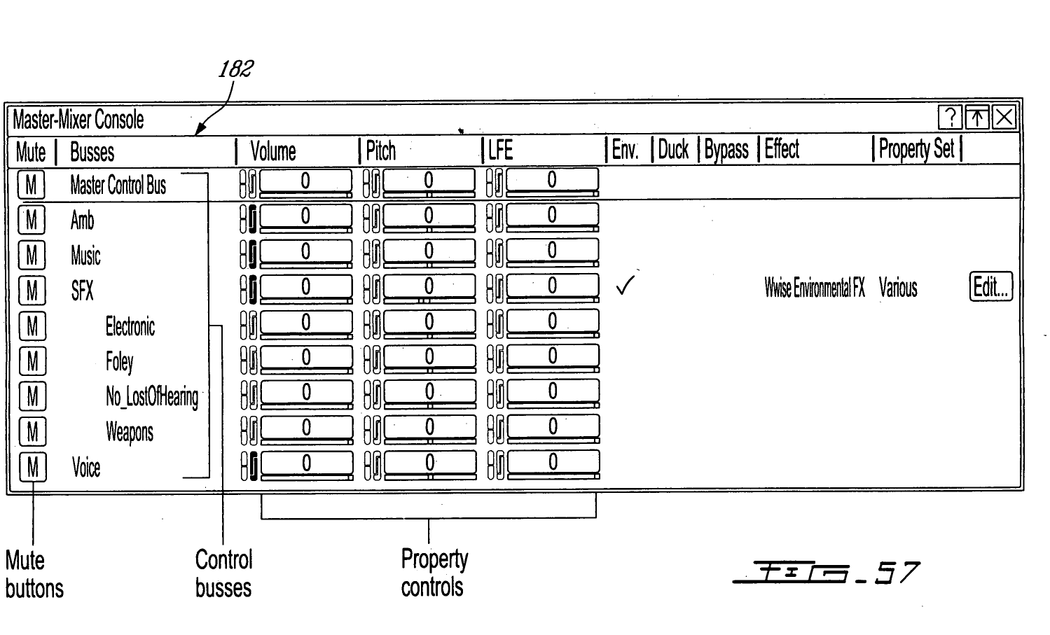

As illustrated in FIG. 55, the following properties and behaviors can be modified to control how the signals are ducked:
ducking volume;
fade out;
fade in;
curve interpolation; and
recovery time.

The Property Editor 84 contextually includes an Auto-ducking control panel 180 to edit each of these parameters (see FIG. 56).

Creating the Final Mix

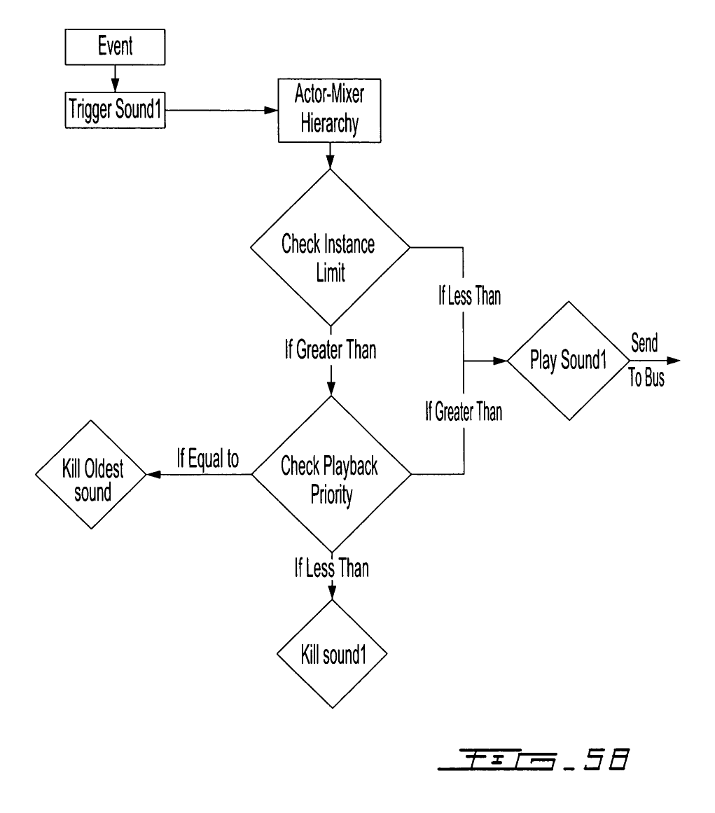

The Authoring Tool includes a Master-Mixer Console GUI 182 (see FIG. 57) to allow the user to fine-tune and troubleshoot the audio mix in the game after the bus structure has been set up. The Master-Mixer Console 182 is provided to audition and modify the audio as it is being played back in game.

Generally stated the Master-Mixer Console GUI 182 includes GUI element allowing modifying during playback all of the Master-Mixer properties and behaviors as described hereinabove in more detail. For example, the following control bus information can be viewed and edited for the objects that are auditioned:
Env.: indicates when an environmental effect has been applied to a control bus;
Duck; indicates when a control bus is ducked;
Bypass: indicates that a particular effect has been bypassed in the control bus;
Effect: indicate that a particular effect has been applied to the control bus;
Property Set: indicates which property set is currently in use for the effect applied to the control bus.

The Authoring Tool is configured for connection to the game for which the audio is being authored.

Once connected, the Master-Mixer console 182 provides quick access to the controls available for the control busses in the Master-Mixer hierarchy.

Since the Master-Mixer and Actor-Mixer share common characteristics and properties, they are both displayed in the Project Explorer 74. Also, to ease their management and the navigation of the user within the Authoring Tool, both Actor-Mixer elements, i.e. objects and containers, and Master-Mixer elements, i.e. control busses, are editable and manageable via the same GUIs, including the Property Editor 84, the Contents Editors 106, etc.

Alternatively, separate GUI can be provided to edit and manage the Master-Mixer and Actor-Mixer hierarchies.

Also both the Master-Mixer and Actor-Mixer hierarchies 79 and 81 can be created and managed via the Project Explorer 74.

Each object or element in the Project Explorer 74 is displayed alphabetically under its parent. Other sequence of displaying the objects within the hierarchies can also be provided.

The Project Explorer 74 includes conventional navigation tools to selectively visualize and access different levels and objects in the Project Explorer 74.

The Project Explorer GUI 74 is configured to allow access to the editing commands included on the particular platform on which the computer 12 operates, including the standard Windows Explorer commands, such as renaming, cutting, copying, and pasting using the shortcut menu.

Playback Limit and Priority

Since many sounds may be playing at the same time at any moment in a game, the Authoring Tool includes a first sub-routine to determine which sound per game object to play within the Actor-Mixer hierarchy 79 and a second sub-routine to determine which sound will be outputted through a given bus. These two sub-routines aim at preventing that more sounds be triggered than the hardware can handle.

As will be described hereinbelow in more detail, the Authoring Tool further allows the user to manage the number of sounds that are played and which sounds take priority: in other words, to provide inputs for the two sub-routines.

More specifically, in the Authoring Tool, there are two main properties that can be set to determine which sounds will be played in game:
playback limit: which specifies a limit to the number of sound instances that can be played at any one time;
playback priority: which specifies the importance of one sound object relative to another.

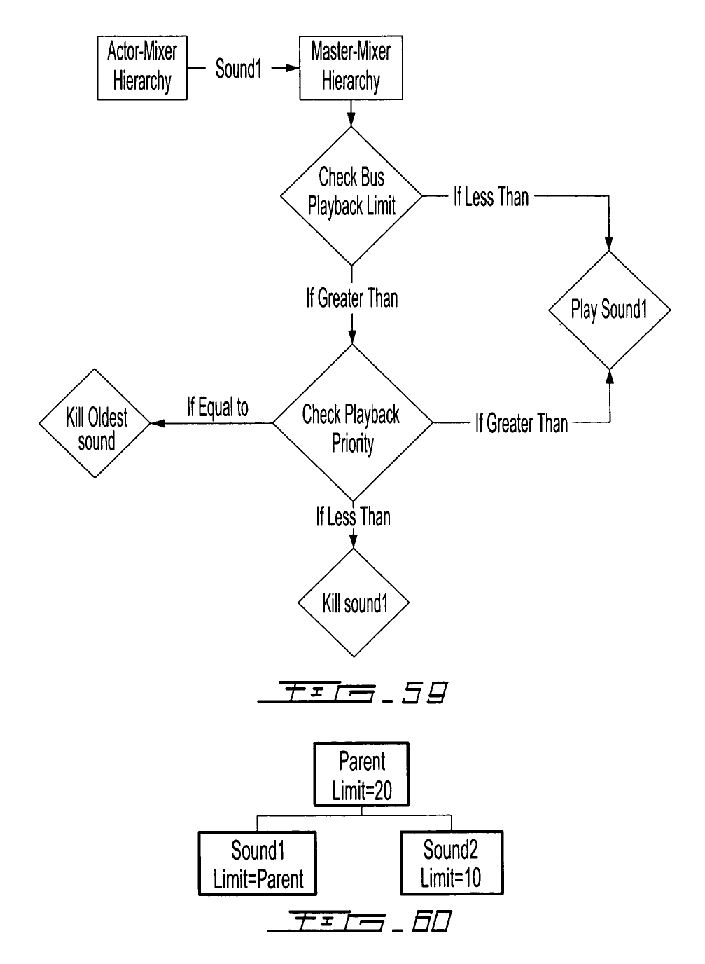

These advanced playback settings are defined at two different levels: at the object level in the Actor-Mixer hierarchy 79 (see FIG. 58), and at the bus level in the Master-Mixer hierarchy 81 (see FIG. 59). Because these settings are defined at two different levels, it results that a sound passes through two separate processes before it is played.

As illustrated in FIG. 58, the first process occurs at the Actor-Mixer level. When the advanced settings for objects are defined within the Actor-Mixer hierarchy 79, a limit per game object is set. If the limit for a game object is reached, the priority then determines which sounds will be passed to the bus level in the Master-Mixer hierarchy 81.

FIG. 58 shows how the Authoring Tool determines which sounds within the actor-mixer structure are played per game object.

If the new sound is not killed at the actor-mixer level, it passes to the second process at the Master-Mixer level. At this level, a global playback limit is used to restrict the total number of voices that can pass through the bus at any one time. FIG. 59 shows how the Authoring Tool determines which sounds are outputted through a bus.

Playback Limit

The simultaneous playback of sounds can be managed using two different methods:
by limiting the number of sound instances that can be played per game object;
by limiting the overall number of sound instances that can pass through a bus.

When either limit is reached, the system 10 uses the priority setting of a sound to determine which one to stop and which one to play. If sounds have equal priority, it is determined that the sound instance having been played the longest is killed so that the new sound instance can play. In case of sounds having equal priority, other rules can also be set to determine which sound to stop playing.

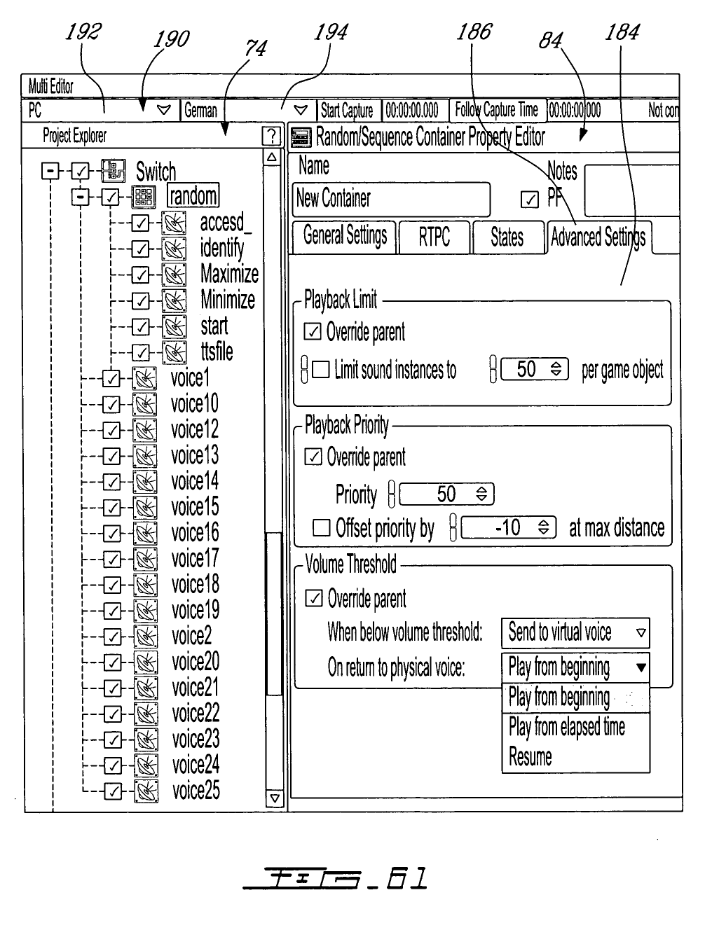

The Authoring Tool is configured for setting a playback limit at the Actor-Mixer level so as to allow controlling the number of sound instances within the same actor-mixer structure that can be played per game object. If a child object overrides the playback limit set at the parent level in the hierarchy, the total number of instances that can play is equal to the sum of all limits defined within the actor-mixer structure. This is illustrated in FIG. 60. For example, considering a parent with a limit of 20 and a child with a limit of 10, the total possible number of instances is 30.

The Authoring Tool is further configured for setting the playback limit at the Master-Mixer level, wherein the number of sound instances that can pass through the bus at any one time can be specified. Since the priority of each sound has already been specified at the Actor-Mixer level, there is no playback priority setting for busses.

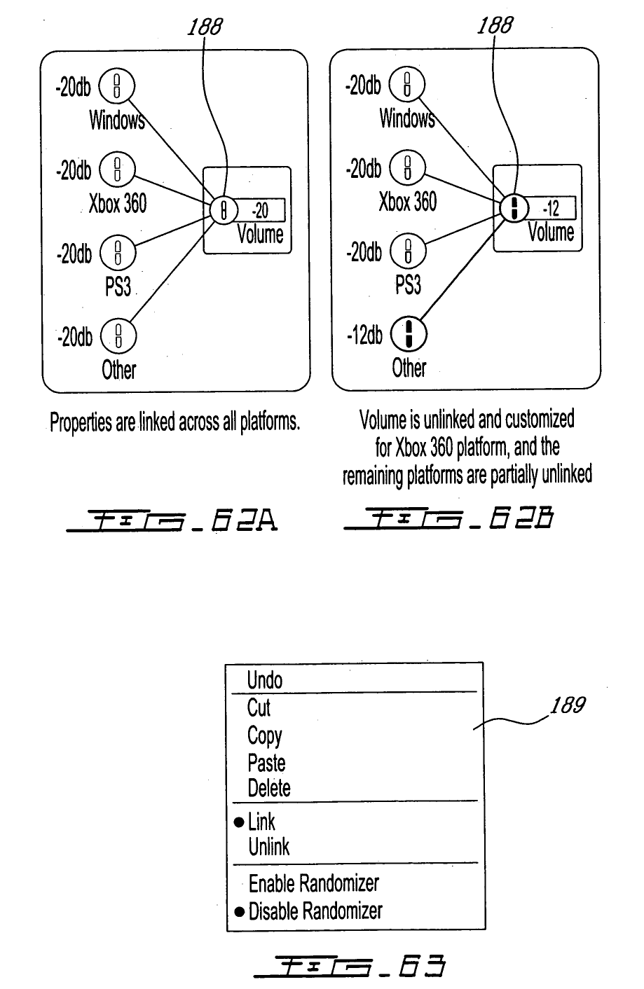

With reference to FIG. 61, the Property Editor 84 includes a “Playback Limit” group box 184 for inputting the limit of sound instances per game object for the current object in the Property Editor 84. This limit can be customized for each platform. Even though the Playback Limit group box 184 is implemented in an Advance Setting tab 186 of the Property Editor 84, it can be made accessible differently. Also, the GUI provided to input the limit of sound instances per game object can take other forms.

Playback Priority

When the limit of sounds that can be played is reached at any one time, either at the game object or bus level, the priority or relative importance of each sound is used to determine which ones will be played.

A standard numerical scale, ranging for example between 1-100, where 1 is the lowest priority and 100 is the highest priority, is provided to define the priority for each sound. Other scales can alternatively be used. The Authoring tool deals with priority on a first in first out (FIFO) approach; when a new sound has the same playback priority as the lowest priority sound already playing, the new sound will replace the existing playing sound.

Using Volume Thresholds

A third performance management mechanism is provided with the Authoring Tool in the form of defining behaviors for sounds that are below a user-defined volume threshold. Sound below this volume may be stopped or may be queued in the virtual voice list, or can continue to play even though they are inaudible. Virtual voices, is a virtual environment where sounds below a certain volume level are monitored by the sound engine, but no audio processing is performed. Sounds defined as virtual voices move from the physical voice to the virtual voice and vice versa based on their volume level.

The implementation of virtual voices is based on the following premises: to maintain an optimal level of performance when many sounds are playing simultaneously, sounds below a certain volume level should not take up valuable processing power and memory. Instead of playing these inaudible sounds, the sound engine queue them in a virtual voice list. The Authoring Tool continues to manage and monitor these sounds, but once inside the virtual voice list, the audio is no longer processed by the sound engine.

When the virtual voices feature is selected, selected sounds move back and forth between the physical and the virtual voice based on their volume levels. As the volume reaches a predetermined threshold for example, they can be added to the virtual voice list and audio processing stops. As volume levels increase, the sounds move from the virtual voice to the physical voice where the audio will be processed by the sound engine again. It is believed to be within the reach of a person skilled in the art to determine such a threshold.

As can be seen in FIG. 61, the group box 184 allows defining the playback behavior of sounds selected from the hierarchy tree 78 of the Project Explorer 74 as they move from the virtual voice back to the physical voice.

The behavior can be defined following one of these options:
Play from beginning: to play the sound from its beginning. This option does not reset the sound object's loop count for example.
Play from elapsed time: to continue playing the sound as if it had never stopped playing. This option is not sample accurate, which means that sounds returning to the physical voice may be out of sync with other sounds playing.
Resume: to pause the sound when it moves from the physical voice to the virtual voice list and then resume playback when it moves back to the physical voice.

In the above, characteristics and features of the Authoring Tool have been described which help to associate modifying values characterizing selected properties and behaviors to selected sound objects (step 312) and to modify the selected sources associated with selected sound objects and corresponding to the selected version identifier accordingly with the associated modifying values characterizing the selected properties and behaviors (step 314). These characteristics and features of the Authoring Tool have been described by way of reference to a first illustrative embodiment which has not been given to limit the scope of the present system and method for multi-version digital authoring in any way. Even though the Authoring Tool according to the first illustrative embodiment has been found particularly efficient for authoring audio for a video game, it is to be understood that the Authoring tool can be modified so as to allow steps 312 and 314, for example, to be performed differently.

The Authoring Tool is configured with well-known operators associated to the corresponding properties and behaviours for modifying the source files accordingly with the associated modifying values. For example, the transformation which has to be applied on an audio file to modify the pitch of the resulting sound is believed to be well-known in the art. Since these operators are believed to be well-known in the art, and for concision purposes, they will not be described herein in more detail.

Specific aspects of the method 300 and of the Authoring Tool which relate to multi-version authoring will now be described.

Customizing Object Properties per Platform

The Authoring Tool according to the first illustrative embodiment is configured so that when sound properties are defined for a particular platform in the project, these properties are set across all predetermined platforms by default. These properties are said to be linked across platforms. This streamlines creating projects across platforms.

As will now be described in further detail, the Authoring Tool allows customizing the properties and behaviors for a specific platform by unlinking selected properties and/or behaviors, and defining new values. For example, the following modifiers can be linked and unlinked:
Effects, including Bypass Effects and Render Effects;
Volume;
Pitch;
Low Pass Filters;
LFE;
Streaming;
Playback Instance Limits;
Playback priority;
Etc.

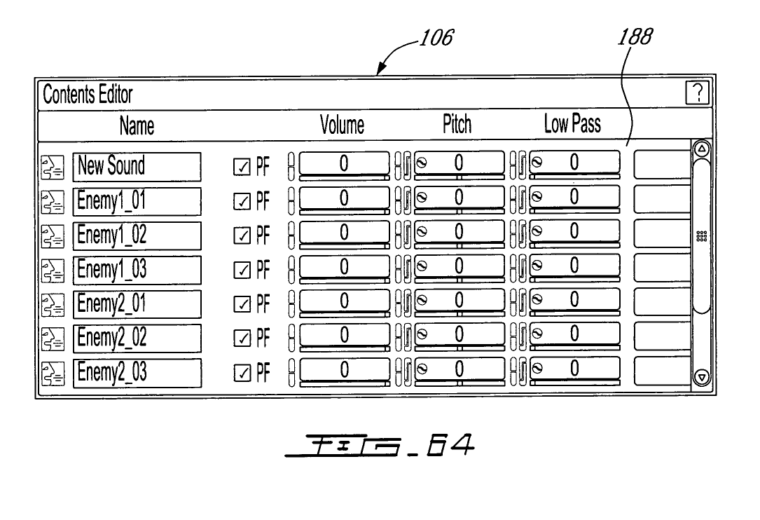

As illustrated for example in FIG. 22 and more specifically in FIGS. 62A and 62B, some of the modifiers include a link indicator 188 to be used to link and unlink the associated modifier for the current platform and also to display the current linking status as defined in the following table:

TABLE 7

| Indicator | Name | Description |
|---|---|---|
| [symbol] | Link | A modifier value that is linked to the |
| | | corresponding values of other game |
| | | platforms. |
| [symbol] (yellow) | Unlink | A unique modifier value that is not |
| | | linked to the corresponding values of |
| | | other game platforms. |
| [symbol] (half yellow) | Partial Unlink | The modifier value for the current |
| | | platform is linked, but one or more |
| | | corresponding values of other |
| | | platforms is unlinked. |

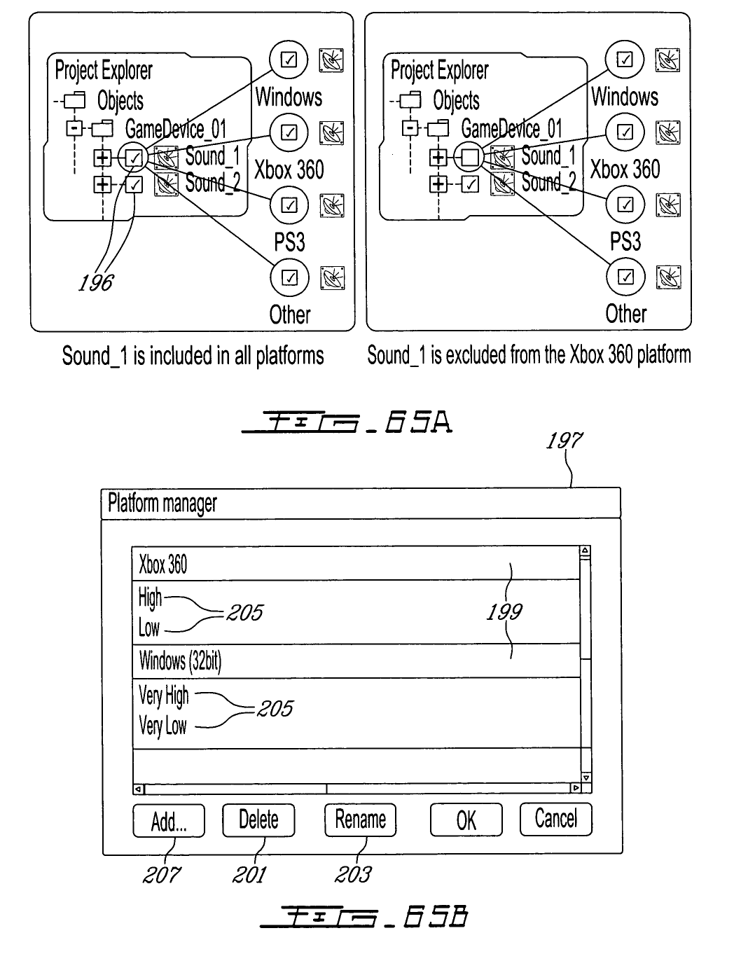

A shortcut menu 189, such as the one illustrated in FIG. 63, is associated to each link indicator 188 to allow the user modifying the linking status. The link indicator 188 together with the shortcut menu 189, define a link editor.

According to a more specific embodiment, information related to the other platforms is displayed to the user, via for example a conventional tooltip or another GUI element, for him to consider while setting a new property value or in deciding to link or unlink the property for the current platform.

According to a further specific embodiment, the linked and unlinked property values can be changed from absolute to relative and vice-versa. For that purpose, an additional user interface element, or an indicator associated to a corresponding menu, is provided to alternate the modifying value between relative to absolute.

As can be seen for example in FIG. 61, the Authoring Tool includes a status bar 190 including a Platform Selector List 192 for selecting and indicating the current platform. As it has been mentioned hereinabove, the modifying values assigned to an object are linked across all platforms unless a selected modifier is unlinked for the current platform selected in the menu 192. As will be described hereinbelow in more detail, a similar Language Selector List 194 is also provided.

Selecting Audio Sources per Platform

The Authoring Tool is configured so that, by default, a sound object uses the same source linked to the same audio file when it is played across platforms. However, different sources with different properties linked to the same or different audio files can be specified for each platform by unlinking the sources in the Contents Editor 106. This is illustrated in FIG. 64.

For example, characters in a fighting game might have been given different names depending on the game platform the game will be played on. The hero of the game is originally named Max, but the character is renamed Arthur on the PlayStation3 game platform. Certain voice sound objects therefore contain two different audio sources, each including a nearly identical line of dialogue mentioning a different name. The sound object can be unlinked in the PlayStation3 version so that the sound object in that version would use Arthur's lines instead of Max's.

Excluding Objects, Languages, and Event Actions from a Platform

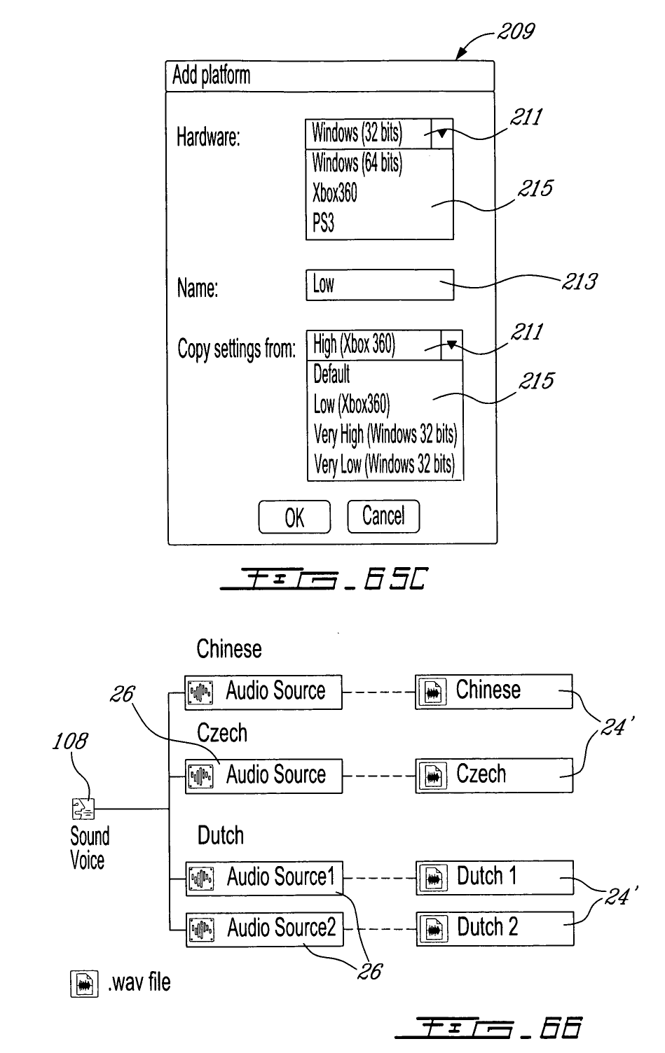

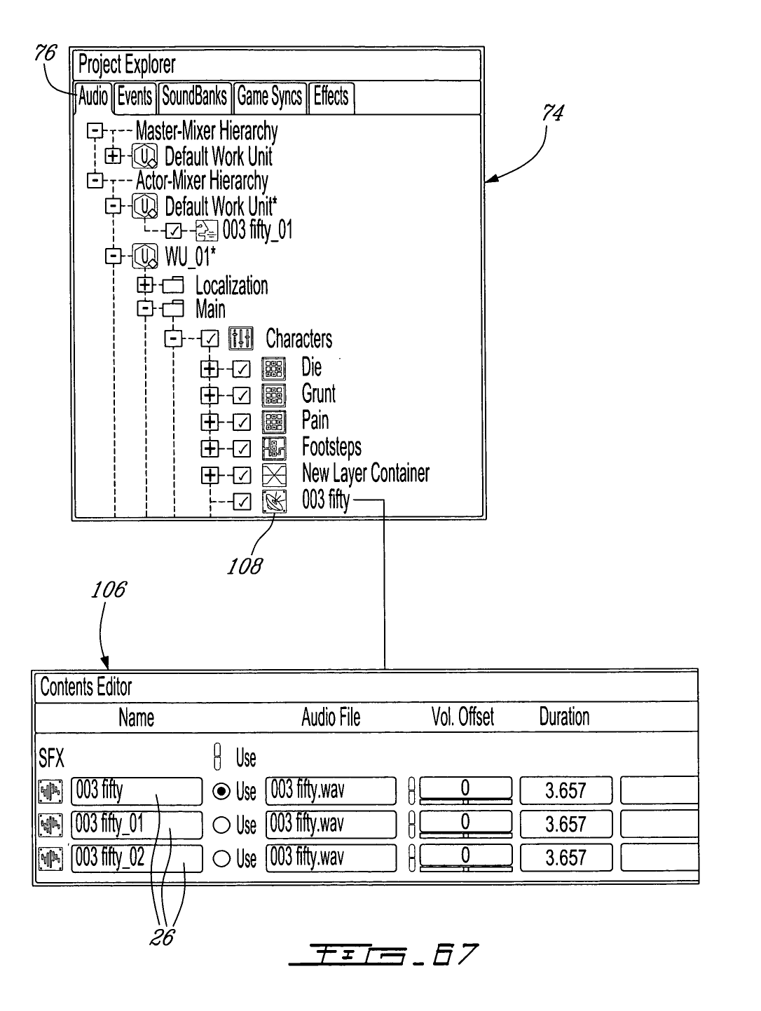

As can be seen in FIG. 65A with reference to the Project Explorer GUI 74, some of the user interface provided with the Authoring Tool includes Project excluder elements in the form of check boxes 196 adjacent and associated to objects and allowing to include or exclude the corresponding object from the current platform 192. Similar selection check boxes are also provided in the Property Editor, Contents Editor and Event Editor. Of course, other user interface elements can be provided to include and exclude sound objects from a platform.

The possibility to selectively exclude sound from a project allows optimizing each platform for the available resources, customizing content for each version, optimizing content based on the limitations and strengths of certain platforms, optimizing performance based on the limitations and strengths of platforms, sharing of certain properties across versions, and creating content that will be delivered in different formats.

Sound objects excluded from a project are also excluded from the SoundBanks that are generated for that platform as will be described hereinbelow in more detail.

According to still another embodiment, the Platform Selector List 192 is configured so that a plurality of platforms selected from the Platform Selector List 192 can be grouped so as to define a new Meta platform. Changes applied to this Meta platform will be made automatically to all platforms included in the group. These changes include changes made to properties, linking and unlinking and excluding of property from the group.

Switching Between Platforms

The Authoring Tool allows switching from one platform to another at any point in the development cycle by accessing the Platform Selector List 192 and selecting the desired platform. The platform versions of the sound objects in the hierarchy are then displayed.

Managing Platforms

Even though the Authoring Tool can be provided with a pre-selected list of platform (and languages), it includes a platform manager, which can be seen in FIG. 65B, including a Platform Manager user interface 197, which allows creating, adding and deleting platforms and versions of platforms as will now be described.

The platform manager 197 includes a list of platforms 199, which can be deleted using a conventional function button 201, or renamed using a similar button 203, and, for each platform 199, a list of associated versions 205, acting as sub-version identifiers, which can be used to further characterize the platforms 199.

Using the <<Add>> button 207 provides access to an Add Platform user interface 209, which is illustrated in FIG. 65C. The Add Platform user interface 209 includes a first drop down menu 211 to select or create a new platform 199, an input box 213 to create a new version for the selected platform and a second drop down menu 215 to select a version, among all the versions 205 already created, on which to base the new version. The objects not excluded and properties associated to these objects that include the linked settings which correspond to the selected based version are copied to the new created version.

All the versions 205 which are in the platform manager 197 when it is closed are selectable from the Platform Selector List 192.

Localizing a Project

As it has been previously mentioned, the present system and method for multi-version digital authoring allow managing simultaneous version classes.

According to the first illustrative embodiment, a plurality of language versions of the platform versions, resulting in a combination of versions, can be authored. Further characteristics of the method 300 and system 10 will now be presented with reference to this localizing aspect.

As will now be described in more detail, the Authoring Tool allows recreating the same audio experience for many selected languages than what is developed in an original language and therefore results in more than one translated versions of the Sound Voice objects.

The Authoring Tool is configured so that the localization, i.e. the process of creating multiple versions of a sound object, can be performed at any time during the authoring process, including after the game is complete.

Managing the localization of a project involves the following steps:
creating the languages for the project;
defining the reference language;
import language files;
auditioning the language versions.

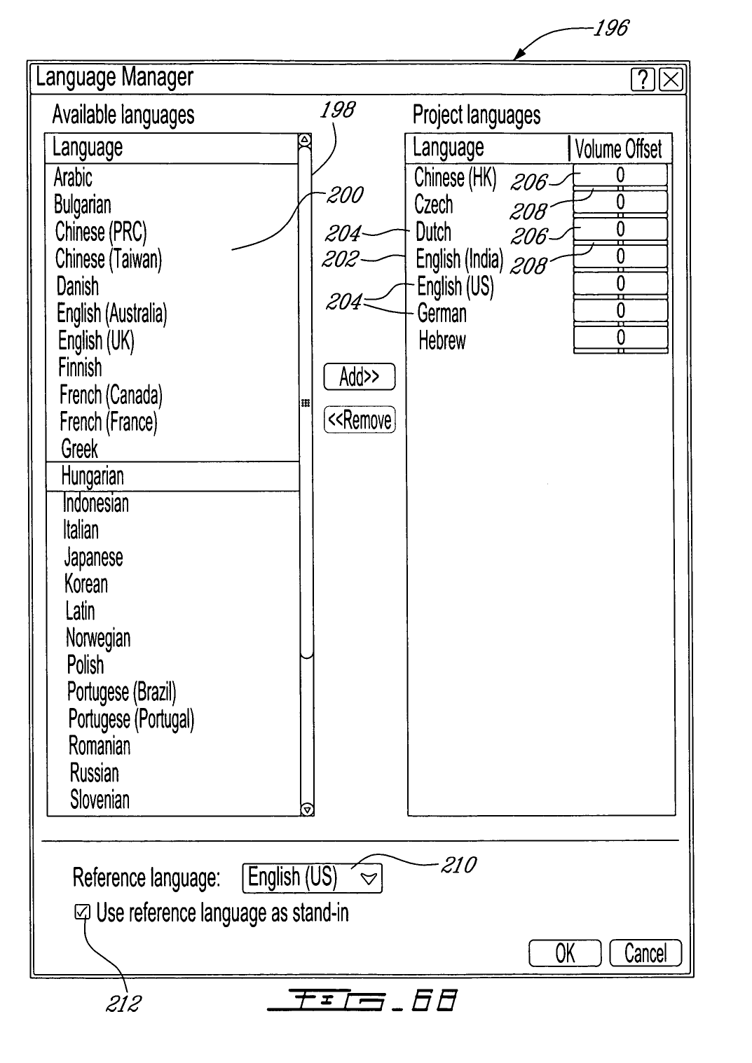

The language versions are stored as sources of the Sound Voice object and are associated with different audio files for each source. FIG. 66 demonstrates the relationships between the sound object 108, its language sources 26, and the language files 24′.

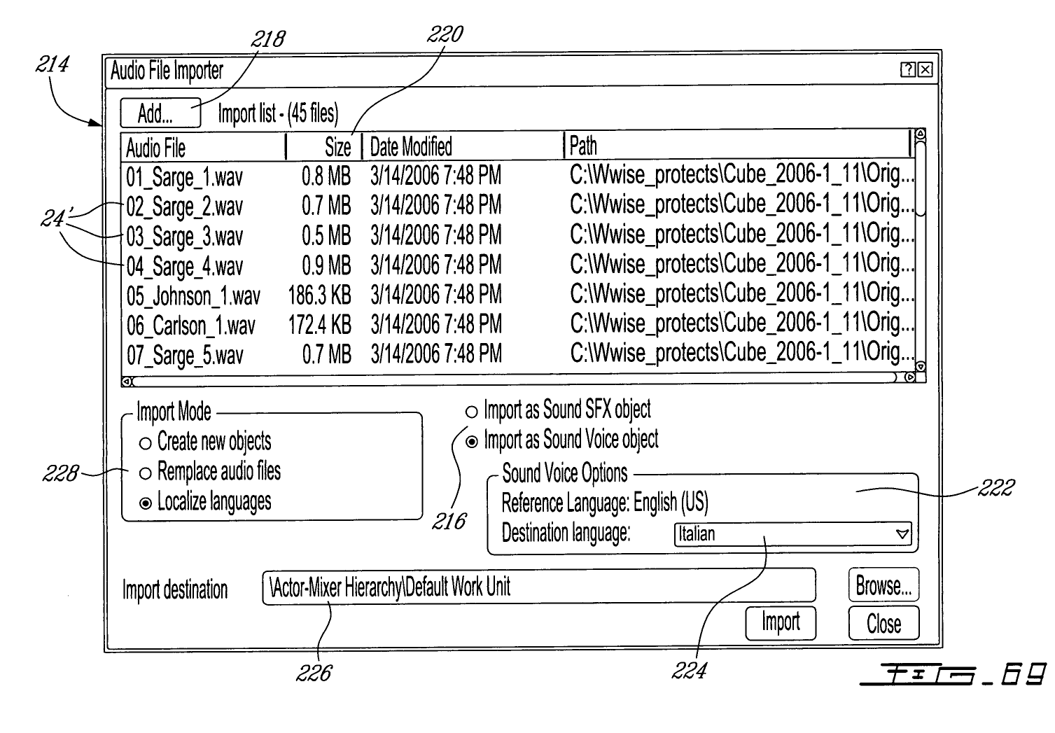

As illustrated in FIG. 67, the Sound Voice object 108 contains the sources 26 for each language. They are displayed in the Contents Editor 106.

Managing the Languages for a Project

With reference now to FIG. 68, the Authoring Tool includes a Language Manager 196 to create and manage the language in a project (part of step 306 from the method 300 in FIG. 2).

After the localizing languages have been determined, they are displayed in the Language Selector 194 on the toolbar 190 (see FIG. 61) and in the Contents Editor 106 for Voice objects. Since not all the languages files are known and therefore available when the list is created, the Language Manager 196 is configured so that a reference language can be selected as a substitute for languages that are not yet ready, and for conversion settings for the imported language files.

Creating and Removing Languages for a Project

As can be seen in FIG. 68, the Language Manager GUI 196 includes an “Available Languages” window menu 198 including a list of predetermined languages 200 for selection using conventional GUI selection tools.

The Language Manager 196 further includes a “Project Languages” window menu 202 to display a list of selected languages 204, each having an associated “Volume Offset” input box 206 including a sliding bar for inputting a volume offset value 208. The selected languages 204 will appear in the Language Selector 194.

Conventional “Add” and “Remove” buttons allows the user moving languages from one window 198 and 202 to the other. Drag and drop functionalities can also be provided.

The “Volume Offset” input boxes 206 allow defining the volume offsets for the corresponding language files. Indeed, in some cases, the localized assets consist of dialogue from different studios with different actors and recording conditions. Modifying their relative volume, allows balancing them and matching the levels for each language. The Content Editor 106 is also configured so that a volume offset can be added for language sources, the resulting offset being cumulative.

Defining a Reference Language

The Language Manager 196 further includes a reference language selector in the form of drop down menu 210 including the list of languages selected in the Project Languages window 202.

The reference language can be used in various situations:
importing language files: when an audio file is imported, the import conversion settings of the reference file are used;
converting language files: when a language file is converted, the conversion settings of the reference language are used; and
before language files are available: when certain language files are not ready, the reference language can be used in their place.

A check box 212 is further provided to command the Authoring Tool to use the reference language during playback when language files are not yet available.

Importing Language Files

As illustrated in FIG. 69, the Authoring Tool further includes an Audio File Importer including an Audio File Importer GUI 214 to Import the audio files when the language files are ready.

As can be seen in FIG. 69, the GUI 214 includes an Object type selector 216 allowing to target the selected files as sound effect objects (“Sound SFX object”) or as sound voice objects (“Sound Voice object”) requiring a destination language to be selected as will be described furtherin. The Audio File Importer can obviously be used for importing both sound effect and sound voice target files.

When these files are imported, language sources 26 are created in the selected Sound Voice objects in the Audio tab 76 of the Project Explorer 74 and the files will be stored in the Originals folder 30. The localized files can be imported at any level of the hierarchy 78, including at the topmost level to localize the entire project at one time.

It has been found advantageous to remove the DC offset prior to importing audio files into the Authoring Tool using a conventional DC offset filter because DC offsets can affect volume and cause artifacts. The DC Offset is removed as part of the above-described platform conversion process.

The Audio File Importer GUI 214 includes a window 220 for displaying the list of audio files 24′ dragged therein or retrieved using a conventional folder explorer accessible via an “Add” button 218.

The Audio File Importer GUI 214 further includes a Sound Voice Options portion 222 displaying the reference language and for inputting the destination language via a drop down menu 224 including the list of selected languages 204.

The import destination 226 is further displayed on the Audio File Importer GUI 214.

The Audio File Importer GUI 214 finally includes interface selection items 228 to allow the user defining the context from which the files are imported. Indeed, an audio file can be imported at different times and for different reasons, according to one of the following three situations:
to bring audio files into a project at the beginning of the project, or as the files become available;
to replace audio files previously imported, for example, to replace placeholders or temporary files used at the beginning of the project; or
to localize languages, including adding further language versions as described hereinabove.

The Audio File Importer component is configured for automatically creating objects 28 and their corresponding audio sources 26 when an audio file 24 is imported into a project. The audio source 26 remains linked to the audio file 24 imported into the project so that they can be referenced to at any time (see FIGS. 5 and 9 for example).

SoundBanks

Referring briefly to FIG. 2, after selected sound objects have been modified for selected versions using selected modifiers (step 314), the method 300 proceeds with the generation of sound banks in step 116, which are project files including events and objects from the hierarchy with links to the corresponding audio files. Sound banks will be referred to herein as “SoundBanks”.

Each SoundBank is loaded into a game's platform memory at a particular point in the game. As will become more apparent upon reading the following description, by including minimal information, SoundBanks allow optimizing the amount of memory that is being used by a platform. In a nutshell, the SoundBanks include the final audio package that becomes part of the game.

In addition to SoundBanks, an initialization bank is further created. This special bank contains all the general information of a project, including information on the bus hierarchy, on states, switches, and RTPCs. The Initialization bank is automatically created with the SoundBanks.

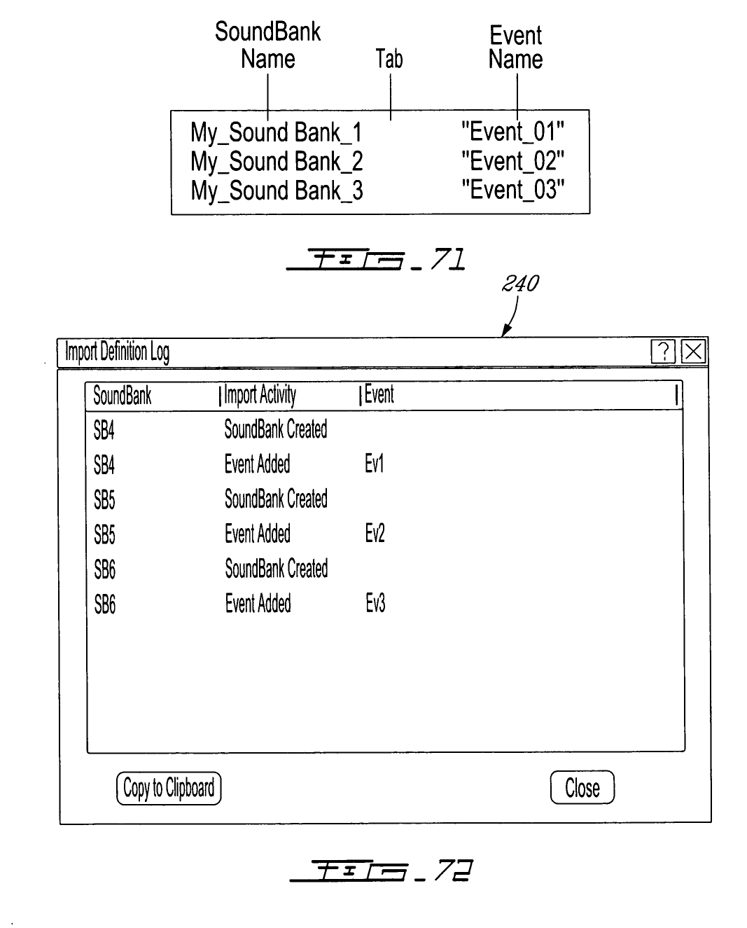

The Authoring Tool includes a SoundBank Manager component including a SoundBank Manger GUI 230 to create and manage SoundBanks. The SoundBank Manager GUI 230 is divided into three different panes as illustrated in FIG. 70:
SoundBanks pane: to display a list of all the SoundBanks in the current project with general information about their size, contents, and when they were last updated;
SoundBank Details: to display detailed information about the size of the different elements within the selected SoundBank as well as any files that may be missing.
Events: displays a list of all the events included in the selected SoundBank, including any invalid events.

Building SoundBanks

The Authoring Tool is configured to manage one to a plurality of SoundBanks. Indeed, since one of the advantages of providing the results of the present authoring method in Soundbanks is to optimize the amount of memory that is being used by a platform, in most projects it is advisable to present the result of the Authoring process via multiple SoundBanks tailored for each platform. SoundBanks can also be generated for all platforms simultaneously.

When determining how many SoundBanks to create, the list of all the events integrated in the game can be considered. This information can then be used to define the size limit and number of SoundBanks that can be used in the game in order to optimize the system resources. For example, the events can be organized into the various SoundBanks based for example on the characters, objects, zones, or levels in game.

The Authoring Tools includes GUI elements to perform the following tasks involved in building a SoundBank:
creating a SoundBank;
populating a SoundBank;
managing the content of a SoundBank; and
managing SoundBanks.

The creation of a SoundBank includes creating the actual file and allocating the maximum of in-game memory thereto. As can be seen from FIG. 70, the SoundBank manager includes input text boxes 232 for that purpose. A “Pad” check box option 234 in the SoundBanks pane is provided to allow setting the maximum amount of memory allowed regardless of the current size of the SoundBank.

A new SoundBank 236 is created and displayed in the SoundBank pane by inserting a new SoundBank in the SoundBank tab 82 of the Project Explore 74 (see FIG. 19).

Similarly to other tabs from the Project Explorer 74, the SoundBank tab 82 displays the SoundBanks alphabetically under its parent folder or work unit. The SoundBank tab GUI 82 further allows organizing SoundBanks into folders and work units, cutting and pasting SoundBanks, etc. Since the SoundBank tab GUI share common functionalities with other tabs from the Project Explorer, it will not be described herein in further detail.

Populating a SoundBank includes associating thereto the series of events 238 to be loaded in the game's platform memory at a particular point in the game.

The SoundBank manager is configured to allow populating SoundBanks either by importing a definition file or manually.

A definition file is for example in the form of a text file that lists all the events in the game, classified by SoundBank. A first example of a definition file is illustrated in FIG. 71.

The text file defining the definition file is not limited to include text string as illustrated in FIG. 71. The Authoring Tool is configured to read definition files, and more specifically events, presented in the globally unique identifiers (GUID), hexadecimal or decimal system.

The SoundBanks include all the information necessary to allow the video game to play the sound created and modified using the Authoring Tool, including Events and associated objects from the hierarchy or links thereto as modified by the Authoring Tool.

According to a further embodiment, where the Authoring Tool is dedicated to another application for example, the SoundBanks may include other information, including selected audio sources or objects from the hierarchical structure.

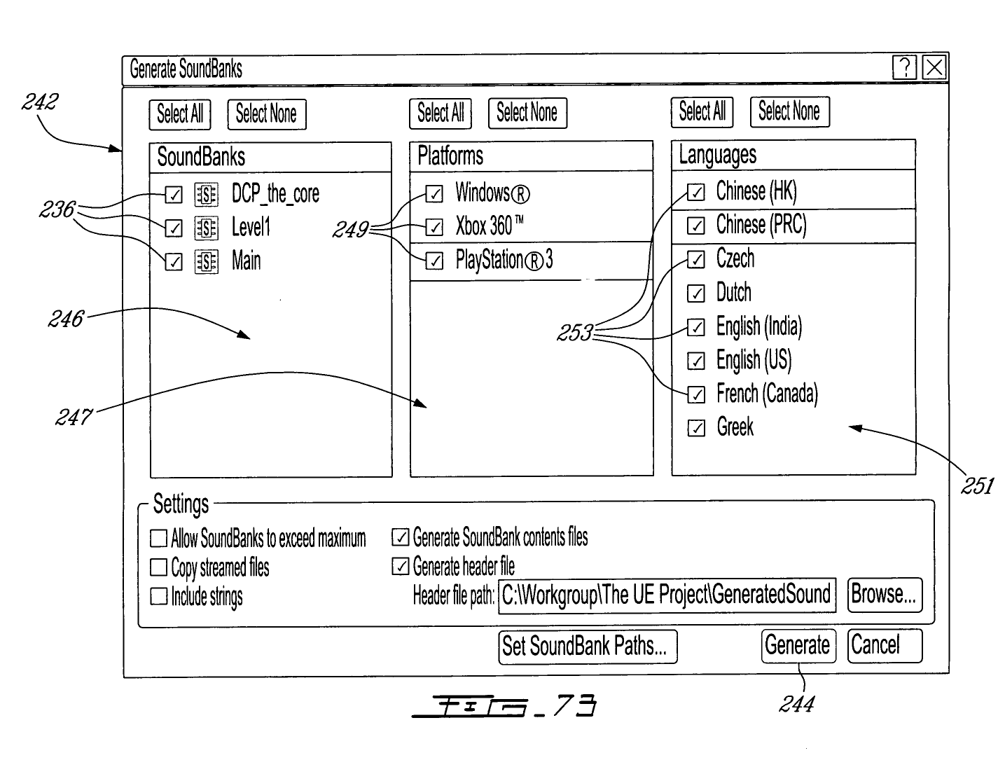

After SoundBanks have been populated automatically using a definition file, the SoundBank manager 230 is configured to open an Import Definition log dialog box 240. An example of such a dialog box 240 is illustrated in FIG. 72. The Definition Log 240 is provided to allow the user reviewing the import activity.

The Definition Log 240 can include also other information related to the import process.

Returning to FIG. 70, the SoundBank Manager 230 further includes an Events pane to manually populate SoundBanks. This pane allows assigning events 238 to a SoundBank selected in the SoundBank pane.

The SoundBank manager 230 includes conventional GUI functionalities to edit the SoundBanks 236 created, including filtering and sorting the SoundBank event list 238, deleting events 238 from a SoundBank, editing events within a SoundBank, and renaming SoundBanks.

The SoundBank manager further includes a Details pane which displays information related to memory, space remaining, sizes of SoundBanks, including:
Languages: a list of the project languages;
SFX: memory used for sound objects;
Voice: the memory used for voice objects;
Missing files: the number of audio files missing from a language version;
Data Size: the amount of memory occupied by the Sound SFX and Sound Voice objects;
Free Space: the amount of space remaining in the SoundBank;
Files Replaced: the number of missing Sound Voice audio files that are currently replaced by the audio files of the Reference Language;
Memory Size: the amount of space occupied by the SoundBank data that is to be loaded into memory;
Prefetch Size: the amount of space occupied by the SoundBank data that is to be streamed; and
File Size: the total size of the generated SoundBank file.

After the SoundBanks have been created and populated, they can be generated.

When a SoundBank is generated, it can include any of the following information:
sound data for in-memory sounds;
sound data for streamed sounds;
pre-fetch sound data for streamed sounds with zero-latency;
event information;
sound, container, and actor-mixer information; and
events string-to-ID conversion mapping.

The information contained in the SoundBanks is project exclusive, which means that a SoundBank is used with other SoundBanks generated from the same project. Further details on the concept of “project” will follow.

The Authoring Tool is configured to generate SoundBanks even if they contain invalid events. These events are ignored during the generation process so that they do not cause errors or take up additional space.

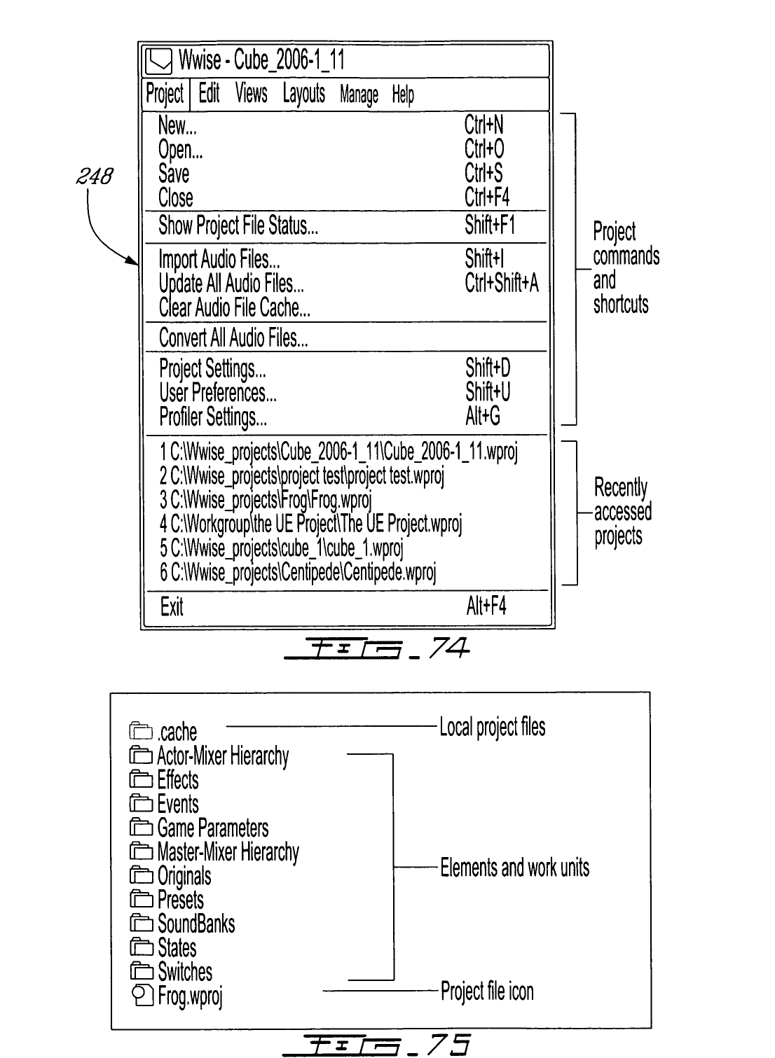

FIG. 73 illustrates an example of SoundBank Generator GUI panel 242 provided when the user trigger the SoundBanks generation process from the SoundBank Manager GUI 230 using the “Generate” button 244 and allowing setting options for their generation.

The SoundBank Generator 242 includes a first list box 246 for listing and allowing selection of the SoundBanks 236 to generate among those that have been created and populated, a second list box 247 for listing and allowing selection of the platforms 249 for which each of the selected SoundBanks 236 will be generated and similarly a third list box 251 for listing and allowing selection of the languages 253.

The SoundBank Generator 242 further includes check boxes for the following options:
“Allow SoundBanks to exceed maximum”: to generate SoundBanks even if they exceed the maximum size specified;
“Copy streamed files”: to copy all streamed files in the project to the location where the SoundBanks are saved;
“Include strings”: to allow the events within the SoundBanks to be called using their names instead of their ID numbers;
“Generate SoundBank contents files”: to create files which list the contents of each SoundBank. The contents files include information on events, busses, states, and switches, as well as a complete list of streamed and in memory audio files.

The SoundBank generation process further includes the step of assigning a location where the SoundBanks will be saved. The SoundBank Generator 242 includes GUI elements to designate the file location.

According to an alternate embodiment, the sound objects with links to the corresponding audio files to be used by the video game are stored in another type of project file than the SoundBanks.

Also, depending on the nature of the original files or of the application, the information included in the project file may vary.

Additional characteristics and features of the method 300 and of the system 10 and more specifically of the Authoring Tool will now be described.

Projects

As it has been described hereinabove, the information created by the Authoring Tool are contained in a project, including sound assets, properties and behaviors associated to these assets, events, presets, logs, simulations and SoundBanks.

The Authoring Tool includes a Project Launcher 248 for creating and opening an audio project. The Project Launcher 248, which is illustrated in FIG. 74, includes conventional menu including a series of command for managing projects, including: creating a new project, opening, closing, saving an existing project, etc. Conventional GUI tools and functionalities are provided with the Project Launcher 248 for those purposes.

A created project is stored in a folder specified in the location chosen on the system 10 or on a network to which the system 10 is connected.

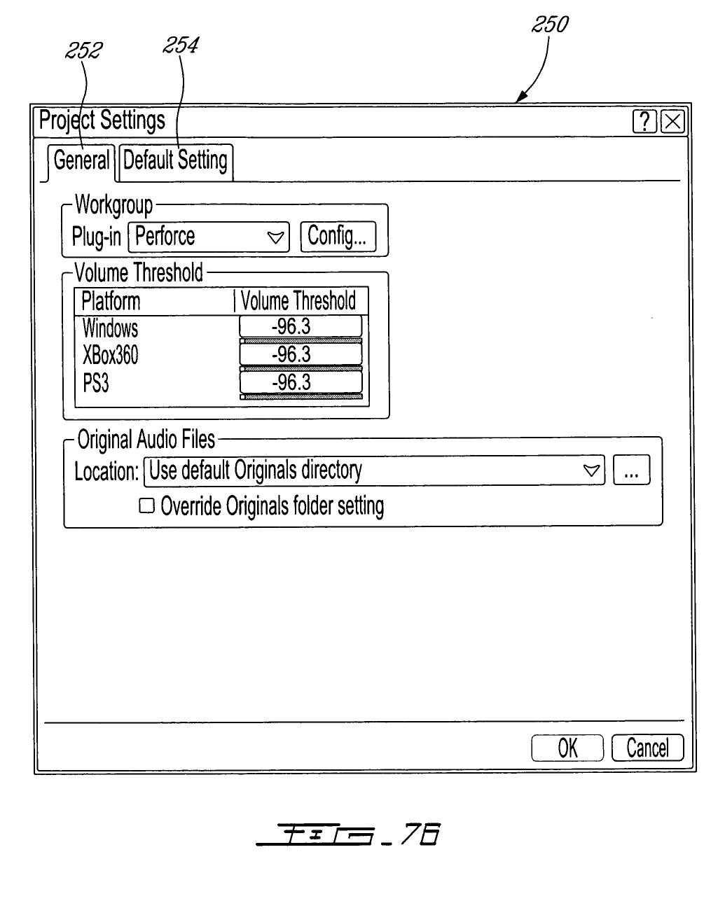

The project is stored for example in XML files in a project folder structure including various folders, each intended to receive specific project elements. The use of XML files has been found to facilitate the management of project versions and multiple users. Other type of files can alternatively be used. A typical project folder contains the following, as illustrated in FIG. 75:
Cache: this hidden folder is saved locally and contains all the imported audio files for the project and the converted files for the platform for which the project is being developed as described hereinabove;
Actor-Mixer Hierarchy: default work unit and user-created work units for the hierarchy;
Effects: default effects work unit for the project effects;
Events: the default event work unit and the user-created work units for the project events;
Game Parameters: default work units for game parameters;
Master-Mixer Hierarchy: default work unit for the project routing;
Originals: original versions of the SFX and Voices assets for your project as described hereinabove;
SoundBanks: default work unit for SoundBanks;
States: default work unit for States;
Switches: default work unit for Switches;
wproj: the actual project file.

The project folder may include other information depending on the nature of the media files provided in step 304 and in the application for which the multi-version of the media files are authored.

The concept of work units will be described hereinbelow in more detail.

The Project Launcher 248 includes a menu option for accessing a Project settings dialog box 250 for defining the project settings. These settings include default values for sound objects such as routing and volume, as well as the location for the project's original files.

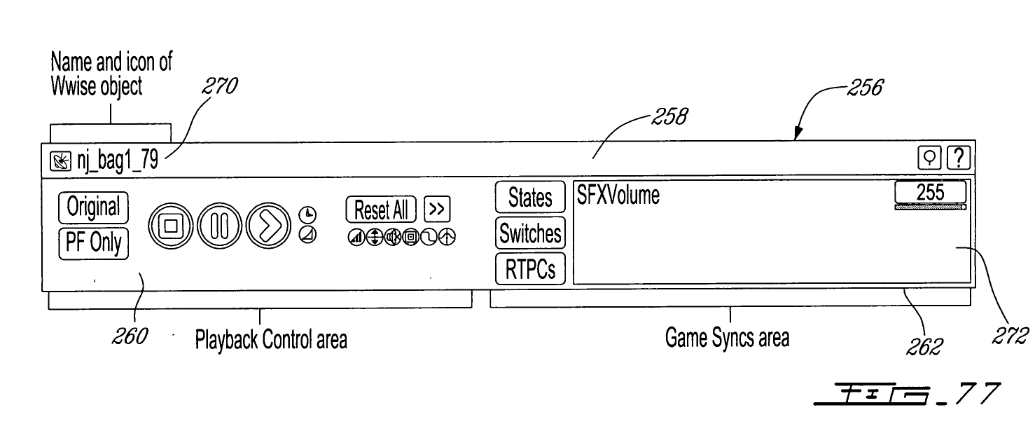

As illustrated in FIG. 76, the Project Settings dialog box 250 includes the following two tabs providing the corresponding functionalities:
General Tab 252: to define a source control system, the volume threshold for the project and the location for the Originals folder for the project assets; and
Defaults Settings Tab 254: to set the default properties for routing, and sound objects.

Auditioning

The Authoring Tool includes an auditioning tool 256 for auditioning the object selected. Such an auditioning tool, which will be referred to herein as Transport Control, will now be described with reference to FIG. 77.

The Authoring Tool is configured so that a selected object, including a sound object, container, or event, is automatically loaded into the Transport Control GUI 256 and the name of the object along with its associated icon are displayed in its title bar 258.

The Transport Control 256 includes two different areas: the Playback Control area 260 and the Game Syncs area 262.

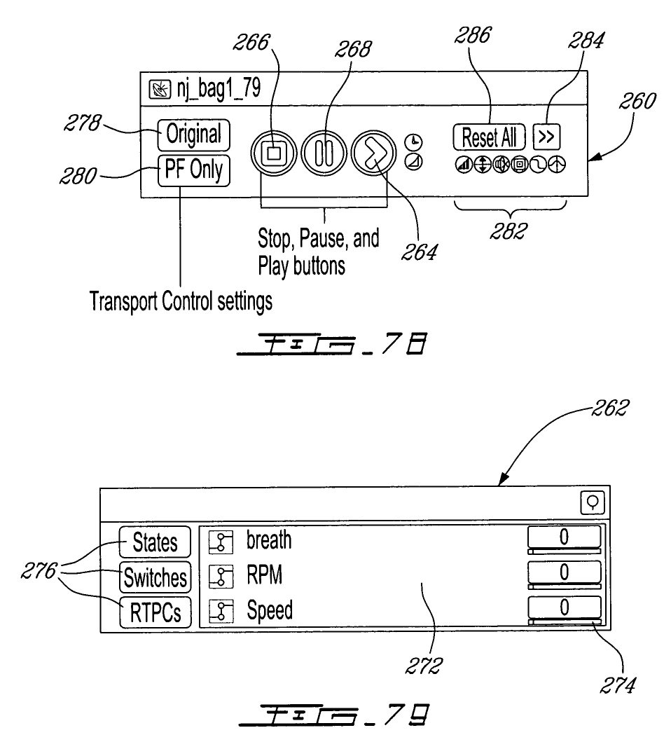

The Playback Control area 260 will now be described in more detail with reference to FIG. 78.

The Playback Control area 260 of the Transport Control 256 contains traditional control icon buttons associated with the playback of audio, such as play 264, stop 266, and pause buttons 268. It also includes Transport Control settings to set how objects will be played back. More specifically, these settings allow specifying for example whether the original or converted object is played as will be described furtherin.

The Playback Control 260 area also contains a series of indicators that change their appearances when certain properties or behaviors that have been previously applied to the object are playing. The following table lists the property and action parameter indicators in the Transport Control 256:

TABLE 8

| Icon | Name | Indicates |
|---|---|---|
| [symbol] | Delay | A delay has been applied to an object in an |
| | | event or a random-sequence container. |
| [symbol] | Fade | A fade has been applied to an object in an |
| | | event or a random-sequence container. |
| [symbol] | Set Volume | A set volume action has been applied to an |
| | | object in an event. |
| [symbol] | Set Pitch | A set pitch action has been applied to an |
| | | object in an event. |
| [symbol] | Mute | A mute action has been applied to an |
| | | object in an event. |
| [symbol] | Set LFE | A set LFE volume action has been applied |
| | | to an object in an event. |
| [symbol] | Set Low Pass | A set Low Pass Filter action has been |
| | Filter | applied to an object in an event. |
| [symbol] | Enable | An Enable Bypass action has been applied |
| | Bypass | to an object in an event. |

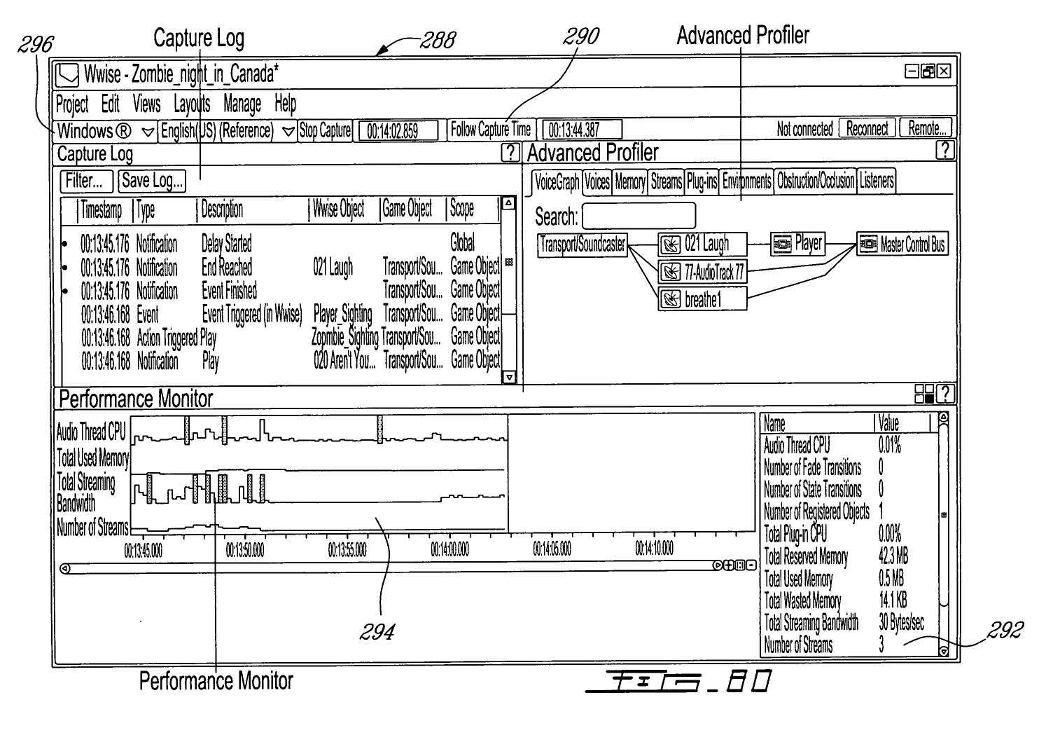

With reference to FIG. 79, in addition to the traditional playback controls 264-268, the Transport Control 256 includes a Game Syncs area 262 that contains states, switches, and RTPCs (Game Parameters) associated with the currently selected object 270. The Transport Control 256 can therefore be used as a mini simulator to test sounds and simulate changes in the game. During playback, states and switches can then be changed, and the game parameters and their mapped values can be auditioned.

For example, the Transport Control 256 is configured so that when an object is loaded therein, a list of state groups and states to which the object is subscribed can be selectively displayed to simulate states and state changes that will occur in game during playback. The Transport Control 256 further allows auditioning the state properties while playing back objects, and state changes while switching between states.

Similarly, a list of switch groups and switches to which the object has been assigned can be selectively displayed in the display area 272 to simulate switch changes that will occur in game during playback so that the switch containers that have subscribed to the selected switch group will play the sounds that correspond with the selected switch.

The Transport Control 256 is also configured so that RTPCs can be selectively displayed in the Games Syncs area. More specifically, as illustrated in FIG. 79, sliders 274 are contextually provided so that the game parameters can be changed during the object's playback. Since these values are already mapped to the corresponding property values, when the game parameter values are changed, the object property values are automatically changed. This therefore allows simulating what happens in game when the game parameters change and verifying how effectively property mappings will work in game.

The Game Syncs area 262 further includes icon buttons 276 to allow selection between states, switches and RTPCs and the display area 272 is provided adjacent these icons buttons to display the list of selected syncs.

The Transport Control 256 is further configured to compare converted audio to the original files and make changes to the object properties on the fly and reset them to the default or original settings as will now be described briefly.

As it has been previously described, when the imported audio files are converted, the Authoring Tool maintains an original version of the audio file that remains available for auditioning. The Transport Control 256 is configured to play the converted sounds by default; however, as can be seen in FIG. 78, the Transport Control 198 includes an “Original” icon button 278 to allow the user selecting the original pre-converted version for playback.

As it has been previously described, the Authoring Tool allows including or excluding certain sounds from one or more platforms while creating the sound structures. The Transport Control 25, which is Platform specific, includes an icon button 280 for alternating between a first playing mode wherein only the sounds that are in the current platform as selected using the Platform Selector 192 (FIG. 61), and a second playing mode wherein all sounds loaded into the Transport Control 256, are available. The corresponding “PF Only” icon button 280 changes color for example to indicate the activation of the first playing mode.

As described hereinabove, the Transport Control 256 provides access to properties, behaviors, and game syncs for the objects during playback. More specifically, property indicators 282 in the Game Syncs area 262 provide the user with feedback about which behaviors or actions are in effect during playback. This can be advantageous since when the Authoring Tool is connected to the game, some game syncs, effects, and events may affect the default properties for objects. The Transport Control 256 further includes a Reset button 284 to access a pop up menu allowing to selectively return objects to their default settings. In addition to an icon button 286 intended to reset all objects to their default settings, the Reset icon button 284 display a Reset menu allowing to perform one of the following:
resetting all objects to their original settings;
resuming playing a sequence container from the beginning of the playlist;
returning all game parameters to the original settings;
clearing all mute actions that have been triggered for the objects;
clearing all pitch actions that have been triggered for the objects;
clearing all volume actions that have been triggered for the objects;
clearing all LFE volume actions that have been triggered for the objects;
clearing all Low Pass Filter actions that have been triggered for the objects;
clearing all bypass actions that have been triggered for the objects;
returning the default state; and
returning to the default switch specified for the Switch Container.

The Authoring Tool is so configured that the Transport Control 256 automatically loads the object currently in the Property Editor 84. It is also configured so that an object or event selected in the Project Explorer 74 will be automatically loaded into the Transport Control 256.

The Transport Control 256 is further provided with additional tools for example to edit an object, find an object in the hierarchy and provide details on the selected object. These options are made available, for example, through a shortcut menu.

The Transport Control 256 is of course adapted to the media files that are being authored. A system and method for multi-version video authoring according to another embodiment may be provided with a Transport Control adapted to play video.

Profiler

The Authoring Tool also includes a Game Profiler, including a Game Profiler GUI 288, to profile selected aspects of the game audio at any point in the Authoring process for a selected platform. More specifically, the Profiler is connectable to a remote game console corresponding to the selected platform so as to capture profiling information directly from the sound engine. By monitoring the activities of the sound engine, specific problems related for example to memory, voices, streaming and effects can be detected and troubleshooted. Of course, since the Game Profiler of the Authoring Tool is configured to be connected to the sound engine, it can be used to profile in game, or to profile prototypes before they have been integrated into a game.

The profiler also allows capturing performance information from models or prototypes created in the authoring tool, to monitor performance prior to connecting to a remote console.

As illustrated in FIG. 80, the Game Profiler GUI includes the following three profiling tools which can be accessed via a respective GUI:
Capture Log panel: to capture and record information coming from the sound engine for a selected platform version 296;
Performance Monitor: to graphically represent the performance from the CPU, memory, and the bandwidth, for activities performed by the sound engine. The information is displayed in real time as it is captured from the sound engine;
Advanced Profiler: a set of sound engine metrics to monitor performance and troubleshoot problems.

The Game Profiler displays the three respective GUI in an integrated single view which contributes helping locating problem areas, determining which events, actions, or objects are causing the problems, determining how the sound engine is handling the different elements, and also fixing the problem quickly and efficiently.

Connecting to a Remote Game Console

To simulate different sounds in game or to profile and troubleshoot different aspects of the game on a particular platform 296, the Authoring Tool may first be connected to the game console corresponding to this platform 296. More specifically, the Game Profiler is connectable to any game console or game simulator that is running and which is connectively available to the Authoring Tool. To be connectively available, the game console or game simulator is located on a same network, such as for example on a same local area network (LAN).

The Authoring Tool includes a Remote Connector including a Remote Connector GUI panel (both not shown) for searching available consoles on selected path of the network and for establishing the connection with a selected console from a list of available consoles. The Remote Connector can be configured, for example, to automatically search for all the game consoles that are currently on the same subnet as the system 10 of the network. The Remote Connector GUI panel further includes an input box for receiving the IP address of a console, which may be located, for example, outside the subnet.

The Remote Connector is configured to maintain a history of all the consoles to which the system 10, and more specifically, the Authoring Tool, has successfully connected to in the past. This allows easy retrieval of connection info and therefore of connection to a console.

The Remote Connector displays on the Remote Connector GUI panel the status of the console for which a connection is attempted. Indeed, the remote console can be a) ready to accept a connection, b) already connected to a machine and c) no longer connected to the network.

After connection to a remote console has been established using the Remote Connector, the Profiler can be used to capture data directly from the sound engine.

The Capture Log module captures the information coming from the sound engine. It includes a Capture Log GUI panel to display this information. An entry is recorded in the Capture Log module for the following types of information: notifications, Switches, Events, SoundBanks, Actions, errors, Properties, messages sent by the sound engine, and States. Of course, the Capture Log Panel module can be modified to capture and display other type of information.

The Performance Monitor and Advanced Profiler are in the form of a respective pane which can be customized to display these entries. These views contain detailed information about memory, voice, and effect usage, streaming, plug-ins, and so on.

These panes make use of icon indicators and a color code to help categorize and identify the entries that appears in the Capture Log panel.

The Profiler can be customized to limit the type of information that will be captured by the Capture Log module, in view of preventing or limiting the performance drop. The Profiler includes a Profiler Settings dialog box (not shown) to allow the user selecting the type of information that will be captured.

The Profiler Settings dialog box includes GUI elements, in the form of menu item with corresponding check boxes, to allow the selection of one or more of the following information types:
information related to the various plug-ins;
information related to the memory pools registered in the sound engine's Memory Manager;
information related to the streams managed by the sound engine;
information related to each of the voices managed by the sound engine;
information related to the environmental effects affecting game objects; and
information related to each of the listeners managed by the sound engine.

The Profiler Setting dialog box further includes an input box for defining the maximum amount of memory to be used for making the Capture log.

The Profiler module is also configured to selectively keep the Capture Log and Performance Monitor in sync with the capture time. A “Follow Capture Time” icon button 290 is provided on the toolbar of the Profiler GUI 288 to trigger that option. In operation, this will cause the automatic scrolling of the entries as the data are being captured, and the synchronization of a time cursor, provided with the Performance Monitor view with the game time cursor.

The Profiler is further customizable by including a log filter accessible via a Capture Log Filter dialog box (not shown), which allows selecting specific information to display, such as a particular game object, or only event related information or state related information.

The Profiler includes further tools to manage the log entries, including sorting and selected or all entries. Since such managing tools are believed to be well-known in the art, and for concision purposes, they will not be described herein in more detail.

The Performance Monitor creates performance graphs 294 as the Profiler module captures information related to the activities of the sound engine. The Performance Monitor includes a Performance Data pane 292 to simultaneously display the actual numbers and percentages related to the graphs 294.

The different graphs of the graph view of the Performance Monitor can be used to locate areas in a game where the audio is surpassing the limits of the platform. Using a combination of the Performance Monitor, Capture Log, and Advanced Profiler, allows troubleshooting many issues that may arise.

The Performance Monitor is customizable. Any performance indicators or counters displayed from a list can be selected by the user for monitoring. Example of indicators include: audio thread CPU, number of Fade Transitions, number of State Transitions, total Plug-in CPU, total reserved memory, total used memory, total wasted memory, total streaming bandwidth, number of streams and number of voices.

The Performance Monitor, Advance Profiler and Capture Log panel are synchronized. For example, scrolling through the graph view automatically updates the position of the entry in the Capture Log panel and the information in the Performance Data pane.

The Profiler is linked to the other module of the Authoring Tool so as to allow access of the corresponding Event and/or Property Editors by selecting an entry in the Capture Log panel. The corresponding event or object then opens in the Event Editor or Property Editor where any modifications that are necessary can be made.

It is to be noted that the steps from the method 300 can be performed in other orders than the one presented.

Also, the functionalities of the above-described components of the Authoring Tool can be made available through different combinations of GUIs.

The present system for multi-version digital authoring has been described with reference to illustrative embodiments including examples of user interfaces allowing a user to interact with the Authoring Tool. These GUIs have been described for illustrative purposes and should not be used to limit the scope of the present system in any way. They can be modified in many ways within the scope and functionalities of the present system and tools. For example, shortcut menus, text boxes, display tabs, etc, can be provided interchangeably.

It is believed to be within the reach of a person skilled in the art to use the present teaching to modify the user interfaces described herein for other version classes, properties, behaviours, or computer applications.

Even though the method 300 and system 10 for multi-version digital authoring according to the first illustrative embodiment includes a hierarchical structure to associate modifying values to selected copies of the media files, the present system and method are not limited to such an embodiment. Indeed, the work copies of the media files can be modified without using a hierarchical structure to manage the media objects.

As it has been described hereinabove, the media files can also be modified directly without creating work copies or sources thereof.

Also, the present system and method is not limited to authoring audio files and can be adapted to multi-version authoring of other types of digital files and entities, including video, images, programming objects, etc.

More specifically, such a modified Authoring Tool can be used in image or video processing.

The present system can also be implemented without any user interface wherein a batch file including formatted instructions can be provided to retrieve selected files and applying modifications thereon using the method as described hereinabove.

The media files can therefore be any type of files including media content, such as text, video, audio, or a combination thereof. Application files can also be modified using the present method and system.

The present method and system for multi-version digital authoring can be used in graphical applications. It can be used, for example, to digitally create multi-version of an advertisement for several targeted mediums, such as:
super high resolution, special format for billboards;
mid resolution in color for a first group of magazines;
mid resolution in black and white for a second group of magazines;
low resolution for a notice or a sign for super market path, etc

According to a further embodiment, the present system and method for multi-version digital authoring is used to create email announcements for example for members of an association that has a generic introduction but a customized multi-version conclusion based on the membership “classes” (for example, normal, elite, super elite, etc.). This allows the provider to prepare a single announcement with a plurality of versions.

In the videogame industry, the present system and method is not limited to audio authoring and can be used in preparing multi-versions of textures, animations, artificial intelligence, scripts, physics, etc.

The present system and method for multi-version digital authoring can also be used in web design and computer application authoring.

Although the present method and system for multi-version digital authoring has been described hereinabove by way of illustrated embodiments thereof, it can be modified, without departing from the spirit and nature of the subject method and system as defined in the appended claims.

What is claimed is:

1. A method in a computer system for multi-version digital authoring comprising:
providing at least one digital media;
predetermining a first version class including first version identifiers; and
associating the at least one digital media to at least one of the first version identifiers.

2. A method as recited in claim 1, wherein the at least one digital media includes a plurality of digital media; said associating the at least one digital media to at least one of the first version identifiers including associating a first selected media among the plurality of digital media to at least one of the first version identifiers.

3. A method as recited in claim 1, wherein said associating the at least one digital media to at least one of the first version identifiers including associating the first selected media to a plurality of the first version identifiers.

4. A method as recited in claim 1, further comprising:
providing at least one modifier to modify the at least one digital media; the modifier being characterized by modifying values; and
modifying the at least one digital media with one of the modifying values.

5. A method as recited in claim 4, further comprising creating, for each of the first version identifiers, a corresponding first version identifier work copy of the at least one digital media.

6. A method as recited in claim 5, wherein the first version identifier work copy of each digital media is a converted version of each of the at least one digital media.

7. A method as recited in claim 6, wherein said creating a corresponding first version identifier work copy of the at least one digital media includes i) defining first identifier conversion settings; and ii) creating the first version identifier work copy of each of the at least one digital media and iii) applying the first identifier conversion settings thereon.

8. A method as recited in claim 5, wherein said modifying the at least one digital media with one of the modifying values includes modifying a first selected work copy among the first version identifier work copies.

9. A method as recited in claim 8, further comprising selectively and independently causing second selected work copies among the first version identifier work copies of the digital files to be alternatively linked and unlinked to the at least one modifier.

10. A method as recited in claim 9, further comprising verifying whether the first selected work copy is one of the second selected work copies; wherein when the first selected work copy is one of the second work copies and it is linked, then verifying which one of the other of the second work copies are linked and further modifying the other of the second work copies that are linked with said one of the modifying values.

11. A method as recited in claim 9, wherein the second selected work copies can be relatively unlinked to the at least one modifier; the second selected work copies being modified by another one of the modifying values; the method further comprising verifying whether the first selected work copy is one of the second work copies; wherein when the first selected work copy is one of the second work copies and it is relatively unlinked, then further modifying the first selected work copy by said another one of the modifying values.

12. A method as recited in claim 8, further comprising:
creating a media object for each one of the digital media;
associating each of the media object to the corresponding digital media; and
associating each corresponding first version identifier work copy of each of the digital media to the object associated thereto.

13. A method as recited in claim 12, wherein said modifying a first selected work copy among the first version identifier work copies includes assigning said one of the modifying values to the media object associated therewith.

14. A method as recited in claim 13, further comprising:
providing a hierarchical structure including the media objects and at least one container element for said assigning said one of the modifying values to the media object associated thereto; the at least one container element being for grouping at least one selected object among the media objects so that when a selected one the modifying values is assigned thereto, the selected one the modifying values is shared to the at least one selected object.

15. A method as recited in claim 14, further comprising selectively excluding the at least one selected object from being assigned the selected one of the modifying values.

16. A method as recited in claim 1, further comprising:
predetermining a second version class including second version identifiers;
further associating the at least one digital media to at least one of the second version identifiers.

17. A method as recited in claim 5, further comprising:
predetermining a second version class including second version identifiers;
further associating the at least one digital media to at least one of the second version identifiers; and
for each of the second version identifiers, creating a corresponding second version identifier work copy of each of the first version work copy of the digital files.

18. A method as recited in claim 17, wherein the first version class includes platform types or languages.

19. A method as recited in claim 1, further comprising:
providing at least one event to drive the at least one digital media; the at least one event having a plurality of actions associated thereto; and
assigning at least one of the plurality of actions to the at least one digital media.

20. A method as recited in claim 19, further comprising selectively excluding at least one of the plurality of actions from being assigned to the at least one digital media associated to a selected one of the first version identifiers.

21. A method as recited in claim 1, wherein the first version class includes platform types or languages.

22. A method as recited in claim 1, wherein the at least one digital media includes audio content.

23. A method as recited in claim 22, further comprising auditioning the at least one of the at least one digital media.

24. The use of the method of claim 1, for authoring audio for video games.

25. The use of the method of claim 1, for multi-version authoring of digital images.

26. A computer tool for multi-version digital authoring comprising:
a file importer component that receives at least one digital media; and
an editor component that provides a first version class including first version identifiers and to selectively associate the at least one digital media to at least one of the first version identifiers.

27. A computer tool as recited in claim 26, wherein the editor component is further to provide at least one modifier, characterized by modifying values, for modifying the at least one digital media and for modifying the at least one digital media with one of the modifying values.

28. A computer tool as recited in claim 27, wherein the file importer creating, for each of the first version identifiers, a corresponding first version identifier work copy of the at least one media.

29. A computer tool as recited in claim 28, wherein the first version identifier work copy of each digital media is a converted version of each of the at least one digital media.

30. A computer tool as recited in claim 29, wherein the file importer component is further i) to define version identifier conversion settings; ii) to create the first version identifier work copy of each of the at least one digital media and iii) to apply the first identifier conversion settings thereto.

31. A computer tool as recited in claim 28, wherein said modifying the at least one digital media with one of the modifying values includes modifying a first selected work copy among the first version identifier work copies.

32. A computer tool as recited in claim 31, further comprising at least one link editor associated to the at least one modifier for selectively and independently causing second selected work copies among the first version identifier work copies of the digital files to be alternatively linked and unlinked to the at least one modifier.

33. A computer tool as recited in claim 32, wherein the link editor further verifies whether the first selected work copy is one of the second selected work copies and, when the first selected work copy is one of the second work copies and it is linked, verifies which one of the other of the second work copies are linked and further modifies the other of the second work copies that are linked with said one of the modifying values.

34. A computer tool as recited in claim 32, wherein the link editor being further to relatively unlinked the second selected work copies to the at least one modifier; the editor component being further to modify the second selected work copies by another one of the modifying values; the link editor further verifying whether the first selected work copy is one of the second work copies, and when the first selected work copy is one of the second work copies and it is relatively unlinked, then further modifying the first selected work copy by said another one of the modifying values.

35. A computer tool as recited in claim 31, wherein the file importer being further for creating a media object for each one of the at least one digital media, for associating each of the media object to the corresponding digital media, and for associating each corresponding first version identifier work copy of each of the at least one digital media to the object associated thereto.

36. A computer tool as recited in claim 35, wherein said modifying a first selected work copy of the first version identifier work copies includes assigning said one of the modifying values to the media object associated therewith.

37. A computer tool as recited in claim 36, further comprising a hierarchical structure editor to create a hierarchical structure including the media objects and at least one container element for said assigning said one of the modifying values to the media object associated thereto; the at least one container element being for grouping at least one selected object among the objects so that when the first modifying values is assigned thereto, the selected one of the modifying values is shared to the at least one selected object.

38. A computer tool as recited in claim 37, further comprising an excluder for selectively excluding the at least one selected object from being assigned the selected one of the modifying values.

39. A computer tool as recited in claim 28, further comprising a project file manager to store in at least one project file information related to at least one of the at least one digital media, and at least one of the first version identifier work copies thereof.

40. A computer tool as recited in claim 26, further comprising a version manager to manage the version identifiers.

41. A computer tool as recited in claim 40, wherein the version manager is for at least one of creating a new version identifier and deleting and renaming one of the version identifiers.

42. A computer tool as recited in claim 41, wherein the version manager further allows creating at least one sub version identifier of one of the version identifiers to be selectively associated to the at least one digital media

43. A computer tool as recited in claim 26, wherein the first version identifiers corresponding to a plurality of first and second version identifiers, yielding a plurality of second versions of first versions of the digital files.

44. A computer tool as recited in claim 26, wherein the first version identifiers are indicative of platform types or languages.

45. A computer tool as recited in claim 44, wherein the first version identifiers are indicative of languages; the computer tool further comprising a language manager component to manage the first version identifiers.

46. A computer tool as recited in claim 45, wherein the language manager component allows performing on the first version identifiers at least one of adding, renaming and deleting.

47. A computer tool as recited in claim 28, wherein the file importer component further stores the at least one digital media in a first location and the first version identifier work copies of the at least one media in a second location.

48. A computer tool as recited in claim 26, wherein the at least one digital media includes at least one of audio, image and text content.

49. A computer tool as recited in claim 48, further comprising an auditioning tool for playing the at least one digital media.

50. A computer tool as recited in claim 26, wherein the computer tool is for multi-version digital authoring for a computer application; the computer tool further comprising a profiler component to collect profiling data from the computer application while the computer tool is connected thereto.

51. A computer tool as recited in claim 50, wherein the first version identifiers are indicative of platform types; the computer application being implemented on a specific platform selected among one of the platform types; the first selected version corresponding to the specific platform.

52. A computer-readable medium containing instructions for controlling a computer system to generate:
a file importer component that receives digital media; and
an editor that provides a first version class including first version identifier and to selectively associate the at least one media to at least one of the first version identifiers.
